(19) United States
(12) Patent Application Publication
(10) Pub. No.: US 2008/0278415 A1
(43) Pub. Date: Nov. 13, 2008

(54) METHOD FOR DRIVING PLASMA DISPLAY PANEL

(75) Inventors: Shunsuke ITAKURA, Chuo-shi (JP); Tsutomu Tokunaga, Chuo-shi (JP); Tatsuya Sugimoto, Chuo-shi (JP); Yoshichika Sato, Chuo-shi (JP); Yuya Shiozaki, Chuo-shi (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Tokyo (JP)

(21) Appl. No.: 12/117,788

(22) Filed: May 9, 2008

(30) Foreign Application Priority Data
May 9, 2007 (JP) 2007-124099
May 14, 2007 (JP) 2007-128050
Jan. 16, 2008 (JP) 2008-007234

(51) Int. Cl. G09G 3/28

(52) U.S. Cl. 345/60

(57) ABSTRACT

A method for driving a plasma display panel which is capable of improving contrast is provided. A plasma display apparatus which is capable of improving dark contrast and suppressing a degradation in image quality immediately after power-on is also provided. In the PDP, the peak potentials of drive pulses to be applied in order to drive display cells which have a phosphor layer containing a phosphor material and a secondary electron emitting material, are set as follows. The peak potential of a reset pulse, to be applied to each of the row electrodes in the first subfield within each unit display period, is set to be lower than the peak potential of a sustain pulse, to be applied to each of the row electrodes in every subfield to produce sustain discharge only in display cells that are in the lighting mode.

### BACKGROUND OF THE INVENTION

1. Technical Field

The present invention relates to a driving method for driving a plasma display panel.

2. Description of the Related Art

For low-profile displays, plasma display panels (hereinafter, referred to as PDPs) of AC type (alternating-current discharge type) have currently been put into production. A PDP includes two substrates, i.e., a front transparent substrate and a rear substrate which are opposed to each other with a predetermined gap therebetween. The inner surface of the front transparent substrate (the side opposed to the rear substrate), or display surface, is provided with a plurality of pairs of row electrodes which are paired with each other and extend in respective horizontal directions of the screen. A dielectric layer for covering each pair of row electrodes is also formed on the inner surface of this front transparent substrate. Meanwhile, the rear substrate is provided with a plurality of column electrodes which extend in a perpendicular direction of the screen so as to intersect with the pairs of row electrodes. When viewed from the side of the foregoing display surface, display cells corresponding to pixels are formed at the intersections of the pairs of row electrodes and the column electrodes.

For providing display brightness in halftones corresponding to input video signals, PDPs like this are subjected to grayscale driving based on a subfield method.

According to the grayscale driving based on the subfield method, display driving for a single field of video signal is performed in units of a plurality of subfields to which respective intended numbers of times (or periods) of light emission are assigned. In each subfield, an address stage and a sustain stage are performed consecutively. At the address stage, a selective discharge is created between the row electrodes and the column electrodes of respective display cells selectively in accordance with an input video signal, thereby forming (or erasing) a predetermined amount of wall charges. At the sustain stage, only the display cells that have the predetermined amount of wall charges are made to create a discharge repeatedly so as to maintain the state of light emission resulting from the discharge. Moreover, at least in the first subfield, an initialization stage is performed prior to the foregoing address stage. At this initialization stage, a reset discharge is created between the paired row electrodes in all the display cells, whereby the amounts of wall charges remaining in all the display cells are initialized.

Here, since the foregoing reset discharge is relatively high in intensity and does not contribute at all to the contents of the image to be displayed, there has been the problem that light emission ascribable to this discharge can lower the image contrast.

A PDP of improved discharge probabilities has also been proposed in which a magnesium oxide layer that is arranged to cover the electrodes in each discharge cell contains vapor-phase oxidized magnesium oxide single crystals that produce CL emission peaking at 200 to 300 nm when irradiated with electron beams. For example, see Japanese Patent Kokai No. 2006-91437 (patent document 1). This PDP reduces a discharge delay significantly, and can thus create weak discharges in a short time with stability. Consequently, it is possible to weaken reset discharges and the like not contributing to display images and suppress light emission ascribable to those discharges, thereby improving the contrast when displaying dark images, i.e., so-called dark contrast.

### SUMMARY OF THE INVENTION

In view of the foregoing, a PDP of reduced discharge delay time and a method for driving the same have been proposed in which magnesium oxide crystals for producing cathode luminescence emission with a peak within wavelengths of 200 to 300 nm when excited by electron beam irradiation are adhered to the surface of a dielectric layer that covers the pairs of row electrodes. For example, see Japanese Patent Kokai No. 2006-54160 (patent document 2). According to this PDP, the priming effect subsequent to discharges lasts for a relatively long time, which makes it possible to create weak discharges with stability. Then, a reset pulse having the pulse waveform that its voltage gradually approaches a peak voltage value with a lapse of time is applied to the row electrodes of a PDP such as described above, so that a weak reset discharge occurs between mutually adjoining row electrodes. Here, since the weakened reset discharge lowers the emission brightness ascribable to that discharge, it becomes possible to improve the image contrast.

There has been the problem, however, that the so-called dark contrast, when displaying dark images, cannot be improved sufficiently even by using this driving method.

It is an object of the present invention to provide a method for driving a plasma display panel, capable of improving dark contrast.

Reset discharges are essential for discharge stabilization, and thus the light emission from the entire screen due to the reset discharges still has been an obstacle to improving the dark contrast. There has also been proposed a driving method for omitting reset discharges. For example, see Japanese Patent Kokai No. 2001-312244 (patent document 3). Nevertheless, the omission of the reset discharges decreases the amounts of charged particles to remain in the discharge cells, causing the problem that various types of discharges to be created subsequently can fail with a higher possibility.

The present invention has been achieved in order to solve the foregoing problems, and it is an object thereof to provide a method for driving a plasma display panel, capable of improving dark contrast without causing discharge failures.

A method for driving a plasma display panel according to a first aspect of the present invention is one for driving a plasma display panel in accordance with pixel data based on a video signal pixel by pixel, the plasma display panel comprising display cells being formed at respective intersections between a plurality of pairs of row electrodes and a plurality of column electrodes, the display cells having a phosphor layer containing a phosphor material and a secondary electron emitting material, the method comprising: in a first subfield out of a plurality of subfields into which a unit display period of the video signal is divided, performing a reset stage for maintaining each of the column electrodes to a predetermined potential and applying a reset pulse having a peak potential higher than or equal to this predetermined potential to one row electrodes in the pairs of row electrodes; and in each of all the subfields, performing an address stage, and a sustain stage for applying a sustain pulse to the pairs of row electrodes, and wherein the reset pulse has a peak potential lower than or equal to the peak potential of the sustain pulse.

A method for driving a plasma display panel according to a second aspect of the present invention is one for driving a plasma display panel in accordance with pixel data based on a video signal pixel by pixel, the plasma display panel comprising display cells being formed at respective intersections between a plurality of pairs of row electrodes and a plurality of column electrodes, the display cells having a phosphor layer containing a phosphor material and a secondary electron emitting material, the method comprising: both in a first subfield and a second subfield immediately after the first subfield out of a plurality of subfields into which a unit display period of the video signal is divided, successively performing a reset stage for maintaining each of the column electrodes to a predetermined potential and applying a reset pulse having a peak potential higher than or equal to this predetermined potential to one row electrodes in the pairs of row electrodes, and an address stage; and in each of the second and subsequent subfields, performing a sustain stage for applying a sustain pulse to the pairs of row electrodes, and wherein at least either one of the reset pulse to be applied at the reset stage of the first subfield and the reset pulse to be applied at the reset stage of the second subfield has a peak potential lower than or equal to the peak potential of the sustain pulse.

A method for driving a plasma display panel according to a third aspect of the present invention is one for driving a plasma display panel in accordance with pixel data based on a video signal pixel by pixel, the plasma display panel comprising display cells being formed at respective intersections between a plurality of pairs of row electrodes and a plurality of column electrodes, the method comprising: in a first subfield out of a plurality of subfields into which a unit display period of the video signal is divided, successively performing a first reset stage for maintaining each of the column electrodes to a predetermined potential and applying a reset pulse having a peak potential higher than or equal to this predetermined potential to one row electrodes in the pairs of row electrodes, thereby the display cells are each initialized into a state of extinction mode, an address stage for setting each of the display cells in a state of lighting mode selectively in accordance with the pixel data, and a weak light emission stage of creating a weak light emission discharge in the display cells that are in the state of the lighting mode; and in each of the subfields subsequent to the first subfield, performing a sustain stage for applying a sustain pulse to the pairs of row electrodes, and wherein: the reset pulse has a peak potential lower than or equal to the peak potential of the sustain pulse; and at the minute light emission stage, a voltage is applied to between the one row electrodes in the pairs of row electrodes and the column electrodes with the one row electrodes as anodes and the column electrodes as cathodes, thereby creating the weak light emission discharge between the column electrodes and the one row electrodes in the display cells that are in the state of the lighting mode.

The peak potentials of drive pulses that are applied to each of the intersections between the plurality of column electrodes and the plurality of pairs of row electrodes of the PDP, in order to drive the phosphor layer which contains the phosphor material and the secondary electron emitting material, are set as follows. The reset pulse to be applied to the row electrodes in order to create a reset discharge in the display cells in the first subfield of each unit display period is given a peak potential lower than the peak potential of the sustain pulse to be applied to the row electrodes in each subfield in order to create a sustain discharge only in display cells that are in the state of the lighting mode. This weakens the reset discharge which entails light emission not contributing to display images, thereby improving the dark contrast of the entire screen.

A method for driving a plasma display panel according to a fourth aspect of the present invention is one for driving a plasma display panel in accordance with pixel data based on a video signal pixel by pixel, discharge cells being formed at respective intersections between a plurality of pairs of row electrodes and a plurality of column electrodes, the discharge cells each having a phosphor layer, the method comprising: a drive control stage for applying a reset pulse to the pairs of row electrodes at least one of a plurality of subfields within every unit display period of the video signal; and a moving images/still image decision stage for deciding whether the video signal shows a moving image or a still image, and wherein the drive control stage includes changing a pulse waveform of the reset pulse between when the video signal is decided to be a moving image and when it is decided to be a still image.

When initializing the states of all the discharge cells through the application of the reset pulse to the PDP in which the phosphor layer containing the secondary electron emitting material is formed in the discharge cells, the reset pulse is generated with different pulse waveforms between when the input video signal shows a moving image and when it shows a still image. That is, reset pulses having respective different peak potentials and/or pulse widths are applied to the discharge cells, depending on if the input video signal shows a moving image or a still image. Here, the peak potential of the reset pulse is raised when the input video signal shows a moving image as compared to when it shows a still image. Alternatively, the pulse width of the reset pulse is increased when the input video signal shows a moving image as compared to when it shows a still image. Consequently, when the input video signal shows a moving image, a reset discharge of relatively high intensity is created to compensate for a lack of charged particles which might occur when displaying this moving image. When the input video signal shows a still image, the reset discharge is weakened to improve the dark contrast. This makes it possible to display with improved dark contrast without causing an accidental discharge, regardless of the state of the image to be shown by the input video signal (moving image or still image).

### BRIEF DESCRIPTION OF THE DRAWINGS

FIG. 1 is a diagram showing the schematic configuration of a plasma display apparatus according to the present invention;

FIG. 2 is a front view schematically showing the internal structure of a PDP 50 as seen from the display-surface side;

FIG. 3 is a diagram showing a cross section taken along the line III-III shown in FIG. 2;

FIG. 4 is a diagram showing a cross section taken along the line IV-IV shown in FIG. 2;

FIG. 5 is a diagram schematically showing MgO crystals which are contained in a phosphor layer 17;

FIG. 6 is a chart showing emission patterns at respective grayscale levels;

FIG. 7 is a diagram showing an example of the emission drive sequence to be employed for the plasma display apparatus shown in FIG. 1;

FIG. 8 is a chart showing various types of drive pulses to be applied to the PDP 50 in accordance with the emission drive sequence shown in FIG. 7;

FIG. 9 is a chart showing the transition of the discharge intensity of a column side cathode discharge that occurs when a reset pulse RP_{Y1} is applied to a conventional PDP in which CL emission MgO crystals are contained in a magnesium oxide layer 13 alone;

FIG. 10 is a chart showing the transition of the discharge intensity of a column side cathode discharge that occurs when the reset pulse RP_{Y1} is applied to the PDP 50 in which CL emission MgO crystals are contained in both the magnesium oxide layer 13 and the phosphor layer 17;

FIG. 11 is a chart showing another mode of application of the reset pulses at the reset stage R shown in FIG. 8;

FIG. 12 is a diagram showing another example of the emission drive sequence to be employed for the plasma display apparatus shown in FIG. 1;

FIG. 13 is a chart showing various types of drive pulses to be applied to the PDP 50 in accordance with the emission drive sequence shown in FIG. 12;

FIG. 14 is a diagram schematically showing the configuration of the phosphor layer 17 which is formed by depositing a secondary electron emitting layer 18 over the surface of a phosphor particle layer 17a;

FIG. 15 is a diagram showing the schematic configuration of a plasma display apparatus according to another embodiment of the present invention;

FIG. 16 is a chart showing emission patterns in respective grayscale levels of the plasma display apparatus shown in FIG. 15;

FIG. 17 is a diagram showing an example of the emission drive sequence to be employed for the plasma display apparatus shown in FIG. 15;

FIG. 18 is a chart showing various types of drive pulses to be applied to the PDP 50 in accordance with the emission drive sequence shown in FIG. 17;

FIG. 19 is a chart showing another mode of application of the reset pulses at the first reset stage R1 shown in FIG. 18;

FIG. 20 is a chart showing another mode of application of the reset pulses at the second reset stage R2 shown in FIG. 18;

FIG. 21 is a diagram showing another example of the emission drive sequence to be employed for the plasma display apparatus shown in FIG. 15;

FIG. 22 is a chart showing various types of drive pulses to be applied to the PDP 50 in accordance with the emission drive sequence shown in FIG. 21;

FIG. 23 is a chart showing another waveform of the reset pulses RP_{Y1}, RP1_{Y1}, RP2_{Y1}, RP_{Y2}, RP1_{Y2}, and RP2_{Y2};

FIG. 24 is a diagram showing the relationship between the negative peak potential V_{-R} of the reset pulse RP_{Y2} shown in FIGS. 8 and 13 and the positive peak potential V_{SUS} of the sustain pulse IP;

FIG. 25 is a diagram showing the relationship between the negative peak potential V_{-R} of the reset pulse RP_{Y2} shown in FIG. 11 and the positive peak potential V_{SUS} of the sustain pulse IP;

FIG. 26 is a diagram showing the relationship between the negative peak potentials V_{-R} of the respective reset pulses RP1_{Y2} and RP2_{Y2} shown in FIGS. 18 and 22 and the positive peak potential V_{SUS} of the sustain pulse IP; and

FIG. 27 is a diagram showing the relationship between the negative peak potentials V_{-R} Of the reset pulse RP1_{Y2} shown in FIG. 19 and the reset pulse RP2_{Y2} shown in FIG. 20 and the positive peak potential V_{SUS} of the sustain pulse IP.

FIG. 28 is a diagram showing the schematic configuration of a plasma display apparatus according to a third embodiment;

FIG. 29 is a front view schematically showing the internal structure of the PDP 50 as seen from the display-surface side;

FIG. 30 is a chart showing various types of drive pulses to be applied to the PDP 50 in [still image mode] in accordance with the emission drive sequence shown in FIG. 7;

FIG. 31 is a chart showing various types of drive pulses to be applied to the PDP 50 in [moving image mode] in accordance with the emission drive sequence shown in FIG. 7;

FIGS. 32A and 32B are charts showing the operations of generating the reset pulse RP_{Y1} in [still image mode] and [moving image mode], respectively, which are created by controlling the rising period of the pulse;

FIG. 33 is a diagram showing another configuration of the plasma display apparatus according to the present invention;

FIG. 34 is a chart showing various types of drive pulses to be applied to the PDP 50 in [still image mode] in accordance with the emission drive sequence shown in FIG. 17;

FIG. 35 is a chart showing various types of drive pulses to be applied to the PDP 50 in [moving image mode] in accordance with the emission drive sequence shown in FIG. 17;

FIGS. 36A and 36B are charts showing the operations of generating the reset pulse RP1_{Y1} (RP2_{Y1}) in [still image mode] and [moving image mode], respectively, which are created by controlling the rising period of the pulse; and

FIG. 37 is a chart showing another example of application of the reset pulses at the first reset stage R1.

### DETAILED DESCRIPTION OF THE INVENTION

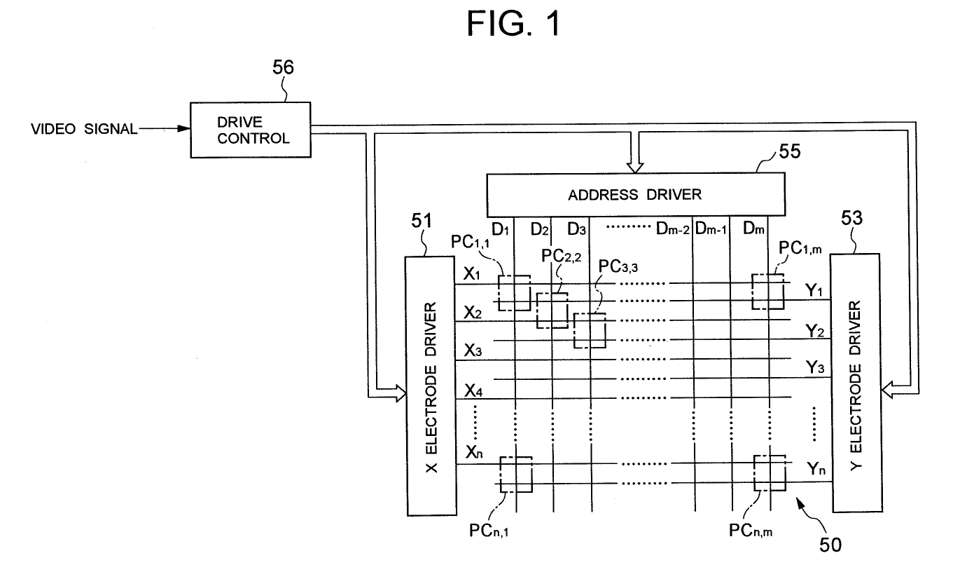

FIG. 1 is a diagram showing the general configuration of a plasma display apparatus which drives its plasma display panel according to a driving method of the present invention.

As shown in FIG. 1, this plasma display apparatus comprises a plasma display panel or PDP 50, an X electrode driver 51, a Y electrode driver 53, an address driver 55, and a drive control circuit 56.

The PDP 50 has column electrodes D₁ to Dₘ which are each arranged to extend in the vertical direction (perpendicular direction) of the two-dimensional display screen, and row electrodes X₁ to Xₙ and row electrodes Y₁ to Yₙ which are each arranged to extend in the lateral direction (horizontal direction). Here, pairs of mutually adjoining row electrodes (Y₁,X₁), (Y₂,X₂), (Y₃,X₃), . . . , (Yₙ,Xₙ) take charge of a first display line to an nth display line of the PDP 50, respectively. The intersections between the display lines and the column electrodes D₁ to Dₘ (the areas boxed in dotted lines in FIG. 1) are provided with respective discharge cells (display cells) PC which are in charge of pixels. More specifically, the PDP 50 has a matrix arrangement of discharge cells PC_{1,1} to PC_{1,m} which pertain to the first display line, discharge cells PC_{2,1} to PC_{2,m} which pertain to the second display line, . . . , discharge cells PC_{n,1} to PC_{n,m} which pertain to the nth display line.

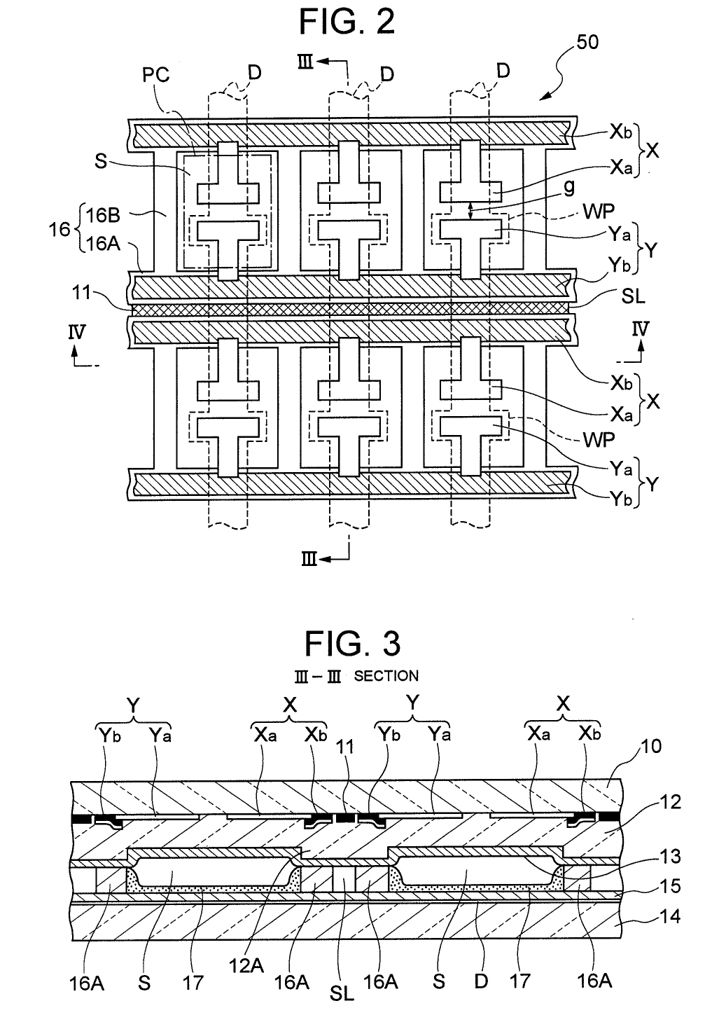

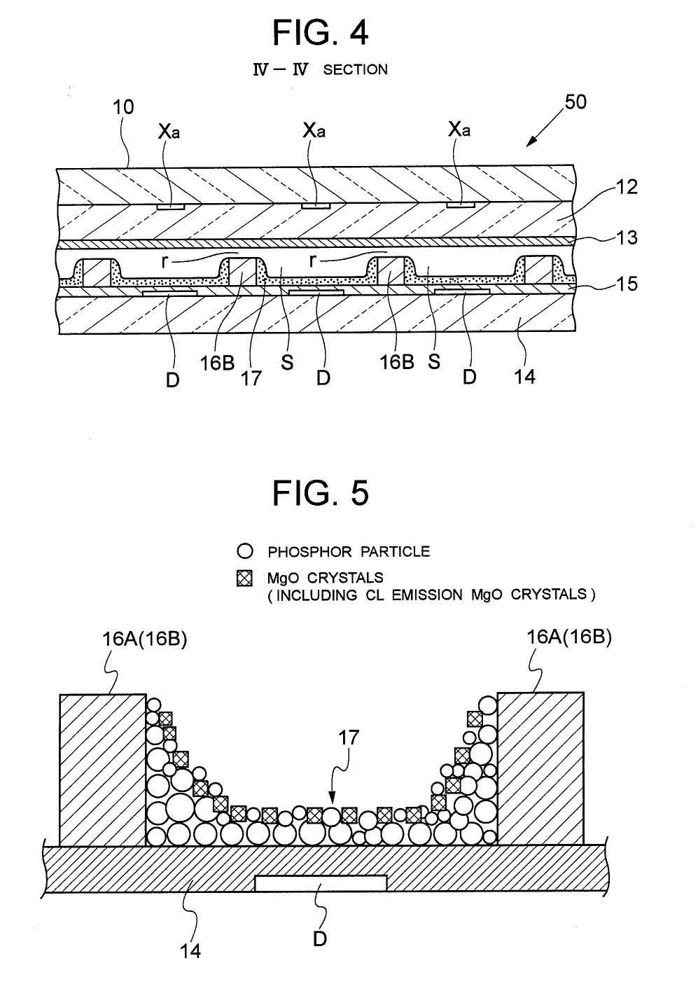

FIG. 2 is a front view schematically showing the internal structure of the PDP 50 as seen from the display-surface side. It should be appreciated that FIG. 2 selectively shows the intersections between three mutually adjoining column electrodes D and two mutually adjoining display lines. FIG. 3 is a diagram showing a cross section of the PDP 50, taken along the line V-V of FIG. 2. FIG. 4 is a diagram showing a cross section of the PDP 50, taken along the line W-W of FIG. 2.

As shown in FIG. 2, each row electrode X is composed of a bus electrode Xb which extends in the horizontal direction of the two-dimensional display screen, and transparent electrodes Xa of T shape which are arranged on this bus electrode Xb at positions corresponding to and in contact with respective discharge cells PC. Each row electrode Y is composed of a bus electrode Yb which extends in the horizontal direction of the two-dimensional display screen, and transparent electrodes Ya of T shape which are arranged on this bus electrode Yb at positions corresponding to and in contact with respective discharge cells PC. The transparent electrodes Xa and Ya are made of a transparent conductive film such as ITO. The bus electrodes Xb and Yb are made of a metal film, for example. As shown in FIG. 3, the row electrodes X, consisting of the transparent electrodes Xa and the bus electrodes Xb, and the row electrodes Y, consisting of the transparent electrodes Ya and the bus electrodes Yb, are formed on the back side of a front transparent substrate 10 whose front side is the display surface of the PDP 50. Here, the transparent electrodes Xa and Ya in each pair of row electrodes (X,Y) extend toward each other's row electrodes so that the top sides of their wide portions are opposed to each other with a discharge gap g of predetermined width therebetween. In addition, a black- or dark-colored light absorbing layer (shielding layer) 11 is formed on the back side of the front transparent substrate 10, between a pair of row electrodes (X,Y) and pairs of row electrodes (X,Y) adjoining to this pair of row electrodes, so as to extend in the horizontal direction of the two-dimensional display screen. A dielectric layer 12 is also formed on the back side of the front transparent substrate 10 so as to cover the pairs of row electrodes (X,Y). As shown in FIG. 3, a bank-raising dielectric layer 12A is formed on the back side of this dielectric layer 12 (on the surface opposite from where the pairs of row electrodes are in contact with), at areas corresponding to where the light absorbing layer 11 and the bus electrodes Xb and Yb adjoining to this light absorbing layer 11 are formed.

A magnesium oxide layer 13 is formed over the surfaces of the dielectric layer 12 and the bank raising dielectric layer 12A. This magnesium oxide layer 13 contains magnesium oxide crystals as a secondary electron emitting material for providing cathode luminescence (CL) emission that peaks at a wavelength within 200 to 300 nm, or within 230 to 250 nm in particular, when excited by irradiation of electron beams (hereinafter, referred to as CL emission MgO crystals). These CL emission MgO crystals are obtained by vapor-phase oxidation of magnesium vapor which is produced by heating magnesium, and have a polycrystalline structure in which cubic crystals fit into one another, or a cubic single crystalline structure, for example. The CL emission MgO crystals have an average particle size of 2000 angstroms or more (measurement by BET method).

When forming vapor-phase oxidized magnesium oxide single crystals that have particle sizes of or above 2000 angstroms in average particle size, the heating temperature for producing the magnesium vapor must be high. This increases the length of flame resulting from the reaction of magnesium and oxygen, widening the temperature difference between this flame and the surroundings. The greater the particle sizes are, the more the vapor-phase oxidized magnesium oxide single crystals that have energy levels corresponding to the peak wavelength of CL emission as described above (for example, near 235 nm or within 230 to 250 nm) are formed.

Moreover, since the vapor-phase oxidized magnesium oxide single crystals are produced by increasing the amount of magnesium to be vaporized per unit time for the sake of an increased reaction area between magnesium and oxygen, thereby causing reaction with a greater amount of oxygen as compared to typical vapor-phase oxidation techniques, they come to have energy levels corresponding to the peak wavelength of the foregoing CL emission.

The magnesium oxide layer 13 is formed by making such CL emission MgO crystals adhere to the surface of the dielectric layer 12 by spraying, electrostatic application, or the like. It should be appreciated that a thin film of magnesium oxide layer may be formed on the surface of the dielectric layer 12 by vapor deposition or sputtering, before CL emission MgO crystals are adhered thereon to form the magnesium oxide layer 13.

Meanwhile, the column electrodes D are formed on a rear substrate 14, which is arranged in parallel with the front transparent substrate 10, so that they extend in a direction orthogonal to the pairs of row electrodes (X,Y) at positions opposed to the respective transparent electrodes Xa and Ya in each pair of row electrodes (X,Y). As shown in FIG. 2, the column electrodes D of predetermined electrode width have wide portions WP that have an electrode width extended along the direction of the display lines, at areas opposed to the respective transparent electrodes Ya. Note that the column electrodes D do not have this wide portion WP at the areas opposed to the transparent electrodes Xa. Consequently, the presence of these wide portions WP makes it easier to produce a discharge between the column electrodes D and the transparent electrodes Ya than between the column electrodes D and the transparent electrodes Xa.

A white-colored column electrode protective layer 15 for covering the column electrodes D is also formed on the rear substrate 14. Partitions 16 are formed on this column electrode protective layer 15. The partitions 16 are formed in a ladder configuration, consisting of lateral walls 16A and vertical walls 16B. The lateral walls 16A extend in the lateral direction of the two-dimensional display screen at respective positions corresponding to the bus electrodes Xb and Yb in each pair of row electrodes (X,Y). The vertical walls 16B extend in the vertical direction of the two-dimensional display screen at respective intermediate positions between mutually adjoining column electrodes D. The partitions 16 of ladder configuration such as shown in FIG. 2 are also formed for each of the display lines of the PDP 50. A gap SL such as shown in FIG. 2 lies between mutually adjoining partitions 16. The partitions 16 of ladder configuration also define the discharge cells PC which include an independent discharge space S and transparent electrodes Xa and Ya each. A discharge gas which contains xenon gas is sealed in the discharge spaces S. In each of the discharge cells PC, a phosphor layer 17 is formed on the sides of the lateral walls 16A, the sides of the vertical walls 16B, and the surface of the column electrode protective layer 15 so that these surfaces are covered entirely. In fact, this phosphor layer 17 is made of three types of phosphors including one for emitting red light, one for emitting green light, and one for emitting blue light.

Note that the phosphor layer 17 contains MgO crystals (including CL emission MgO crystals) as the secondary electron emitting material in such a form as shown in FIG. 5. Here, the MgO crystals are exposed from the phosphor layer 17 at least on the surface of the phosphor layer 17, or equivalently on the surface where to touch the discharge space S, so that they make contact with the discharge gas.

Here, in each of the discharge cells PC, the discharge space S and the gap SL are closed to each other since the magnesium oxide layer 13 is in contact with the lateral walls 16A as shown in FIG. 3. In the meantime, as shown in FIG. 4, the vertical walls 16B and the magnesium oxide layer 13 are not in contact with each other, and thus have a gap r therebetween. In other words, the discharge spaces S of respective discharge cells PC that adjoin each other in the lateral direction of the two-dimensional display screen communicate with each other through this gap r.

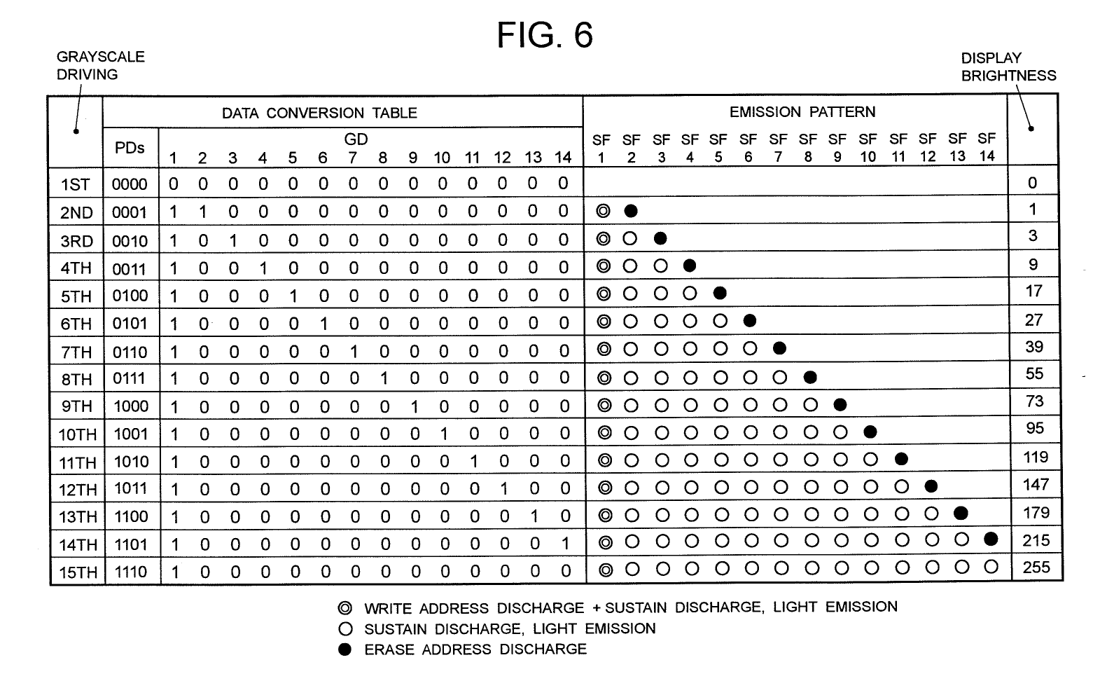

The drive control circuit 56 initially converts an input video signal into eight bits of pixel data for expressing all possible brightness levels in 256 grayscale levels pixel by pixel, and applies multi-grayscale processing consisting of error diffusion processing and dithering to this pixel data. In the error diffusion processing, the drive control circuit 56 adds pieces of error data on the pixel data corresponding to respective peripheral pixels with weights, and reflects the resultant on display data to obtain six bits of error-diffused pixel data, with the upper six bits of the foregoing pixel data as the display data and the remaining lower two bits as the error data. According to this error diffusion processing, the lower two bits of brightness of an original pixel is expressed by peripheral pixels in a pseudo fashion, so that brightness levels equivalent to eight bits of pixel data can be expressed by the display data of six bits, i.e., in less than eight bits. Next, the drive control circuit 56 applies dithering to the 6-bit error-diffused pixel data which is obtained by this error diffusion processing. In the dithering, dither coefficients consisting of mutually different coefficient values are assigned to the error-diffused pixel data corresponding to respective pixels in a single pixel unit and added to obtain dither-added pixel data, with a plurality of mutually adjoining pixels as this single pixel unit. According to the addition of dither coefficients, it is possible to express brightness equivalent to eight bits with only the upper four bits of dither-added pixel data when viewed in such pixel units as described above. Then, the drive control circuit 56 converts the upper four bits of the dither-added pixel data into four bits of multi-grayscale pixel data PDs which expresses all possible brightness levels in 15 grayscale levels as shown in FIG. 6. Then, the drive control circuit 56 converts the multi-grayscale pixel data PDs into 14 bits of pixel drive data GD according to a data conversion table such as shown in FIG. 6. The drive control circuit 56 associates the first to fourteenth bits of this pixel drive data GD with subfields SF1 to SF14 (to be described later), respectively, and supplies the bit digits corresponding to the subfields SF to the address driver 55 as pixel drive data bits in units of a single display line (m pieces).

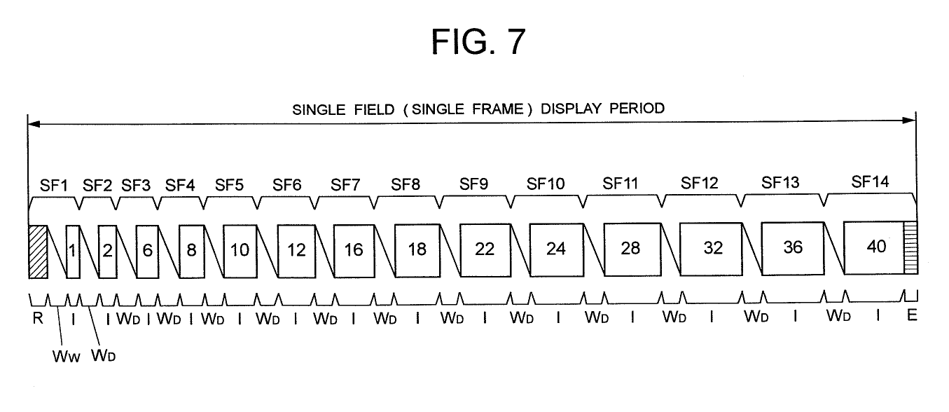

Moreover, the drive control circuit 56 supplies various types of control signals for driving the PDP 50 of the foregoing structure according to an emission drive sequence such as shown in FIG. 7, to a panel driver that consists of the X electrode driver 51, the Y electrode driver 53, and the address driver 55. More specifically, in the first subfield SF1 within a single field (single frame) display period such as shown in FIG. 7, the drive control circuit 56 supplies the panel driver with various types of control signals for performing driving in accordance with a reset stage R, a selective write address stage W_{W}, and a sustain stage I in succession. In each of the subfields SF2 to SF14, it also supplies the panel driver with various types of control signals for performing driving in accordance with a selective erase address stage W_{D} and a sustain stage I in succession. It should be appreciated that the drive control circuit 56 supplies, only in the last subfield SF14 within a single field display period, the panel driver with various types of control signals for performing driving in accordance with an erase stage E successively after the execution of a sustain stage I.

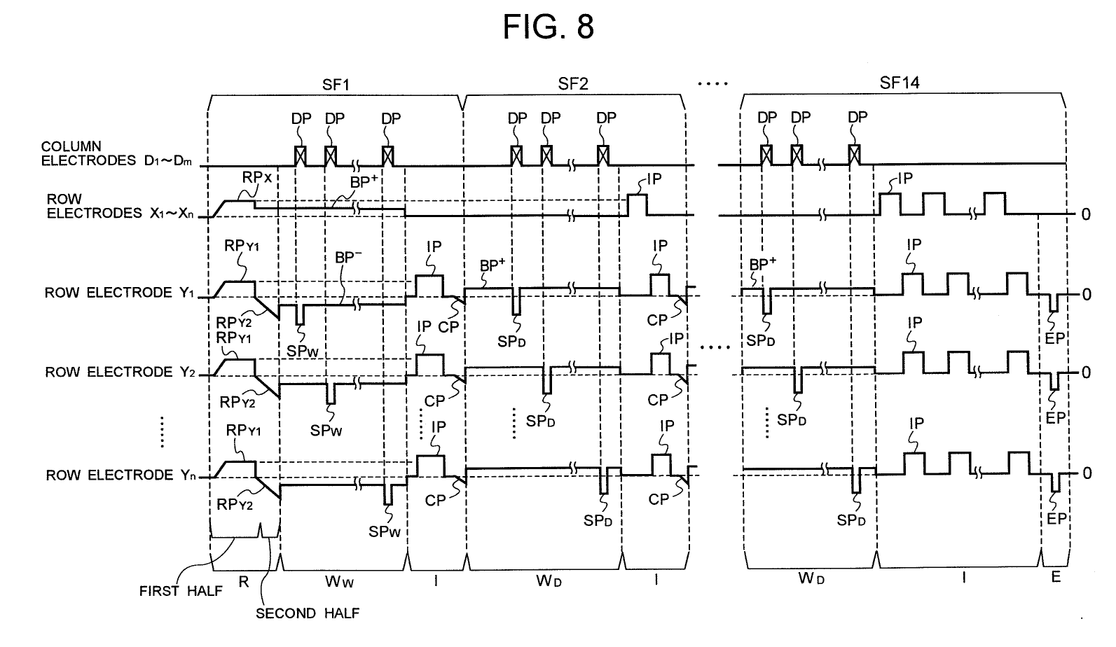

The panel driver, i.e., the X electrode driver 51, the Y electrode driver 53, and the address driver 55 generate various types of drive pulses such as shown in FIG. 8, and supply the same to the column electrodes D and the row electrodes X and Y of the PDP 50 in accordance with the various types of control signals supplied from the drive control circuit 56.

FIG. 8 selectively shows the operations only in the first subfield SF1, the subsequent subfield SF2, and the last subfield SF14 out of the subfields SF1 to SF14 shown in FIG. 7.

In the first half of the reset stage R in the subfield SF1, the Y electrode driver 53 initially applies to all the row electrodes Y₁ to Yₙ a positive reset pulse RP_{Y1} which has such a waveform that its front edge makes a gradual potential transition with a lapse of time as compared to a sustain pulse IP to be described later. It should be noted that the reset pulse RP_{Y1} has a positive peak potential lower than or equal to the positive peak potential of the sustain pulse IP mentioned above. In the meantime, the address driver 55 sets the column electrodes D₁ to Dₘ to the state of a ground potential (0 volt). The application of the foregoing reset pulse RP_{Y1} creates a first reset discharge between the row electrodes Y and the column electrodes D in all the discharge cells PC individually. That is, in the first half of the reset stage R, voltages are applied to between the electrodes with the row electrodes Y as anodes and the column electrodes D as cathodes, whereby a discharge for passing a current from the row electrodes Y to the column electrodes D (hereinafter, referred to as column side cathode discharge) occurs as the foregoing first reset discharge. In response to this first reset discharge, negative wall charges are formed near the row electrodes Y and positive wall charges are formed near the column electrodes D in all the discharge cells PC.

In the first half of the reset stage R, the X electrode driver 51 also applies a reset pulse RP_{X}, which has the same polarity as that of the reset pulse RP_{Y1} and has a positive peak potential that can prevent a surface discharge between the row electrodes X and Y due to the application of the reset pulse RP_{Y1}, to all the row electrodes X₁ to Xₙ individually. It should be noted that the positive peak potential of the reset pulse RP_{X} is lower than or equal to the positive peak potential of the sustain pulse IP to be described later.

Next, in the second half of the reset stage R in the subfield SF1, the Y electrode driver 53 generates a negative reset pulse RP_{Y2} whose front edge makes a gradual potential transition with a lapse of time, and applies the same to all the row electrodes Y₁ to Yₙ. In the second half of the reset stage R, the X electrode driver 51 also applies a base pulse BP⁺, having a predetermined positive potential, to all the row electrodes X₁ to Xₙ individually. Here, the application of these negative reset pulse RP_{Y2} and positive base pulse BP⁺ creates a second reset discharge between the row electrodes X and Y in all the discharge cells PC. Note that the peak potentials of the reset pulse RP_{Y2} and the base pulse BP⁺ both are minimum potentials that can create the second reset discharge between the row electrodes X and Y with reliability, in consideration of the wall charges that are formed near the respective row electrodes X and Y in response to the foregoing first reset discharge. Moreover, the negative peak potential of the reset pulse RP_{Y2} is set to a potential higher than the peak potential of a negative write scan pulse SP_{W} to be described later, or equivalently, a potential closer to zero volts. The reason is that if the peak potential of the reset pulse RP_{Y2} is set to be lower than the peak potential of the write scan pulse SP_{W}, a strong discharge can occur between the row electrodes Y and the column electrodes D. This might erase much of the wall charges formed near the column electrodes D, making an address discharge in the selective write address stage W_{W} unstable.

Here, the second reset discharge created in the second half of the reset stage R erases the wall charges formed near the respective row electrodes X and Y in each discharge cell PC, whereby all the discharge cells PC are initialized into extinction mode. In addition, the application of the foregoing reset pulse RP_{Y2} also creates a weak discharge between the row electrodes Y and the column electrodes D in all the discharge cells PC. This discharge erases part of the positive wall charges formed near the column electrodes D, thereby adjusting them to an amount capable of properly producing a selective write address discharge in the selective write address stage W_{W} to be described later.

Next, at the selective write address stage W_{W} of the subfield SF1, the Y electrode driver 53 applies a base pulse BP⁻ having a predetermined negative potential such as shown in FIG. 8 to the row electrodes Y₁ to Yₙ at the same time while selectively applying a write scan pulse SP_{W} having a negative peak potential to each of the row electrodes Y₁ to Yₙ in succession. The X electrode driver 51 continues applying the base pulse BP⁺, which has been applied to the row electrodes X₁ to Xₙ in the second half of the reset stage R, to each of the row electrodes X₁ to Xₙ even in this selective write address stage W_{W}. It should be appreciated that the potentials of the base pulse BP⁻ and the base pulse BP⁺ both are set so that the voltages between the row electrodes X and Y fall below the discharge start voltage of the discharge cells PC during a period when the write scan pulse SP_{W} is not applied.

Moreover, in this selective write address stage W_{W}, the address driver 55 initially converts pixel drive data bits corresponding to the subfield SF1 into pixel data pulses DP which have pulse voltages according to their logic levels. For example, if a pixel drive data bit of logic level 1 for setting a discharge cell PC to lighting mode is supplied, the address driver 55 converts it into a pixel data pulse DP having a positive peak potential. For a pixel drive data bit of logic level 0 for setting a discharge cell PC to extinction mode, on the other hand, it converts this into a pixel data pulse DP of low voltage (0 volts). The address driver 55 then applies these pixel data pulses DP to the column electrodes D₁ to Dₘ in units of a single display line (m pulses) in synchronization with the timing of application of each write scan pulse SP_{W}. Here, simultaneously with the write scan pulse SP_{W}, a selective write address discharge occurs between the column electrodes D and the row electrodes Y in discharge cells PC to which pixel data pulses DP of high voltage for setting to the lighting mode are applied. Furthermore, immediately after the selective write address discharge, a weak discharge also occurs between the row electrodes X and Y in these discharge cells PC. More specifically, after the application of the write scan pulse SP_{W}, a voltage corresponding to the base pulse BP⁻ and the base pulse BP⁺ is applied to between the row electrodes X and Y. Since this voltage is set to be lower than the discharge start voltage of the discharge cells PC, no discharge will be created inside the discharge cells PC by the application of this voltage alone. If the selective write address discharge is created, however, a discharge can be created between the row electrodes X and Y even by means of the voltage application based on the base pulse BP⁻ and the base pulse BP⁺ alone, being induced by this selective write address discharge. By this discharge and the selective write address discharge, these discharge cells PC are set into a state where positive wall charges are formed near the row electrodes Y, negative wall charges are formed near the row electrodes X, and negative wall charges are formed near the, column electrodes D, i.e., into the lighting mode. In discharge cells PC to which pixel data pulses DP of low voltage (0 volts) for setting to the extinction mode are applied, on the other hand, such a selective write address discharge as mentioned above will not occur between the column electrodes D and the row electrodes Y simultaneously with the foregoing write scan pulse SP_{W}. Thus, the row electrodes X and Y will not produce any discharge therebetween, either. Consequently, these discharge cells PC maintain their immediately preceding state, i.e., the state of the extinction mode into which they are initialized at the reset stage R.

Next, at the sustain stage I of the subfield SF1, the Y electrode driver 53 generates a single sustain pulse IP having a positive peak potential, and applies it to each of the row electrodes Y₁ to Yₙ simultaneously. In the meantime, the X electrode driver 51 sets the row electrodes X₁ to Xₙ into the state of the ground potential (0 volts). The address driver 55 sets the column electrodes D₁ to Dₘ to the state of the ground potential (0 volts). With the application of the foregoing sustain pulse IP, a sustain discharge occurs between the row electrodes X and Y in the discharge cells PC that are set to the lighting mode as described above. Light emitted from the phosphor layer 17 in response to this sustain discharge is emitted outside through the front transparent substrate 10, thereby performing a single round of display light emission corresponding to the brightness weight of this subfield SF1. With the application of this sustain pulse IP, a discharge also occurs between the row electrodes Y and the column electrodes D in the discharge cells PC that are set to the lighting mode. This discharge and the foregoing sustain discharge produce negative wall charges near the row electrodes Y and positive wall charges near the row electrodes X and the column electrodes D in the discharge cells PC. Then, after the application of this sustain pulse IP, the Y electrode driver 53 applies to the row electrodes Y₁ to Yₙ a wall charge adjusting pulse CP having a negative peak potential whose front edge makes a gradual potential transition with a lapse of time as shown in FIG. 8. With the application of this wall charge adjusting pulse CP, a weak erase discharge occurs in the discharge cells PC that have undergone the foregoing sustain discharge, whereby the wall charges formed inside are erased in part. As a result, the wall charges in the discharge cells PC are adjusted to an amount capable of properly producing a selective erase address discharge in the subsequent selective erase address stage W_{D}.

Next, at the selective erase address stage W_{D} in each of the subfields SF2 to SF14, the Y electrode driver 53 applies the base pulse BP⁺ having a predetermined positive potential to each of the row electrodes Y₁ to Yₙ while selectively applying an erase scan pulse SP_{D} having a negative peak potential such as shown in FIG. 8 to each of the row electrodes Y₁ to Yₙ in succession. It should be appreciated that the peak potential of the base pulse BP⁺ is set at a potential capable of avoiding any accidental discharge between the row electrodes X and Y over the period of execution of this selective erase address stage W_{D}. The X electrode driver 51 also sets each of the row electrodes X₁ to Xₙ to the ground potential (0 volts) over the period of execution of the selective erase address stage W_{D}. Moreover, at this selective erase address stage W_{D}, the address driver 55 initially converts pixel drive data bits corresponding to that subfield SF into pixel data pulses DP that have pulse voltages according to their logic levels. For example, if a pixel drive data bit of logic level 1 for shifting a discharge cell PC from the lighting mode to the extinction mode is supplied, the address driver 55 converts this into a pixel data pulse DP having a positive peak potential. If a pixel drive data bit of logic level 0 for maintaining a discharge cell PC in its present state is supplied, on the other hand, it converts this into a pixel data pulse DP of low voltage (0 volts). The address driver 55 then applies these pixel data pulses DP to the column electrodes D₁ to Dₘ in units of a single display line (m pulses) in synchronization with the timing of application of each erase scan pulse SP_{D}. Here, simultaneously with the erase scan pulse SP_{D}, a selective erase address discharge occurs between the column electrodes D and the row electrodes Y in discharge cells PC to which the pixel data pulses DP of high voltage are applied. By this selective erase address discharge, these discharge cells PC are set into the state where positive wall charges are formed near the row electrodes Y and X, and negative wall charges are formed near the column electrodes D, i.e., into the extinction mode. In discharge cells PC to which pixel data pulses DP of low voltage (0 volts) are applied, on the other hand, the foregoing selective erase address discharge will not occur between the column electrodes D and the row electrodes Y simultaneously with the foregoing erase scan pulse SP_{D}. These discharge cells PC therefore maintain their immediately preceding states (lighting mode or extinction mode).

Next, at the sustain stage I in each of the subfields SF2 to SF14, the X electrode driver 51 and the Y electrode driver 53 apply the sustain pulse IP having a positive peak potential to each of the respective row electrodes X₁ to Xₙ and Y₁ to Yₙ repeatedly as many times (an even number of times) as corresponding to the brightness weight of that subfield, taking turns to the row electrodes X and Y alternately as shown in FIG. 8. Each time this sustain pulse IP is applied, a sustain discharge occurs between the row electrodes X and Y in the discharge cells PC that are set to the lighting mode. The light emitted from the phosphor layer 17 in response to this sustain discharge is emitted outside through the front transparent substrate 10, thereby providing as many times of display light emission as corresponding to the brightness weight of that subfield SF. Here, in the discharge cells PC that have undergone a sustain discharge corresponding to the last sustain pulse IP applied at the sustain stage I of each of the subfields SF2 to SF14, negative wall charges are formed near the row electrodes Y and positive wall charges are formed near the row electrodes X and the column electrodes D. Then, after the application of the last sustain pulse IP, the Y electrode driver 53 applies to the row electrodes Y₁ to Yₙ a wall charge adjusting pulse CP having a negative peak potential whose front edge makes a gradual potential transition with a lapse of time as shown in FIG. 8. With the application of this wall charge adjusting pulse CP, a weak erase discharge occurs in the discharge cells PC that have undergone the foregoing sustain discharge, whereby the wall charges formed inside are erased in part. As a result, the wall charges in the discharge cells PC are adjusted to an amount capable of properly producing a selective erase address discharge in the subsequent selective erase address stage W_{D}.

Then, in the erase stage E at the end of the last subfield SF14, the Y electrode driver 53 applies an erase pulse EP having a negative peak potential to all the row electrodes Y₁ to Yₙ. With the application of this erase pulse EP, an erase discharge occurs only in the discharge cells PC that are in the lighting mode. By this erase discharge, the discharge cells PC in the lighting mode are brought into the extinction mode.

The foregoing driving is performed based on 15 possible values of pixel drive data GD such as shown in FIG. 6. According to this driving, as shown in FIG. 6, a write address discharge (indicated by a double circle) initially occurs in each discharge cell PC in the first subfield SF1, thereby setting this discharge cell PC into the lighting mode, except when expressing brightness level 0 (first tone level). Subsequently, a selective erase address discharge (indicated by a black circle) occurs at the selective erase address stage W_{D} of only one of the subfields SF2 to SF14. The discharge cell PC is then set into the extinction mode. In other words, each discharge cell PC is set to the lighting mode in consecutive subfields as many as corresponding to its intermediate brightness to be expressed, and repeats light emission (indicated by a white circle) resulting from a sustain discharge as many times as the numbers assigned to these respective subfields. Here, what is visualized is the brightness corresponding to the total number of sustain discharges created within a single field (or single frame) display period. Consequently, according to the 15 types of emission patterns corresponding to the first to fifteenth levels of driving such as shown in FIG. 6, 15 levels of intermediate brightness are expressed corresponding to the total numbers of sustain discharges created in the respective subfields that are indicated by white circles.

This driving precludes areas of inverted emission patterns (lighting state, extinction state) from concurrently appearing on a single screen within a single field display period, thereby avoiding false contours which tend to occur in these states.

Now, according to the driving shown in FIG. 8, a voltage is applied to between the electrodes with the column electrodes D as cathodes and the row electrodes Y as anodes at the reset stage R of the first subfield SF1, so that a column side cathode discharge of passing a current from the row electrodes Y to the column electrodes D occurs as the first reset discharge. At the time of this first reset discharge, positive ions in the discharge gas therefore travel toward the column electrodes D, in which time they collide with MgO crystals, or secondary electron emitting material, contained in the phosphor layer 17 such as shown in FIG. 5 and make these MgO crystals emit secondary electrons. In particular, in the PDP 50 of the plasma display apparatus shown in FIG. 1, MgO crystals are exposed to the discharge spaces as shown in FIG. 5. This increases the collision probability with positive ions, so that secondary electrons are emitted to the display spaces with high efficiency. It follows that the priming effect of these secondary electrons lowers the discharge start voltage of the discharge cells PC, making it possible to create a relatively weak reset discharge. Since the weakened reset discharge reduces the emission brightness ascribable to that discharge, it becomes possible to display with improved dark contrast.

Moreover, according to the driving shown in FIG. 8, the first reset discharge is created between the row electrodes Y which are formed on the front transparent substrate 10 and the column electrodes D which are formed on the rear substrate 14 as shown in FIG. 3. As compared to the cases where a reset discharge is created between the row electrodes X and Y both of which are formed on the front transparent substrate 10, it is therefore possible to reduce the discharge light to be emitted outside from the front transparent substrate 10, with a further improvement in the dark contrast.

In addition, according to the driving shown in FIGS. 7 and 8, the reset discharge intended to initialize all the discharge cells PC into the extinction mode is created in the first subfield SF1 before a selective write address discharge intended to shift the discharge cells PC in this extinction mode into the lighting mode is created. Then, in this driving which employs the selective erase address method, a selective erase address discharge intended to shift the discharge cells PC in the lighting mode into the extinction mode is created in any one of the subfields SF2 to SF14 subsequent to SF1. When displaying black (brightness level 0) by this driving, the discharges to be created within a single field display period are only the reset discharge in the first subfield SF1. In other words, the number of discharges to be created within a single field display period decreases as compared to the cases of performing such driving that a reset discharge for initializing all the display cells PC into the lighting mode is created in the first subfield SF1 and then a selective erase address discharge intended to shift them into the extinction mode is created. Consequently, according to the driving shown in FIGS. 7 and 8, it is possible to improve the contrast when displaying dark images, i.e., so-called dark contrast.

Now, according to the driving shown in FIG. 8, a sustain discharge is created only once at the sustain stage I of the subfield SF1 which has the smallest brightness weight, thereby improving the display producibility at lower grayscale levels for expressing low brightness. At the sustain stage I of the subfield SF1, the number of sustain pulses IP to be applied in order to create the sustain pulse is also only one. In the state after the extinction of the sustain discharge that is created in response to this one sustain pulse IP, negative wall charges are therefore formed near the row electrodes Y, and positive wall charges are formed near the column electrodes D. Consequently, at the selective erase address stage W_{D} in the next subfield SF2, the column electrodes D and the row electrodes Y can create a discharge therebetween as a selective erase address discharge with the column electrodes D as anodes (hereinafter, referred to as column side anode discharge). Meanwhile, at the sustain stage I of each of the subsequent subfields SF2 to SF14, the sustain pulse IP is applied an even number of times. As a result, in the state immediately after the completion of each sustain stage I, negative wall charges are formed near the row electrodes Y and positive wall charges are formed near the column electrodes D. This allows a column side anode discharge at the selective erase address stage W_{D} that is performed subsequent to each sustain stage I. Since the column electrodes D are subjected to positive pulses alone, it is possible to avoid an increase in the cost of the address driver 55.

It should be noted that the PDP 50 shown in FIG. 1 is configured so that CL emission MgO crystals, or secondary electron emitting material, are contained not only in the magnesium oxide layer 13 which is formed on the front transparent substrate 10 in each discharge cell PC, but also in the phosphor layer 17 which is formed on the rear substrate 14.

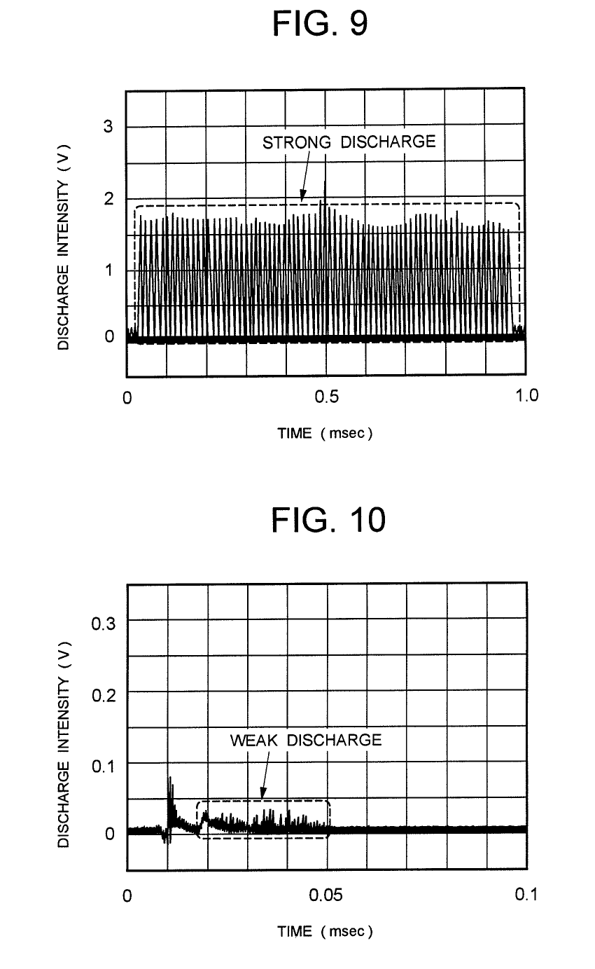

Hereinafter, the operation and effect of employment of the foregoing configuration will be described with reference to FIGS. 9 and 10.

FIG. 9 is a chart showing the transition of the discharge intensity of a column side cathode discharge that occurs when the reset pulse RP_{Y1} such as shown in FIG. 8 is applied to a so-called conventional PDP in which CL emission MgO crystals are contained in the magnesium oxide layer 13 alone, out of the foregoing magnesium oxide layer 13 and phosphor layer 17.

FIG. 10, on the other hand, is a diagram showing the transition of the discharge intensity of a column side cathode discharge that occurs when the reset pulse RP_{Y1} is applied to the PDP 50 according to the present invention in which CL emission MgO crystals are contained both in the magnesium oxide layer 13 and the phosphor layer 17.

As shown in FIG. 9, according to the conventional PDP, a column side cathode discharge of relatively high intensity continues for more than 1 [ms](millisecond) in response to the application of the reset pulse RP_{Y1}. In the PDP 50 according to the present invention, however, the column side cathode discharge extinguishes within approximately 0.04 [ms] as shown in FIG. 10. That is, the discharge delay time of the column side cathode discharge can be reduced significantly as compared to the conventional PDP.

As a result, even if the reset pulse RP_{Y1} has a positive peak potential lower than the positive peak potential of the sustain pulse IP as shown in FIG. 8, it is possible to create the first reset discharge, a column side cathode discharge, with reliability. Here, since the positive peak potential of the reset pulse RP_{Y1} is a relatively low potential, the resulting column side cathode discharge is also weak.

Consequently, according to the present invention, a column side cathode discharge of extremely low discharge intensity can be created as the reset discharge. This can improve the image contrast, or the dark contrast when displaying dark images in particular.

In the embodiment shown in FIG. 8, the reset pulse RP_{X} to be applied simultaneously with the reset pulse RP_{Y1} has a positive peak potential lower than or equal to the positive peak potential of the sustain pulse IP. The positive peak potential of the reset pulse RP_{X} may be set to be higher, however, if the column electrodes D employ the configuration such as shown in FIG. 2 each. More specifically, when the wide portions WP having an increased electrode width along the direction of the display lines are formed on the respective column electrodes D at areas where opposed to the transparent electrodes Ya as shown in FIG. 2, discharges are more difficult to occur between the column electrodes D and the row electrodes X than between the column electrodes D and the row electrodes Y. Here, the positive peak potential of the reset pulse RP_{X} may be made higher than the positive peak potential of the sustain pulse IP unless the column electrodes D and the row electrodes X create any discharge therebetween in the first half of the reset stage R.

Moreover, while the first half of the reset stage R shown in FIG. 8 includes creating the first reset discharge as a column side cathode discharge by applying the reset pulse RP_{Y1} to the row electrodes Y₁ to Yₙ, this process may be omitted.

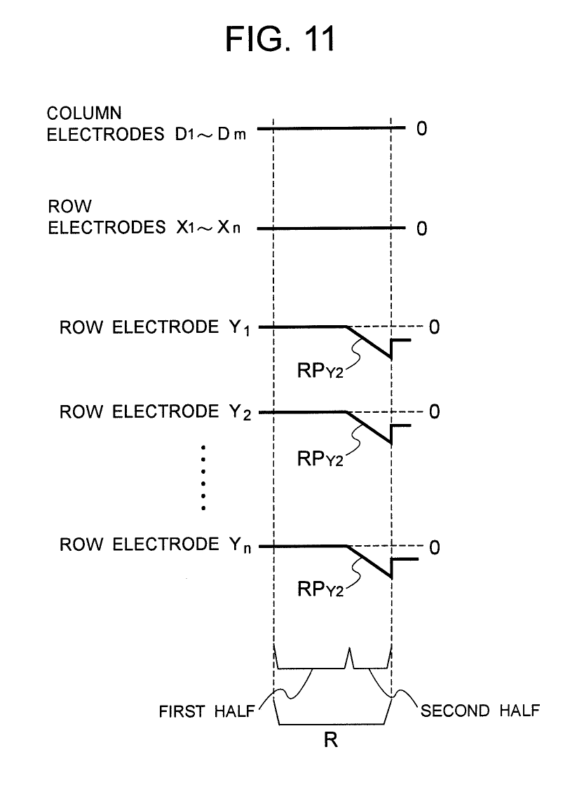

For example, such a reset stage R as shown in FIG. 11 is employed instead of the reset stage R shown in FIG. 8. As shown in FIG. 11, the row electrodes Y₁ to Yₙ are fixed to the ground potential in the first half of the reset stage R. That is, the column side cathode discharge in the first half of the reset stage R is intended to emit charged particles for the sake of stabilizing the write discharge in the selective write address stage W_{W}. Here, if the PDP is configured so that the phosphor layer contains MgO crystals including CL emission MgO crystals such as shown in FIG. 5, the write discharge is even stabilized as compared to the cases of not employing configuration like this. As a result, it is possible to employ the configuration of fixing both the row electrodes Y and the column electrodes D to the ground potential in the first half of the reset stage R so as not to create a column side cathode discharge. In this case, the row electrodes X may also be set to the ground potential level as in FIG. 11. This omission of the first reset discharge at the reset stage R improves the dark contrast further since the light emission from the entire screen, not contributing to display images, disappears. It should be appreciated that even if the first reset discharge is omitted, all the discharge cells PC are initialized into the extinction mode by immediately before the selective write address stage W_{W}, through the operation at the erase stage E of the previous field and the operation in the second half of the reset stage R such as described above.

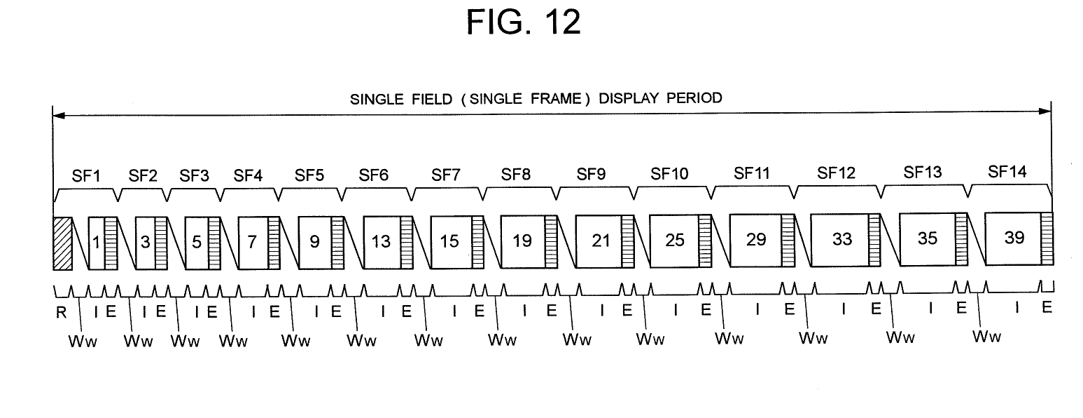

In the foregoing embodiment, the PDP 50 is driven in accordance with the emission drive sequence that employs such a selective erase address method as shown in FIG. 7. Nevertheless, it may be driven in accordance with an emission drive sequence that employs a selective write address method such as shown in FIG. 12.

More specifically, the drive control circuit 56 supplies the panel driver with various types of control signals for performing driving in accordance with a selective write address stage W_{W}, a sustain stage I, and an erase stage E in succession in each of the subfields SF1 to SF14 such as shown in FIG. 12. It should be appreciated that the drive control circuit 56 supplies the panel driver with various types of control signals for performing driving in accordance with a reset stage R prior to the selective write address stage W_{W}, only in the first subfield SF1.

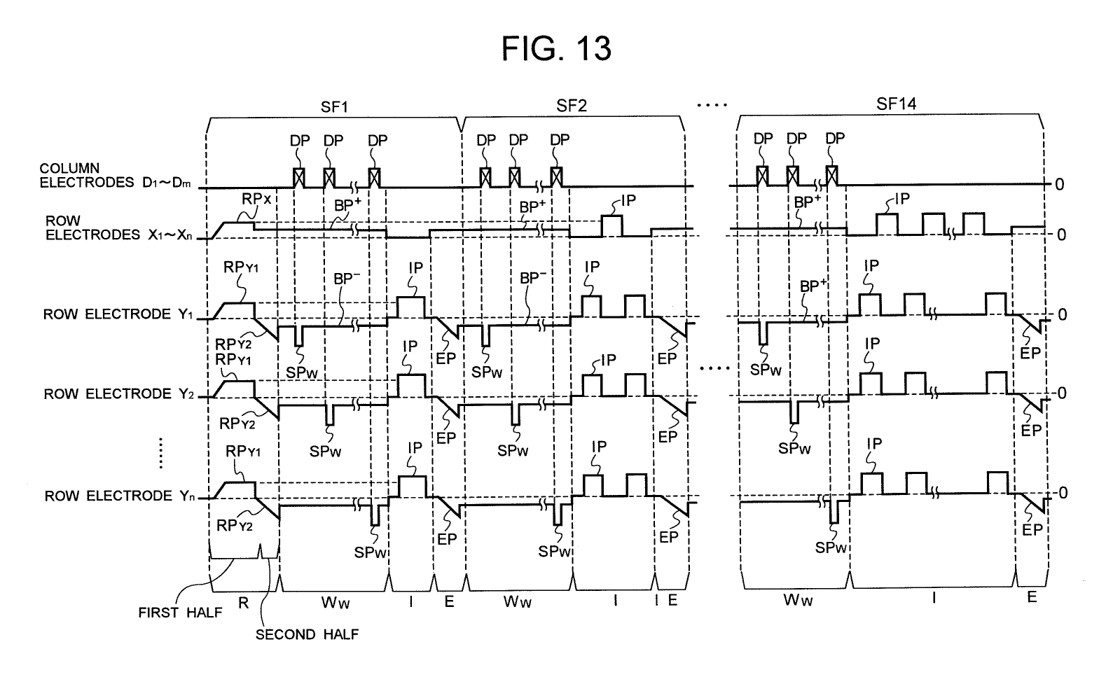

The panel driver, i.e., the X electrode driver 51, the Y electrode driver 53, and the address driver 55 generate various types of drive pulses such as shown in FIG. 13, and supply the same to the column electrodes D and the row electrodes X and Y of the PDP 50 in accordance with the various types of control signals supplied from the drive control circuit 56.

FIG. 13 selectively shows the operations only in the first subfield SF1, the subsequent subfield SF2, and the last subfield SF14 out of the subfields SF1 to SF14 shown in FIG. 12.

In the first half of the reset stage R in the first subfield SF1, the Y electrode driver 53 initially applies to all the row electrodes Y₁ to Yₙ a positive reset pulse RP_{Y1} which has such a waveform that its front edge makes a gradual potential transition with a lapse of time as compared to the sustain pulse IP. Note that the reset pulse RP_{Y1} has a positive peak potential lower than or equal to the positive peak potential of the sustain pulse IP mentioned above. In the meantime, the address driver 55 sets the column electrodes D, to Dₘ to the state of the ground potential (0 volt). The application of the foregoing reset pulse RP_{Y1} creates a first reset discharge between the row electrodes Y and the column electrodes D in all the discharge cells PC individually. That is, in the first half of the reset stage R, voltages are applied to between the electrodes with the row electrodes Y as anodes and the column electrodes D as cathodes, so that a column side cathode discharge of passing a current from the row electrodes Y to the column electrodes D occurs as the first reset discharge. In response to this first reset discharge, negative wall charges are formed near the row electrodes Y and positive wall charges are formed near the column electrodes D in all the discharge cells PC.

In the first half of the reset stage R, the X electrode driver 51 also applies a reset pulse RP_{X}, which has the same polarity as that of the reset pulse RP_{Y1} and has a positive peak potential capable of avoiding a surface discharge between the row electrodes X and Y due to the application of the reset pulse RP_{Y1}, to all the row electrodes X₁ to Xₙ individually. Noted that the positive peak potential of the reset pulse RP_{X} is lower than or equal to the positive peak potential of the sustain pulse IP.

Next, in the second half of the reset stage R in the subfield SF1, the Y electrode driver 53 generates a negative reset pulse RP_{Y2} whose front edge makes a gradual potential transition with a lapse of time, and applies it to all the row electrodes Y₁ to Yₙ. In the second half of the reset stage R, the X electrode driver 51 also applies a base pulse BP⁺, having a predetermined positive potential, to all the row electrodes X₁ to Xₙ individually. Here, the application of these negative reset pulse RP_{Y2} and positive base pulse BP⁺ creates a second reset discharge between the row electrodes X and Y in all the discharge cells PC. Note that the peak potentials of the reset pulse RP_{Y2} and the base pulse BP⁺ both are minimum potentials that can create the second reset discharge between the row electrodes X and Y with reliability, in consideration of the wall charges that are formed near the respective row electrodes X and Y in response to the foregoing first reset discharge. Moreover, the negative peak potential of the reset pulse RP_{Y2} is set to a potential higher than the peak potential of a negative write scan pulse SP_{W} to be described later, or equivalently, a potential closer to zero volts. The reason is that if the peak potential of the reset pulse RP_{Y2} is set to be lower than the peak potential of the write scan pulse SP_{W}, a strong discharge can occur between the row electrodes Y and the column electrodes D. This might erase much of the wall charges formed near the column electrodes D, making an address discharge in the selective write address stage W_{W} unstable.

Here, the second reset discharge created in the second half of the reset stage R erases the wall charges that are formed near the respective row electrodes X and Y in each discharge cell PC, whereby all the discharge cells PC are initialized into extinction mode. In addition, the application of the foregoing reset pulse RP_{Y2} also creates a weak discharge between the row electrodes Y and the column electrodes D in all the discharge cells PC. This discharge erases part of the positive wall charges formed near the column electrodes D, thereby adjusting them to an amount capable of properly producing a selective write address discharge in the selective write address stage W_{W} to be described later.

Next, at the selective write address stage W_{W} in each of the subfields SF1 to SF14, the Y electrode driver 53 applies a base pulse BP⁻ having a predetermined negative potential such as shown in FIG. 13 to the row electrodes Y₁ to Yₙ at the same time while selectively applying a write scan pulse SP_{W} having a negative peak potential to each of the row electrodes Y₁ to Yₙ in succession. The X electrode driver 51 applies the base pulse BP⁺, which has been applied to the row electrodes X₁ to Xₙ in the second half of the reset stage R, to each of the row electrodes X₁ to Xₙ similarly even in this selective write address stage W_{W}. It should be appreciated that the potentials of the base pulse BP⁻ and the base pulse BP⁺ both are set so that the voltages between the row electrodes X and Y fall below the discharge start voltage of the discharge cells PC during a period when the write scan pulse SP_{W} is not applied.

Moreover, at this selective write address stage W_{W}, the address driver 55 converts pixel drive data bits corresponding to that subfield SF subfield by subfield, into pixel data pulses DP having pulse voltages according to their logic levels. For example, if a pixel drive data bit of logic level 1 for setting a discharge cell PC to lighting mode is supplied, the address driver 55 converts it into a pixel data pulse DP having a positive peak potential. For a pixel drive data bit of logic level 0 for setting a discharge cell PC to extinction mode, on the other hand, it converts this into a pixel data pulse DP of low voltage (0 volts). The address driver 55 then applies these pixel data pulses DP to the column electrodes D₁ to D, in units of a single display line (m pulses) in synchronization with the timing of application of each write scan pulse SP_{W}. Here, simultaneously with the write scan pulse SP_{W}, a selective write address discharge occurs between the column electrodes D and the row electrodes Y in discharge cells PC to which pixel data pulses DP of high voltage for setting to the lighting mode are applied. Furthermore, immediately after the selective write address discharge, a weak discharge also occurs between the row electrodes X and Y in these discharge cells PC. More specifically, after the application of the write scan pulse SP_{W}, a voltage corresponding to the base pulse BP⁻ and the base pulse BP⁺ is applied to between the row electrodes X and Y. Since this voltage is set to be lower than the discharge start voltage of the discharge cells PC, no discharge will be creased inside the discharge cells PC by the application of this voltage alone. If the selective write address discharge is created, however, a discharge can be created between the row electrodes X and Y even by means of the voltage application based on the base pulse BP⁻ and the base pulse BP⁺ alone, being induced by this selective write address discharge. By this discharge and the foregoing selective write address discharge, these discharge cells PC are set into a state where positive wall charges are formed near the row electrodes Y, negative wall charges are formed near the row electrodes X, and negative wall charges are formed near the column electrodes D, i.e., into the lighting mode. In discharge cells PC to which pixel data pulses DP of low voltage (0 volts) for setting to the extinction mode are applied, on the other hand, such a selective write address discharge as described above will not occur between the column electrodes D and the row electrodes Y simultaneously with the foregoing write scan pulse SP_{W}. Thus, the row electrodes X and Y will not produce any discharge therebetween, either. These discharge cells PC therefore maintain their immediately preceding state of the extinction mode.

At the sustain stage I of the first subfield SF1, the Y electrode driver 53 generates a single sustain pulse IP having a positive peak potential, and applies this to each of the row electrodes Y₁ to Yₙ simultaneously. In the meantime, the X electrode driver 51 sets the row electrodes X₁ to Xₙ into the state of the ground potential (0 volts). The address driver 55 sets the column electrodes D₁ to Dₘ into the state of the ground potential (0 volts). The application of the sustain pulse IP creates a sustain discharge between the row electrodes X and Y in the discharge cells PC that are set to the lighting mode. The light emitted from the phosphor layer 17 in response to this sustain discharge is emitted outside through the front transparent substrate 10, thereby performing a single round of display light emission corresponding to the brightness weight of this subfield SF1. With the application of this sustain pulse IP, a discharge also occurs between the row electrodes Y and the column electrodes D in the discharge cells PC that are set to the lighting mode. This discharge and the foregoing sustain discharge produce negative wall charges near the row electrodes Y and positive wall charges near the row electrodes X and the column electrodes D in the discharge cells PC.

Next, at the erase stage E in each of the subfields SF1 to SF14, the Y electrode driver 53 applies to the row electrodes Y₁ to Yₙ a negative erase pulse EP having the same waveform as that of the reset pulse RP_{Y2} which is applied in the second half of the reset stage R. In the meantime, the X electrode driver 51 applies the base pulse BP⁺, having a predetermined positive base potential, to each of all the row electrodes X₁ to Xₙ as in the second half of the reset stage R. In response to these erase pulse EP and base pulse BP⁺, a weak erase discharge occurs in the discharge cells PC that have undergone the foregoing sustain discharge. This erase discharge erases part of the wall charges formed in the discharge cells PC, so that these discharge cells PC enter the extinction mode. Furthermore, in response to the application of the erase pulse EP, a weak discharge also occurs between the column electrodes D and the row electrodes Y in the discharge cells PC. By this discharge, the positive wall charges formed near the column electrodes D are adjusted to an amount capable of properly producing a selective write address discharge at the next selective write address stage W_{W}.

Next, at the sustain stage I of each of the subfields SF2 to SF14, the X electrode driver 51 and the Y electrode driver 53 apply a sustain pulse IP having a positive peak potential to the row electrodes Y₁ to Yₙ and X₁ to Xₙ repeatedly as many times as corresponding to the brightness weight of that subfield, taking turns to the row electrodes Y and X alternately as shown in FIG. 13. Each time this sustain pulse IP is applied, a sustain discharge occurs between the row electrodes X and Y in the discharge cells PC that are set to the lighting mode. The light emitted from the phosphor layer 17 in response to this sustain discharge is emitted outside through the front transparent substrate 10, thereby performing as many times of display light emission as corresponding to the brightness weight of that subfield SF. It should be noted that the total number of sustain pulses IP to be applied within each sustain stage I is an odd number. That is, in each sustain stage I, the first sustain pulse IP and the last sustain pulse IP both are applied to the row electrodes Y. As a result, immediately after the completion of each sustain stage I, negative wall charges are formed near the row electrodes Y and positive wall charges are formed near the row electrodes X and the column electrodes D in the discharge cells PC that have undergone the sustain discharges. This brings the wall charges formed in each discharge cell PC into the same condition as immediately after the first reset discharge at the reset stage R. Consequently, at the immediately-following erase stage E,.the erase pulse EP having the same waveform as that of the reset pulse RP_{Y2}, which is applied in the second half of the reset stage R, can be applied to the row electrodes Y so that all the discharge cells PC enter the state of the extinction mode.

Here, when practicing the driving shown in FIGS. 12 and 13, (N+1) grayscale levels (N: the number of subfields in a single field display period) of intermediate brightness can be displayed if the selective write address discharge is created at the selective write address stage W_{W} in each of the first and subsequent subfields. More specifically, with the fourteen subfields SF1 to SF14, sustain discharges are created in each of as many subfields successive to the first subfield SF1 as corresponding to the tone level to express as shown in FIG. 6. This makes it possible to display intermediate brightness in fifteen grayscale levels while avoiding false contours.

Moreover, when practicing the driving shown in FIGS. 12 and 13, 2^{N} grayscale levels (N: the number of subfields in a single field display period) of intermediate brightness can be expressed depending on the combination of subfields to create a selective write address discharge among all the subfields within a single field display period. More specifically, since the fourteen subfields SF1 to SF14 have 2¹⁴ patterns of combination of subfields to create a selective write address discharge, it is possible to display intermediate brightness in 16384 grayscale levels.

According to the driving shown in FIGS. 12 and 13, the reset pulse RP_{Y2} to be applied to the row electrodes Y at the reset stage R and the erase pulse EP to be applied to the row electrodes Y at the erase stage E have the same waveforms, and both can thus be generated by a common circuit. Since the selective write address stage W_{W} is also performed consistently in every subfield SF1 to SF14, the scan pulses can be generated only by a single system of circuitry. In addition, each of the selective write address stages W_{W} has only to create an ordinary column side anode discharge, using the column electrodes as anodes.

Consequently, when the driving based on the selective write address method such as shown in FIGS. 12 and 13 is employed to drive the PDP 50, the panel driver for generating the various types of drive pulses can be constructed at low price as compared to the cases where the driving based on the selective erase address method such as shown in FIGS. 7 and 8 is employed.

Moreover, while the reset discharge is created in all the display cells simultaneously at the reset stage R shown in FIGS. 8 and 13, reset discharges may be created in a temporally distributed fashion in units of display cell blocks each consisting of a plurality of display cells.

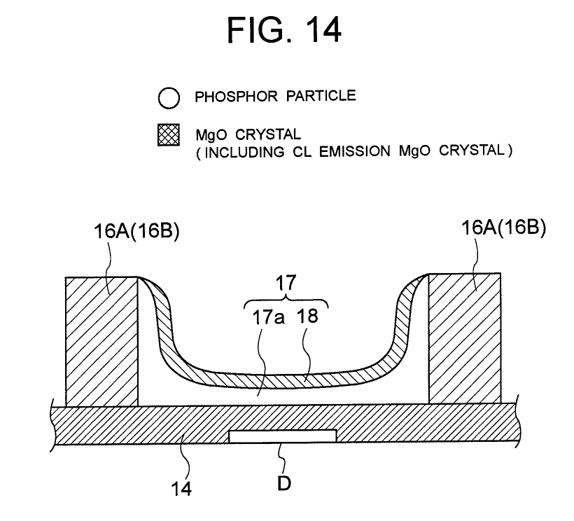

In the present embodiment shown in FIG. 5, MgO crystals are contained in the phosphor layer 17 which is formed on the rear substrate 14 of the PDP 50. Nevertheless, as shown in FIG. 14, the phosphor layer 17 may be formed by laminating a phosphor particle layer 17a which is made of phosphor particles and a secondary electron emitting layer 18 which is made of a secondary electron emitting material. Here, the secondary electron emitting layer 18 may be formed by spreading crystals of secondary electron emitting material (for example, MgO crystals that contain CL emission MgO crystals) or by depositing a thin film of secondary electron emitting material over the surface of the phosphor particle layer 17a.

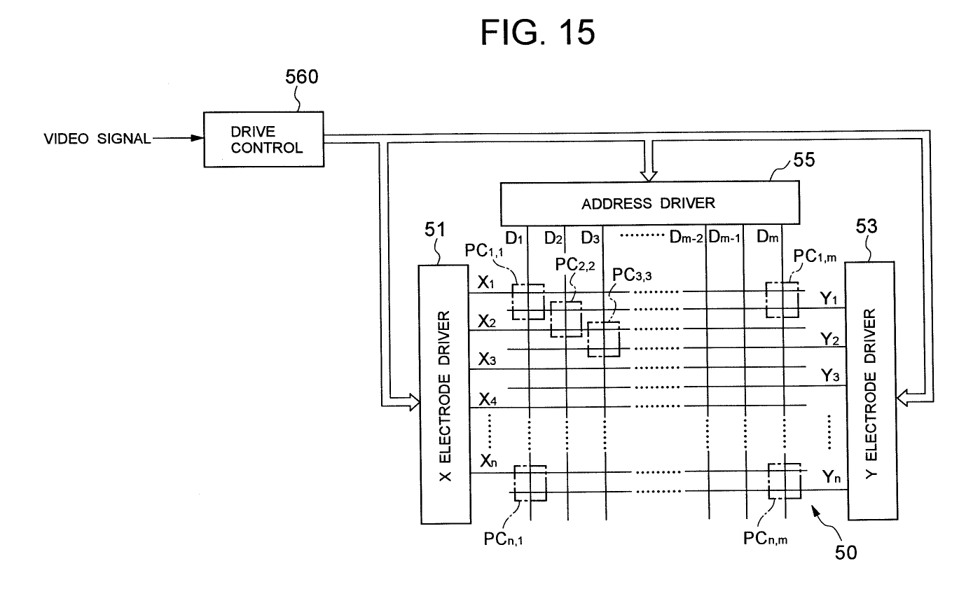

FIG. 15 is a diagram showing another configuration of the plasma display apparatus which drives its plasma display panel according to a driving method of the present invention.

It should be appreciated that the PDP 50 of the plasma display apparatus shown in FIG. 15 is the same as the PDP 50 of the plasma display apparatus shown in FIG. 1, having such a structure as shown in FIGS. 2 to 5 and 14. Nevertheless, the method for driving the PDP 50 to be performed by a drive control circuit 560, the X electrode driver 51, the Y electrode driver 53, and the address driver 55 is different from that of the plasma display apparatus shown in FIG. 1.

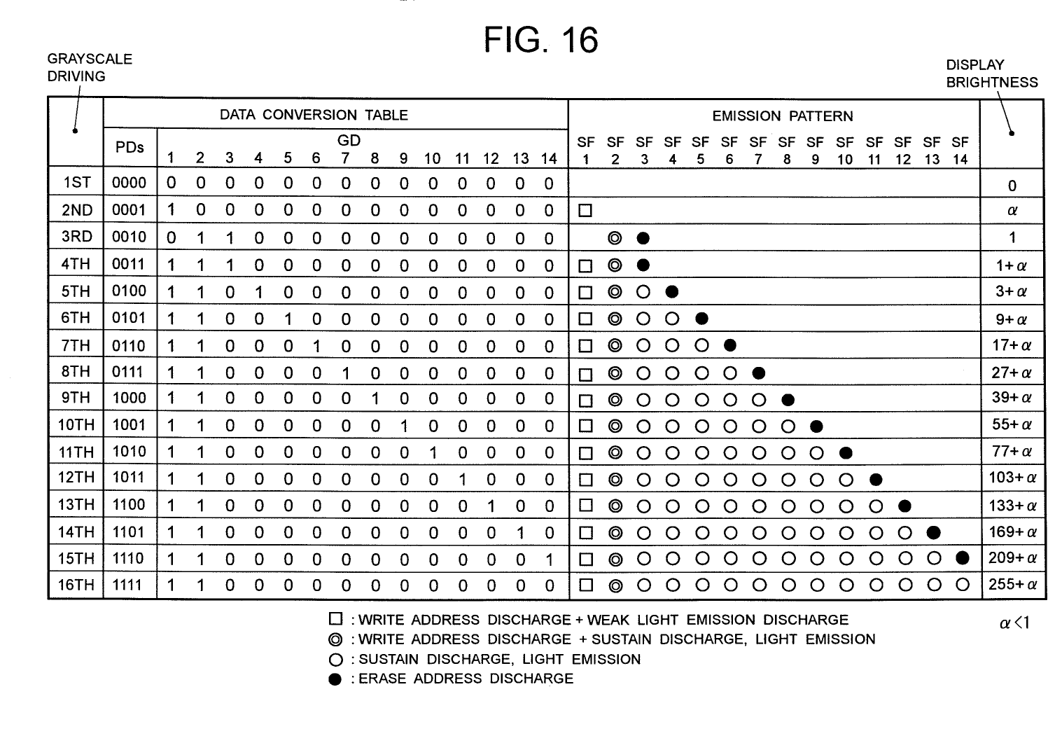

The drive control circuit 560 shown in FIG. 15 initially converts the input video signal into eight bits of pixel data for expressing all possible brightness levels in 256 grayscale levels pixel by pixel, and applies multi-grayscale processing consisting of error diffusion processing and dithering to this pixel data. It should be noted that this multi-grayscale processing is the same as that performed by such a drive control circuit 56 as described above. In other words, the drive control circuit 560 obtains, through this multi-grayscale processing, 4-bit multi-grayscale pixel data PDs which expresses the entire brightness range in 15 levels of sections. Then, the drive control circuit 560 converts this multi-grayscale pixel data PDs into 14 bits of pixel drive data GD according to a data conversion table such as shown in FIG. 16.

The drive control circuit 560 associates the first to fourteenth bits of this pixel drive data GD with subfields SF1 to SF14, respectively, and supplies bit digits corresponding to the subfields SF to the address driver 55 as pixel drive data bits in units of a single display line (m pieces).

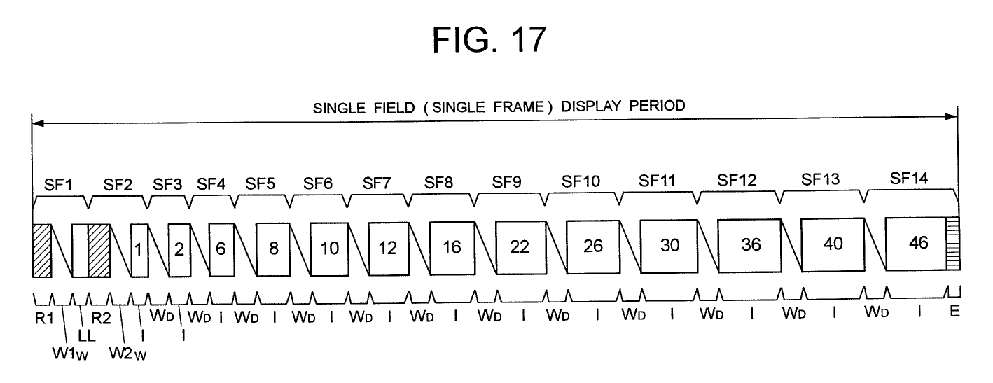

The drive control circuit 560 also supplies various types of control signals for driving the PDP 50 of the foregoing structure in accordance with an emission drive sequence such as shown in FIG. 17, to each of the X electrode driver 51, the Y electrode driver 53, and the address driver 55. More specifically, in the first subfield SF1 within a single field (single frame) display period, the drive control circuit 560 supplies the panel driver with various types of control signals for performing driving in accordance with a first reset stage R1, a first selective write address stage W1_{W}, and a weak light emission stage LL in succession. In the subfield SF2 subsequent to this SF1, it supplies the panel driver with various types of control signals for performing driving in accordance with a second reset stage R2, a second selective write address stage W2_{W}, and a sustain stage I in succession. Moreover, in each of the subfields SF3 to SF14, it supplies the panel driver with various types of control signals for performing driving in accordance with a selective erase address stage W_{D} and a sustain stage I in succession. It should be appreciated that the drive control circuit 560 supplies the panel driver with various types of control signals for performing driving in accordance with an erase stage E after the execution of the sustain stage I in succession, only in the last subfield SF14 in the single field display period.

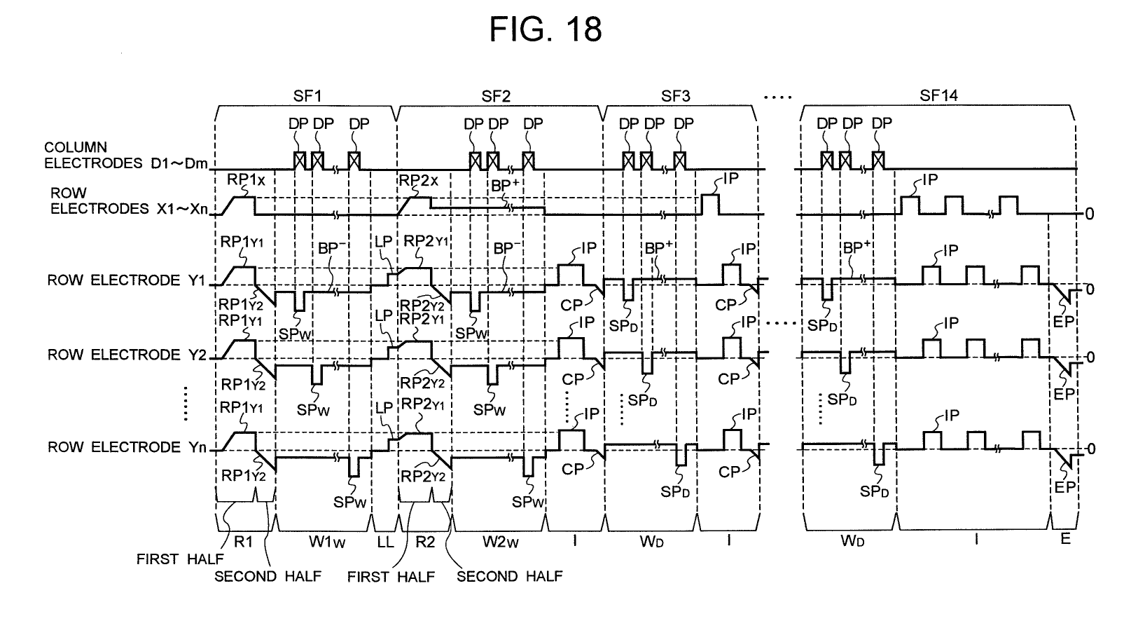

The panel driver, i.e., the X electrode driver 51, the Y electrode driver 53, and the address driver 55 generate various types of drive pulses such as shown in FIG. 18, and supply the same to the column electrodes D and the row electrodes X and Y of the PDP 50 in accordance with the various types of control signals supplied from the drive control circuit 560.

FIG. 18 selectively shows the operations only in the subfields SF1 to SF3 and the last subfield SF14 out of SF1 to SF14 shown in FIG. 17.

In the first half of the first reset stage R1 in the subfield SF1, the Y electrode driver 53 initially applies to all the row electrodes Y₁ to Yₙ a positive reset pulse RP1_{Y1} which has such a waveform that its front edge makes a gradual potential transition with a lapse of time as compared to sustain pulses. As shown in FIG. 18, the reset pulse RP1_{Y1} has a positive peak potential lower than or equal to the positive peak potential of the sustain pulse IP to be described later. In the meantime, the address driver 55 sets the column electrodes D₁ to Dₘ to the state of the ground potential (0 volt). The application of the foregoing reset pulse RP1_{Y1} creates a first reset discharge between the row electrodes Y and the column electrodes D in all the discharge cells PC individually. That is, in the first half of the first reset stage R1, voltages are applied to between the electrodes with the row electrodes Y as anodes and the column electrodes D as cathodes, so that a column side cathode discharge of passing a current from the row electrodes Y to the column electrodes D occurs as the first reset discharge. In response to this first reset discharge, negative wall charges are formed near the row electrodes Y and positive wall charges are formed near the column electrodes D in all the discharge cells PC.

Next, in the first half of the first reset stage R1, the X electrode driver 51 applies a reset pulse RP_{X}, which has the same polarity as that of the reset pulse RP1_{Y1} and has a peak potential capable of avoiding a surface discharge between the row electrodes X and Y due to the application of the reset pulse RP1_{Y1}, to all the row electrodes X₁ to Xₙ individually.

Then, in the second half of the first reset stage R1, the Y electrode driver 53 generates a reset pulse RP1_{Y2} which has such a pulse waveform that its potential gradually decreases with a lapse of time until it reaches a negative peak potential as shown in FIG. 18, and applies this to all the row electrodes Y₁ to Yₙ. Here, the application of this reset pulse RP1_{Y2} creates a second reset discharge between the row electrodes X and Y in all the discharge cells PC. Note that the peak potential of the reset pulse RP1_{Y2} is a minimum potential capable of producing the foregoing second reset discharge between the row electrodes X and Y with reliability, in consideration of the wall charges that are formed near the respective row electrodes X and Y in response to the foregoing first reset discharge. The peak potential of the reset pulse RP1_{Y2} is also set to a potential higher than the peak potential of a negative write scan pulse SP_{W} to be described later, or equivalently, a potential closer to zero volts. The reason is that if the negative peak potential of the reset pulse RP1_{Y2} is set to be lower than the negative peak potential of the write scan pulse SP_{W}, a strong discharge can occur between the row electrodes Y and the column electrodes D. This might erase much of the wall charges formed near the column electrodes D, making an address discharge at the first selective write address stage W1_{W} to be described later unstable. The second reset discharge created in the second half of the first reset stage R1 erases the wall charges formed near the row electrodes X and Y in each discharge cell PC, whereby all the discharge cells PC are initialized into extinction mode. In addition, the application of the foregoing reset pulse RP1_{Y2} also creates a weak discharge between the row electrodes Y and the column electrodes D in all the discharge cells PC. This discharge erases part of the positive wall charges formed near the column electrodes D, thereby adjusting them to an amount capable of properly producing a selective write address discharge at the first selective write address stage W1_{W}.

Next, at the first selective write address stage W1_{W} in the subfield SF1, the Y electrode driver 53 applies a base pulse BP⁻ having a predetermined negative potential such as shown in FIG. 18 to the row electrodes Y₁ to Yₙ at the same time while selectively applying a write scan pulse SP_{W} having a negative peak potential to each of the row electrodes Y₁ to Yₙ in succession. In the meantime, the X electrode driver 51 applies a voltage of 0 volts to each of the row electrodes X₁ to Xₙ. Moreover, at the first selective write address stage W1_{W}, the address driver 55 generates pixel data pulses DP according to the logic levels of the pixel drive data bits corresponding to the subfield SF1. For example, if a pixel drive data bit of logic level 1 for setting a discharge cell PC to lighting mode is supplied, the address driver 55 generates a pixel data pulse DP having a positive peak potential. For a pixel drive data bit of logic level 0 for setting a discharge cell PC to the extinction mode, on the other hand, it generates a pixel data pulse DP of low voltage (0 volts). The address driver 55 then applies these pixel data pulses DP to the column electrodes D₁ to Dₘ in units of a single display line (m pulses) in synchronization with the timing of application of each write scan pulse SP_{W}. Here, simultaneously with the write scan pulse SP_{W}, a selective write address discharge occurs between the column electrodes D and the row electrodes Y in discharge cells PC to which pixel data pulses DP of high voltage for setting to the lighting mode are applied. By this selective write address discharge, these discharge cells PC are set into the state where positive wall charges are formed near the row electrodes Y and negative wall charges are formed near the column electrodes D, i.e., into the lighting mode. In discharge cells PC to which pixel data pulses DP of low voltage (0 volts) for setting to the extinction mode are applied, on the other hand, the foregoing selective write address discharge will not occur between the column electrodes D and the row electrodes Y simultaneously with the foregoing write scan pulse SP_{W}. Consequently, these discharge cells PC maintain their immediately preceding state, i.e., the extinction mode into which they are initialized at the first reset stage R1.

Next, at the weak light emission stage LL in the subfield SF1, the Y electrode driver 53 applies a weak light emission pulse LP, which has a predetermined positive peak potential such as shown in FIG. 18, to the row electrodes Y₁ to Yₙ simultaneously. With the application of this weak light emission pulse LP, a discharge (hereinafter, referred to as weak light emission discharge) occurs between the column electrodes D and the row electrodes Y in the discharge cells PC that are set to the lighting mode. That is, at the weak light emission stage LL, the row electrodes Y are subjected to a potential that can create a discharge between the row electrodes Y and the column electrodes D but not between the row electrodes X and Y in the discharge cells PC, so that a weak light emission discharge occurs only between the column electrodes D and the row electrodes Y in the discharge cells PC that are set to the lighting mode. Here, the positive peak potential of the weak light emission pulse LP is lower than the peak potential of the sustain pulse IP which is applied at the sustain stages I of the subfields SF2 and later to be described below. For example, it is the same as the base potential to be applied to the row electrodes Y at the selective erase address stage W_{D} to be described later. As shown in FIG. 18, the rate of change of potential of the weak light emission pulse LP with a lapse of time in its rising interval is higher than those of the reset pulses (RP1_{Y1}, RP2_{Y1}) in their rising intervals. In other words, the potential transition at the front edge of the weak light emission pulse LP is made steeper than the potential transitions at the front edges of the reset pulses, thereby creating a discharge stronger than the first reset discharge which occurs at the first reset stages R1. This discharge is a column side cathode discharge such as described previously, and is created by the weak light emission pulse LP which has a peak potential lower than that of the sustain pulse IP. The emission brightness resulting from the discharge is thus lower than that of the sustain discharge occurring between the row electrodes X and Y. That is, at the weak light emission stage LL, a discharge that is accompanied with light emission of higher brightness level than that of the first reset discharge and lower than that of the sustain discharge, i.e., a discharge that is accompanied with as weak light emission as is available for display purposes is created as the weak light emission discharge. At the first selective write address stage W1_{W} which is performed immediately before the weak light emission stage LL, a selective write address discharge is created between the column electrodes D and the row electrodes Y in the discharge cells PC. Consequently, in the subfield SF1, brightness corresponding to a tone level one higher than the brightness level 0 is expressed by the light emission resulting from this selective write address discharge and the light emission resulting from the weak light emission discharge.

After the foregoing weak light emission discharge, negative wall charges are formed near the row electrodes Y and positive wall charges are formed near the column electrodes D.

Next, in the first half of the second reset stage R2 in the subfield SF2, the Y electrode driver 53 applies to all the row electrodes Y₁ to Yₙ a positive reset pulse RP2_{Y1} which has such a waveform that its front edge makes a gradual potential transition with a lapse of time as compared to the sustain pulse IP to be described later. As shown in FIG. 18, the reset pulse RP2_{Y1} has a positive peak potential lower than or equal to the positive peak potential of the sustain pulse IP. In the meantime, the address driver 55 sets the column electrodes D₁ to Dₘ into the state of the ground potential (0 volts). The X electrode driver 51 applies to each of all the row electrodes X₁ to Xₙ a positive reset pulse RP2_{X} which has a peak potential capable of avoiding a surface discharge between the row electrodes X and Y due to the application of the foregoing reset pulse RP2_{Y1}. The reset pulse RP2_{X} has a positive peak potential lower than or equal to the positive peak potential of the sustain pulse IP. Here, instead of applying the foregoing reset pulse RP2_{X}, the X electrode driver 51 may set all the row electrodes X₁ to Xₙ to the ground potential (0 volts) unless the row electrodes X and Y create a surface discharge therebetween. In response to the application of the foregoing reset pulse RP2_{Y1}, a first reset discharge weaker than the column side cathode discharge at the foregoing weak light emission stage LL occurs between the row electrodes Y and the column electrodes D in discharge cells PC that have not undergone the column side cathode discharge at the weak light emission stage LL. That is, in the first half of the second reset stage R2, voltages are applied to between the electrodes with the row electrodes Y as anodes and the column electrodes D as cathodes, so that a column side cathode discharge of passing a current from the row electrodes Y to the column electrodes D occurs as the first reset discharge. In discharge cells PC that have already undergone the weak light emission discharge at the foregoing weak light emission stage LL, on the other hand, no discharge occurs even when the reset pulse RP2_{Y1} is applied. As a result, immediately after the completion of the first half of the second reset stage R2, negative wall charges are formed near the row electrodes Y and positive wall charges are formed near the column electrodes D in all the discharge cells PC. Then, in the second half of the second reset stage R2 in the subfield SF2, the Y electrode driver 53 applies to the row electrodes Y₁ to Yₙ a reset pulse RP2_{Y2} which has such a pulse waveform that its potential gradually decreases with a lapse of time until it reaches a negative peak potential Vᵣ₂ as shown in FIG. 18. In the second half of the second reset stage R2, the X electrode driver 51 also applies a base pulse BP⁺ having a predetermined positive potential to each of the row electrodes X₁ to Xₙ. Here, the application of these negative reset pulse RP2_{Y2} and positive base pulse BP⁺ creates a second reset discharge between the row electrodes X and Y in all the discharge cells PC. Note that the peak potentials of the reset pulse RP2_{Y2} and the base pulse BP⁺ both are minimum voltages that can produce the second reset discharge between the row electrodes X and Y with reliability, in consideration of the wall charges that are formed near the respective row electrodes X and Y by the foregoing first reset discharge. Moreover, the negative peak potential Vᵣ₂ of the reset pulse RP2_{Y2} is set to a potential higher than the peak potential of the negative write scan pulse SP_{W}, or equivalently, a potential closer to zero volts. The reason is that if the peak potential Vᵣ₂ of the reset pulse RP2_{Y2} is set to be lower than the peak potential of the write scan pulse SP_{W}, a strong discharge can occur between the row electrodes Y and the column electrodes D. This might erase much of the wall charges formed near the column electrodes D, making an address discharge at the second selective write address stage W2_{W} unstable. Here, the second reset discharge created in the second half of the second reset stage R2 erases the wall charges formed near the respective row electrodes X and Y in each discharge cell PC, whereby all the discharge cells PC are initialized into the extinction mode. In addition, the application of the foregoing reset pulse RP2_{Y2} also creates a weak discharge between the row electrodes Y and the column electrodes D in all the discharge cells PC. This discharge erases part of the positive wall charges formed near the column electrodes D, thereby adjusting them to an amount capable of properly producing a selective write address discharge at the second selective write address stage W2_{W}.

Next, at the second selective write address stage W2_{W} of the subfield SF2, the Y electrode driver 53 applies the base pulse BP⁻ having a predetermined negative potential such as shown in FIG. 18 to the row electrodes Y₁ to Yₙ at the same time while selectively applying the write scan pulse SP_{W} having a negative peak potential to each of the row electrodes Y₁ to Yₙ in succession. In the meantime, the X electrode driver 51 applies the base pulse BP⁺ having a predetermined positive potential to each of the row electrodes X₁ to Xₙ. Moreover, at the second selective write address stage W2_{W}, the address driver 55 initially generates pixel data pulses DP having peak potentials according to the logic levels of the pixel drive data bits corresponding to the subfield SF2. For example, if a pixel drive data bit of logic level 1 for setting a discharge cell PC to the lighting mode is supplied, the address driver 55 generates a pixel data pulse DP having a positive peak potential. For a pixel drive data bit of logic level 0 for setting a discharge cell PC to the extinction mode, on the other hand, it generates a pixel data pulse DP of low voltage (0 volts). The address driver 55 then applies these pixel data pulses DP to the column electrodes D₁ to Dₘ in units of a single display line (m pulses) in synchronization with the timing of application of each write scan pulse SP_{W}. Here, simultaneously with the write scan pulse SP_{W}, a selective write address discharge occurs between the column electrodes D and the row electrodes Y in discharge cells PC to which pixel data pulses DP of high voltage for setting to the lighting mode are applied. Furthermore, immediately after the selective write address discharge, a weak discharge also occurs between the row electrodes X and Y in these-discharge cells PC. More specifically, after the application of the write scan pulse SP_{W}, a voltage corresponding to the base pulses BP⁻ and BP⁺ is applied to between the row electrodes X and Y. Since this voltage is set to be lower than the discharge start voltage of the discharge cells PC, no discharge will be created inside the discharge cells PC by the application of this voltage alone. If the selective write address discharge is created, however, a discharge occurs between the row electrodes X and Y even by means of the voltage application with the base pulses BP⁻ and BP⁺ alone, being induced by this selective write address discharge. By this discharge and the foregoing selective write address discharge, these discharge cells PC are set into a state where positive wall charges are formed near the row electrodes Y, negative wall charges are formed near the row electrodes X, and negative wall charges are formed near the column electrodes D, i.e., into the lighting mode. In discharge cells PC to which pixel data pulses DP of low voltage (0 volts) for setting to the extinction mode are applied, on the other hand, such a selective write address discharge as described above will not occur between the column electrodes D and the row electrodes Y simultaneously with the foregoing write scan pulse SP_{W}. Thus, the row electrodes X and Y will not create any discharge, either. Consequently, these discharge cells PC maintain their immediately preceding state, i.e., the extinction mode into which they are initialized at the second reset stage R2.

Next, at the sustain stage I of the subfield SF2, the Y electrode driver 53 generates a single sustain pulse IP having a positive peak potential, and applies it to each of the row electrodes Y₁ to Yₙ simultaneously. In the meantime, the X electrode driver 51 sets the row electrodes X₁ to Xₙ into the state of the ground potential (0 volts). The address driver 55 sets the column electrodes D₁ to Dₘ into the state of the ground potential (0 volts). The application of the sustain pulse IP creates a sustain discharge between the row electrodes X and Y in the discharge cells PC that are set to the lighting mode. The light emitted from the phosphor layer 17 in response to this sustain discharge is emitted outside through the front transparent substrate 10, thereby performing a single round of display emission corresponding to the brightness weight of this subfield SF2. With the application of this sustain pulse IP, a discharge also occurs between the row electrodes Y and the column electrodes D in the discharge cells PC that are set to the lighting mode. This discharge and the foregoing sustain discharge produce negative wall charges near the row electrodes Y and positive wall charges near the row electrodes X and the column electrodes D in the discharge cells PC.

Next, at the selective erase address stage W_{D} in each of the subfields SF3 to SF14, the Y electrode driver 53 applies the base pulse BP⁺ having a predetermined positive potential to each of the row electrodes Y₁ to Yₙ while selectively applying an erase scan pulse SP_{D} having a negative peak potential such as shown in FIG. 18 to each of the row electrodes Y₁ to Yₙ in succession. It should be appreciated that the peak potential of the base pulse BP⁺ is set at a potential capable of avoiding any accidental discharge between the row electrodes X and Y over the period of execution of this selective erase address stage W_{D}. The X electrode driver 51 also sets each of the row electrodes X₁ to Xₙ to the ground potential (0 volts) over the period of execution of the selective erase address stage W_{D}. At this selective erase address stage W_{D}, the address driver 55 initially converts pixel drive data bits corresponding to that subfield SF into pixel data pulses DP having peak potentials according to their logic levels. For example, if a pixel drive data bit of logic level 1 for shifting a discharge cell PC from the lighting mode to the extinction mode is supplied, the address driver 55 converts this into a pixel data pulse DP having a positive peak potential. If a pixel drive data bit of logic level 0 for maintaining a discharge cell PC in its present state is supplied, on the other hand, it converts this into a pixel data pulse DP of low voltage (0 volts). The address driver 55 then applies these pixel data pulses DP to the column electrodes D₁ to Dₘ in units of a single display line (m pulses) in synchronization with the timing of application of each erase scan pulse SP_{D}. Here, simultaneously with the erase scan pulse SP_{D}, a selective erase address discharge occurs between the column electrodes D and the row electrodes Y in discharge cells PC to which the pixel data pulses DP of high voltage are applied. By this selective erase address discharge, these discharge cells PC are set into the state where positive wall charges are formed near the row electrodes Y and X, and negative wall charges are formed near the column electrodes D, i.e., into the extinction mode. In discharge cells PC to which pixel data pulses DP of low voltage (0 volts) are applied, on the other hand, the foregoing selective erase address discharge will not occur between the column electrodes D and the row electrodes Y simultaneously with the foregoing erase scan pulse SP_{D}. These discharge cells PC therefore maintain their immediately preceding states (lighting mode or extinction mode).

Next, at the sustain stage I in each of the subfields SF3 to SF14, the X electrode driver 51 and the Y electrode driver 53 apply the sustain pulse IP having a positive peak to the row electrodes Y₁ to Yₙ and X₁ to Xₙ repeatedly as many times as corresponding to the brightness weight of that subfield, taking turns to the row electrodes Y and X alternately as shown in FIG. 18. Each time this sustain pulse IP is applied, a sustain discharge occurs between the row electrodes X and Y in the discharge cells PC that are set to the lighting mode. The light emitted from the phosphor layer 17 in response to this sustain discharge is emitted outside through the front transparent substrate 10, thereby performing as many times of display light emission as corresponding to the brightness weight of that subfield SF. It should be noted that the total number of sustain pulses IP to be applied within each sustain stage I is an even number. That is, in each sustain stage I, the first sustain pulse IP is applied to the row electrodes X and the last sustain pulse IP is applied to the row electrodes Y. As a result, immediately after the completion of each sustain stage I, negative wall charges are formed near the row electrodes Y and positive wall charges are formed near the row electrodes X and the column electrodes D in the discharge cells PC that have undergone the sustain discharges. This brings the wall charges formed in each discharge cell PC into the same condition as immediately after the completion of the first reset discharge.

Then, after the completion of the sustain stage I in the last subfield SF14, the Y electrode driver 53 applies an erase pulse EP having a negative peak potential to all the row electrodes Y₁ to Yₙ. With the application of this erase pulse EP, an erase discharge occurs only in the discharge cells PC that are in the lighting mode. By this erase discharge, the discharge cells PC in the lighting mode are brought into the extinction mode.

The foregoing driving is performed based on 16 possible values of pixel drive data GD such as shown in FIG. 16.

Initially, at the second tone level which expresses brightness one level higher than the first tone level for expressing black display (brightness level 0), a selective write address discharge for setting discharge cells PC into the lighting mode is created only in the subfield SF1 out of SF1 to SF14 as shown in FIG. 16, so that the discharge cells PC that are set to this lighting mode create a weak light emission discharge (indicated with □). Here, the brightness level of the light emission resulting from these selective write address discharge and weak light emission discharge is lower than the brightness level of the light emission resulting from a single sustain discharge. Assuming that the visible brightness level of a sustain discharge is “1,” the second tone level therefore expresses brightness level “α” which is lower than brightness level “1.”

Next, at the third tone level which expresses brightness one level higher than this second tone level, a selective write address discharge for setting discharge cells PC into the lighting mode is created only in the subfield SF2 out of SF1 to SF14 (indicated with a double circle). A selective erase address discharge for shifting the discharge cells PC into the extinction mode is created in the next subfield SF3 (indicated with a black circle). Consequently, at the third tone level, one sustain discharge occurs only at the sustain stage I of the subfield SF2 out of SF1 to SF14, thereby expressing brightness corresponding to brightness level “1.”

Next, at the fourth tone level which expresses brightness one level higher than this third tone level, a selective write address discharge for setting discharge cells PC into the lighting mode is initially created in the subfield SF1, so that the discharge cells PC that are set to this lighting mode create a weak light emission discharge (indicated with □). At this fourth tone level, a selective write address discharge for setting the discharge cells PC into the lighting mode is also created in the subfield SF2 alone out of SF1 to SF14 (indicated with a double circle). A selective erase address discharge for shifting the discharge cells PC into the extinction mode is created in the next subfield SF3 (indicated with a black circle). At the fourth tone level, light of brightness level “α” is thus emitted in the subfield SF1, and a single sustain discharge accompanied with light emission of brightness level “1” is performed in SF2. This consequently expresses brightness corresponding to a brightness level of “α”+“1.”

Moreover, at each of the fifth to sixteenth grayscale levels, a selective write address discharge for setting discharge cells PC into the lighting mode is created in the subfield SF1, so that the discharge cells PC set to this lighting mode create a weak light emission discharge (indicated with □). Then, a selective erase address discharge for shifting the discharge cells PC into the extinction mode is created only in one of the subfields corresponding to that tone level (indicated with a black circle). At each of the fifth to sixteenth grayscale levels, the foregoing weak light emission discharge is thus created in the subfield SF1, and a single sustain discharge is created in SF2. Then, in each of as many consecutive subfields (indicated with white circles) as corresponding to that tone level, a sustain discharge is created as many times as assigned to that subfield. As a result, each of the fifth to sixteenth grayscale levels visualizes the brightness corresponding to a brightness level of “α” +“the total number of sustain discharges created within the single field (or single frame) display period.” According to the driving shown in FIGS. 16 to 18, it is therefore possible to express the brightness range of brightness levels “0” to “255+α” in 16 levels such as shown in FIG. 16.

According to this driving shown in FIGS. 16 to 18, not a sustain discharge but a weak light emission discharge is created as the discharge that contributes to the display image in the subfield SF1 of the lowest brightness weight. Since this weak light emission discharge occurs between the column electrodes D and the row electrodes Y, the brightness level of the light emitted by the discharge is lower than that of a sustain discharge which occurs between the row electrodes X and Y. Consequently, when expressing brightness one level higher than black display (brightness level 0) by using this weak light emission discharge (second tone level), the brightness difference from brightness level 0 becomes smaller than when expressing it by using a sustain discharge. This enhances the power of gradational expression when expressing images of lower brightness. At the second tone level, the second reset stage R2 of the subfield SF2 subsequent to SF1 includes no reset discharge, and thus suppresses a drop in the dark contrast ascribable to this reset discharge. According to the driving shown in FIG. 16, the weak light emission discharge in the subfield SF1, accompanied with light emission of brightness level α, is created even at each of the fourth and subsequent grayscale levels. Nevertheless, this weak light emission discharge may be omitted at the third and higher grayscale levels. The reason, in essence, is that since the light emission that accompanies the weak light emission discharge is extremely low in brightness (brightness level α), the brightness increase due to the brightness level α might not be visible at the fourth and subsequent grayscale levels where sustain discharges accompanied with light emission of higher brightness are also included. In such cases, there is no use creating the weak light emission discharge.

Here, the display panel or PDP 50 is configured so that CL emission MgO crystals, or secondary electron emitting material, are contained not only in the magnesium oxide layer 13 which is formed on the front transparent substrate 10 in each discharge cell PC, but also in the phosphor layer 17 which is formed on the rear substrate 14.

According to this structure, it becomes possible to reduce the discharge delay time of the column side cathode discharge significantly as compared to conventional PDPs. As a result, even if the reset pulses RP1_{Y1} and RP2_{Y1} have a positive peak potential lower than or equal to the positive peak potential of the sustain pulse IP as shown in FIG. 18, it is possible to create the first reset discharge, a column side cathode discharge, with reliability. Since the positive peak potentials of the reset pulses RP1_{Y1} and RP2_{Y1} are relatively low, the resulting column side cathode discharges also become weaker.

Consequently, according to the present invention, a column side cathode discharge of extremely low discharge intensity can be created as the reset discharge. This allows an improvement to the image contrast, or the dark contrast when displaying dark images in particular.

According to the embodiment shown in FIG. 18, the positive peak potential of the reset pulse RP1_{X} (RP2_{X}) to be applied simultaneously with the reset pulse RP1_{Y1} (RP2_{Y1}) is set to be lower than or equal to the positive peak potential of the sustain pulse IP. The positive peak potential of the reset pulse RP1_{X} (RP2_{X}) may be set to be higher, however, if the column electrodes D have such a configuration as shown in FIG. 2 each. More specifically, when the wide portions WP having an increased electrode width along the direction of the display lines are formed on the respective column electrodes D at areas where opposed to the transparent electrodes Ya as shown in FIG. 2, discharges are more difficult to occur between the column electrodes D and the row electrodes X than between the column electrodes D and the row electrodes Y. Thus, the positive peak potential of the reset pulse RP1_{X} (RP2_{X}) may be made higher than the positive peak potential of the sustain pulse IP if no discharge occurs between the column electrodes D and the row electrodes X in the first half of the reset stage R. It should be appreciated that the positive peak potential of either one of the reset pulses RP1_{X} and RP2_{X} may be made higher than the positive peak potential of the sustain pulse IP.

According to the embodiment shown in FIG. 18, the reset pulse RP1_{Y1} at the first reset stage R1 and the reset pulse RP2_{Y1} at the second reset stage R2 both have a potential lower than or equal to the positive peak potential of the sustain pulse IP. Nevertheless, at least either one of these may be set to be higher than the positive peak potential of the sustain pulse IP. In this case, however, the charged particles produced by the first reset discharge at the second reset stage R2 have an impact on the selective erase address stage W_{D} in each of all the subfields SF2 and later. Then, if the selective erase address discharges in the subfields SF2 and later require further stabilization, the positive peak potential of the reset pulse RP2_{Y1} alone is preferably made higher than that of the sustain pulse IP.

At the reset stages (R1, R2) shown in FIG. 18, the first reset discharge, a column side cathode discharge, is created by applying the reset pulses (RP1_{Y1}, RP2_{Y1}) to the row electrodes Y₁ to Yₙ in the respective first halves. The application of either one or both of these reset pulses RP1_{Y1} and RP2_{Y1} may be omitted, however.

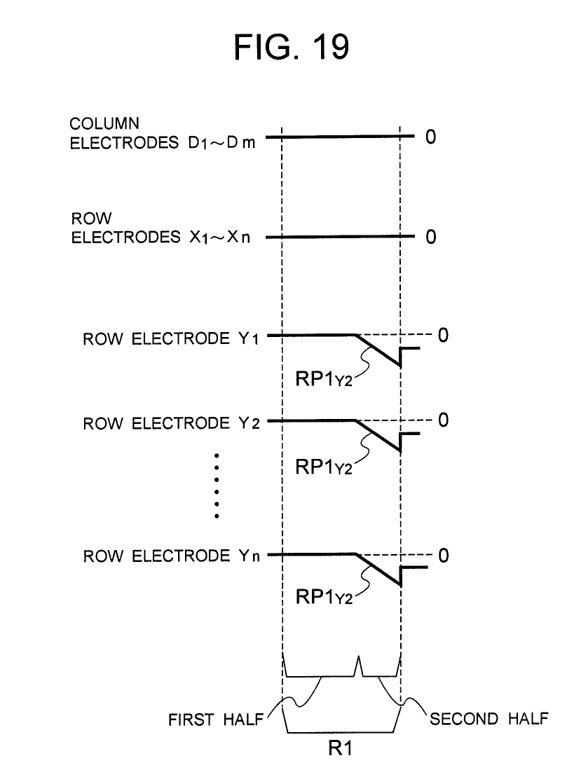

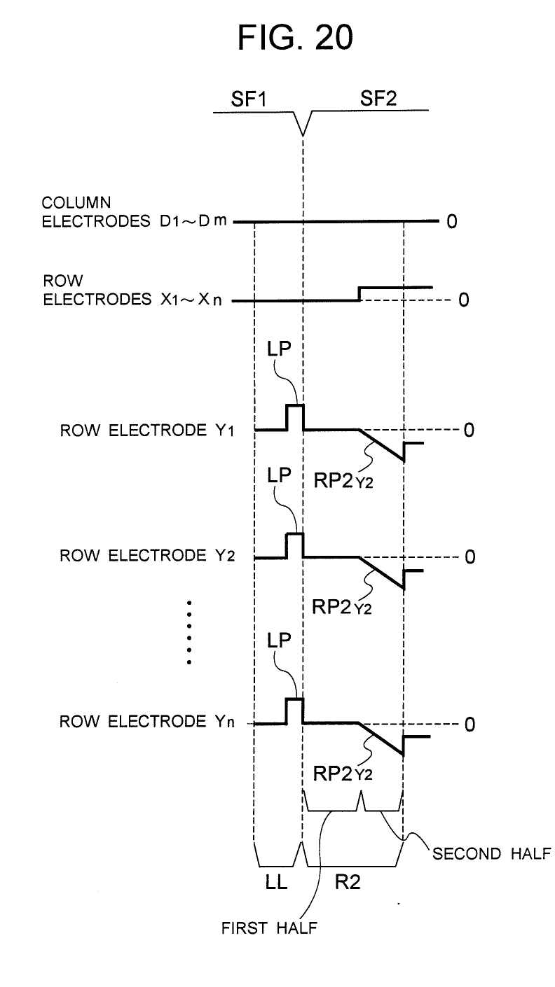

For example, such a first reset stage R1 as shown in FIG. 19 is employed instead of the first reset stage R1 shown in FIG. 18. As shown in FIG. 19, the row electrodes Y₁ to Yₙ are fixed to the ground potential in the first half of the first reset stage R1. In addition, such a second reset stage R2 as shown in FIG. 20 is employed instead of the second reset stage R2 shown in FIG. 18. As shown in FIG. 20, the row electrodes Y₁ to Yₙ are fixed to the ground potential in the first half of the second reset stage R2. In conjunction with this, the application of either one or both of the reset pulses RP1_{X} and RP2_{X}, which are supposed to be applied to all the row electrodes X at the same timing as that of the reset pulses (RP1_{Y1}, RP2_{Y2}), may be omitted. That is, in the first halves of the respective reset stages R1 and R2, all the row electrodes X are subjected to the ground potential instead of the reset pulses (RP1_{X}, RP2_{X}) while all the row electrodes Y are set to the ground potential as shown in FIGS. 19 and 20.

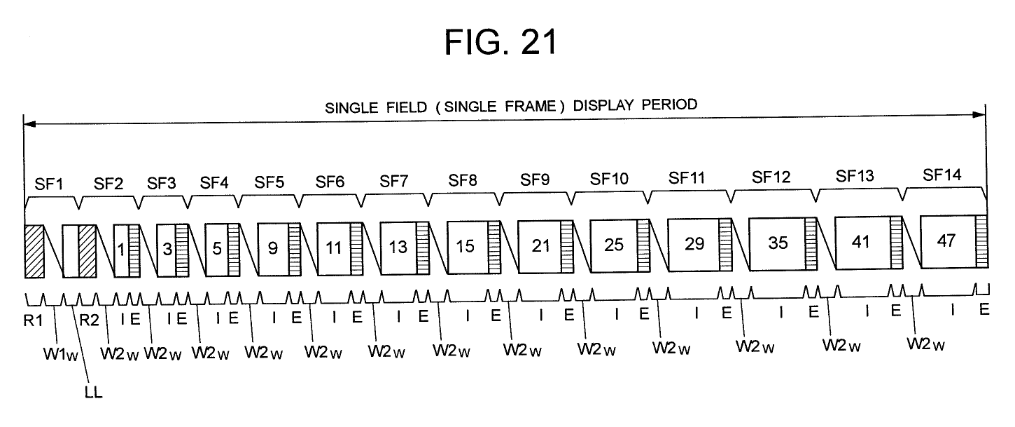

The PDP 50 may also be driven by employing an emission drive sequence based on such a selective write address method as shown in FIG. 21, instead of the selective erase address method such as shown in FIG. 17.

Here, in the first subfield SF1 of a single field (frame) display period such as shown in FIG. 21, the drive control circuit 560 supplies the panel driver with various types of control signals for performing driving in accordance with a first reset stage R1, a first selective write address stage W1_{W}, and a weak light emission stage LL in succession. Moreover, in each of the subfields SF2 to SF14, the drive control circuit 560 supplies the panel driver with various types of control signals for performing driving in accordance with a second write address stage W2_{W}, a sustain stage I, and an erase stage E in succession. In the subfield SF2, the drive control circuit 560 also supplies the panel driver with various types of control signals for performing driving in accordance with a second reset stage R2 prior to the second write address stage W2_{W}.

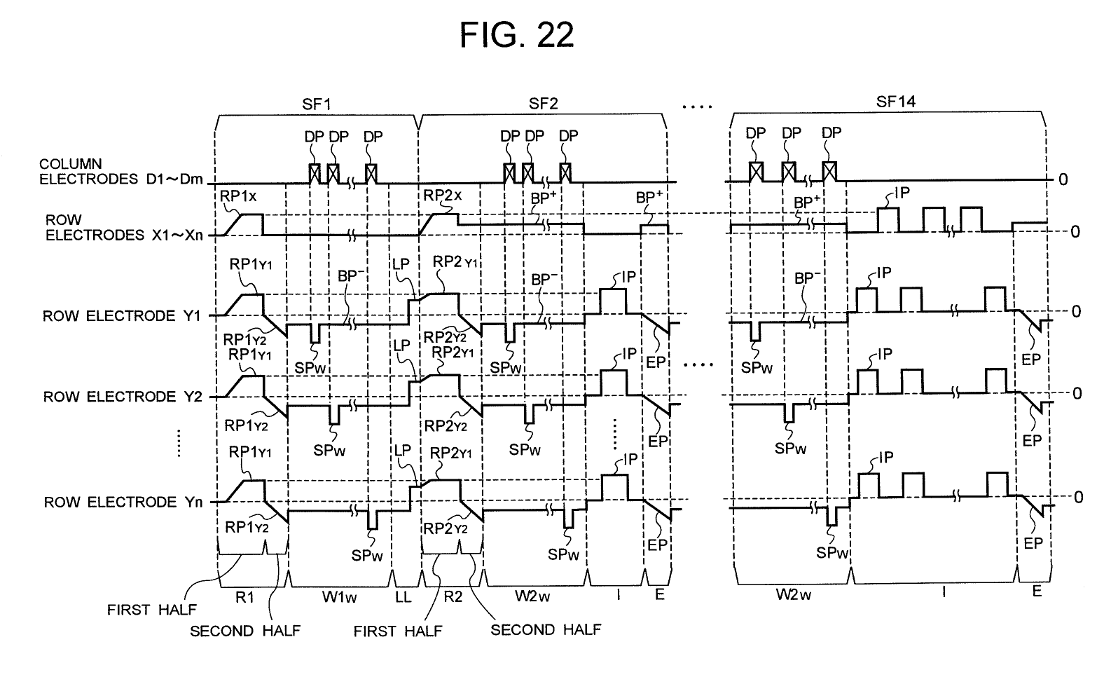

The panel driver, i.e., the X electrode driver 51, the Y electrode driver 53, and the address driver 55 generate various types of drive pulses such as shown in FIG. 22, and supply the same to the column electrodes D and the row electrodes X and Y of the PDP 50 in accordance with the various types of control signals supplied from the drive control circuit 560.

FIG. 22 selectively shows the operations only in the first subfield SF1, the next subfield SF2, and the last subfield SF14 out of the subfields SF1 to SF14 shown in FIG. 21. In FIG. 22, the operations at the first reset stage R1, the first selective write address stage W1_{W}, and the weak light emission stage LL of the subfield SF1, and the operations at the second reset stage R2, the second write address stage W2_{W}, and the sustain stage I of SF2 are the same as those shown in FIG. 18.

In the first half of the first reset stage R1 in the subfield SF1, the Y electrode driver 53 initially applies to all the row electrodes Y₁ to Y, a positive reset pulse RP1_{Y1} which has such a waveform that its front edge makes a gradual potential transition with a lapse of time as compared to sustain pulses. As shown in FIG. 22, the reset pulse RP1_{Y1} has a positive peak potential lower than or equal to the positive peak potential of the sustain pulse IP to be described later. In the meantime, the address driver 55 sets the column electrodes D₁ to Dₘ into the state of the ground potential (0 volt). The application of the foregoing reset pulse RP1_{Y1} creates a first reset discharge between the row electrodes Y and the column electrodes D in all the discharge cells PC individually. That is, in the first half of the first reset stage R1, voltages are applied to between the electrodes with the row electrodes Y as anodes and the column electrodes D as cathodes, so that a column side cathode discharge of passing a current from the row electrodes Y to the column electrodes D occurs as the first reset discharge. In response to this first reset discharge, negative wall charges are formed near the row electrodes Y and positive wall charges are formed near the column electrodes D in all the discharge cells PC.

Next, in the first half of the first reset stage R1, the X electrode driver 51 applies a reset pulse RP_{X}, which has the same polarity as that of the reset pulse RP1_{Y1} and has a peak potential capable of avoiding a surface discharge between the row electrodes X and Y due to the application of the reset pulse RP1_{Y1}, to all the row electrodes X₁ to Xₙ individually.

Then, in the second half of the first reset stage R1, the Y electrode driver 53 generates a reset pulse RP1_{Y2} which has such a pulse waveform that its potential gradually decreases with a lapse of time until it reaches a negative peak potential as shown in FIG. 22, and applies this to all the row electrodes Y₁ to Yₙ. Here, the application of this reset pulse RP1_{Y2} creates a second reset discharge between the row electrodes X and Y in all the discharge cells PC. Note that the peak potential of the reset pulse RP1_{Y2} is a minimum potential capable of creating the foregoing second reset discharge between the row electrodes X and Y with reliability, in consideration of the wall charges that are formed near the respective row electrodes X and Y in response to the foregoing first reset discharge. The peak potential of the reset pulse RP_{Y2} is also set to a potential higher than the peak potential of a negative write scan pulse SP_{W} to be described later, or equivalently, a potential closer to zero volts. The reason is that if the negative peak potential of the reset pulse RP1_{Y2} is set to be lower than the negative peak potential of the write scan pulse SP_{W}, a strong discharge can occur between the row electrodes Y and the column electrodes D. This might erase much of the wall charges formed near the column electrodes D, making an address discharge at the first selective write address stage W1_{W} to be described later unstable. The second reset discharge created in the second half of the first reset stage R1 erases the wall charges formed near the row electrodes X and Y in each discharge cell PC, whereby all the discharge cells PC are initialized into extinction mode. In addition, the application of the foregoing reset pulse RP1_{Y2} also creates a weak discharge between the row electrodes Y and the column electrodes D in all the discharge cells PC. This discharge erases part of the positive wall charges formed near the column electrodes D, thereby adjusting them to an amount capable of properly producing a selective write address discharge at the first selective write address stage W1_{W}.

Next, at the first selective write address stage W1_{W} in the subfield SF1, the Y electrode driver 53 applies a base pulse BP⁻ having a predetermined negative potential such as shown in FIG. 22 to the row electrodes Y₁ to Yₙ at the same time while selectively applying a write scan pulse SP_{W} having a negative peak potential to each of the row electrodes Y₁ to Yₙ in succession. In the meantime, the X electrode driver 51 applies a voltage of 0 volts to each of the row electrodes X₁ to Xₙ. Moreover, at the first selective write address stage W1_{W}, the address driver 55 generates pixel data pulses DP according to the logic levels of the pixel drive data bits corresponding to the subfield SF1. For example, if a pixel drive data bit of logic level 1 for setting a discharge cell PC to lighting mode is supplied, the address driver 55 generates a pixel data pulse DP having a positive peak potential. For a pixel drive data bit of logic level 0 for setting a discharge cell PC to the extinction mode, on the other hand, it generates a pixel data pulse DP of low voltage (0 volts). The address driver 55 then applies these pixel data pulses DP to the column electrodes D₁ to Dₘ in units of a single display line (m pulses) in synchronization with the timing of application of each write scan pulse SP_{W}. Here, simultaneously with the write scan pulse SP_{W}, a selective write address discharge occurs between the column electrodes D and the row electrodes Y in discharge cells PC to which pixel data pulses DP of high voltage for setting to the lighting mode are applied. By this selective write address discharge, these discharge cells PC are set into the state where positive wall charges are formed near the row electrodes Y and negative wall charges are formed near the column electrodes D, i.e., into the lighting mode. In discharge cells PC to which pixel data pulses DP of low voltage (0 volts) for setting to the extinction mode are applied, on the other hand, the foregoing selective write address discharge will not occur between the column electrodes D and the row electrodes Y simultaneously with the foregoing write scan pulse SP_{W}. Consequently, these discharge cells PC maintain their immediately preceding state, i.e., the extinction mode into which they are initialized at the first reset stage R1.

Next, at the weak light emission stage LL in the subfield SF1, the Y electrode driver 53 applies a weak light emission pulse LP, which has a predetermined positive peak potential such as shown in FIG. 22, to the row electrodes Y₁ to Yₙ simultaneously. With the application of this weak light emission pulse LP, a discharge (hereinafter, referred to as weak light emission discharge) occurs between the column electrodes D and the row electrodes Y in the discharge cells PC that are set to the lighting mode. That is, at the weak light emission stage LL, the row electrodes Y are subjected to a potential that can create a discharge between the row electrodes Y and the column electrodes D but not between the row electrodes X and Y in the discharge cells PC, so that a weak light emission discharge occurs only between the column electrodes D and the row electrodes Y in the discharge cells PC that are set to the lighting mode. Here, the weak light emission pulse LP has a positive peak potential lower than the peak potential of the sustain pulse IP which is applied in the subfields SF2 and later to be described below. As shown in FIG. 22, the rate of change of potential of the weak light emission pulse LP with a lapse of time in its rising interval is higher than those of the reset pulses (RP1_{Y1}, RP2_{Y1}) in their rising intervals. In other words, the potential transition at the front edge of the weak light emission pulse LP is made steeper than the potential transitions at the front edges of the reset pulses, thereby creating a discharge stronger than the first reset discharge which occurs at the first reset stages R1. This discharge is a column side cathode discharge such as described previously, and is created by the weak light emission pulse LP which has a peak potential lower than that of the sustain pulse IP. The emission brightness resulting from the discharge is thus lower than that of the sustain discharge occurring between the row electrodes X and Y. That is, at the weak light emission stage LL, a discharge that is accompanied with light emission of higher brightness level than that of the first reset discharge and lower than that of the sustain discharge, i.e., a discharge that is accompanied with as weak light emission as is available for display purposes is created as the weak light emission discharge. At the first selective write address stage W1_{W} which is performed immediately before the weak light emission stage LL, a selective write address discharge is created between the column electrodes D and the row electrodes Y in the discharge cells PC. Consequently, in the subfield SF1, brightness corresponding to a tone level one higher than the brightness level 0 is expressed by the light emission resulting from this selective write address discharge and the light emission resulting from the weak light emission discharge.

After the foregoing weak light emission discharge, negative wall charges are formed near the row electrodes Y and positive wall charges are formed near the column electrodes D.

Next, in the first half of the second reset stage R2 in the subfield SF2, the Y electrode driver 53 applies to all the row electrodes Y₁ to Yₙ a positive reset pulse RP2_{Y1} which has such a waveform that its front edge makes a gradual potential transition with a lapse of time as compared to the sustain pulse IP to be described later. As shown in FIG. 22, the reset pulse RP2_{Y1} has a positive peak potential lower than or equal to the positive peak potential of the sustain pulse IP. In the meantime, the address driver 55 sets the column electrodes D₁ to Dₘ into the state of the ground potential (0 volts). The X electrode driver 51 applies to each of all the row electrodes X₁ to Xₙ a positive reset pulse RP2_{X} which has a peak potential capable of preventing a surface discharge between the row electrodes X and Y due to the application of the foregoing reset pulse RP2_{Y1}. The reset pulse RP2_{X} has a positive peak potential lower than or equal to the positive peak potential of the sustain pulse IP. Here, instead of applying the foregoing reset pulse RP2_{X}, the X electrode driver 51 may set all the row electrodes X₁ to Xₙ to the ground potential (0 volts) unless the row electrodes X and Y create a surface discharge therebetween. In response to the application of the foregoing reset pulse RP2_{Y1}, a first reset discharge which is weaker than the column side cathode discharge at the foregoing weak light emission stage LL occurs between the row electrodes Y and the column electrodes D in discharge cells PC that have not undergone the column side cathode discharge at the weak light emission stage LL. That is, in the first half of the second reset stage R2, voltages are applied to between the electrodes with the row electrodes Y as anodes and the column electrodes D as cathodes, so that a column side cathode discharge of passing a current from the row electrodes Y to the column electrodes D occurs as the first reset discharge. In discharge cells PC that have already undergone the weak light emission discharge at the foregoing weak light emission stage LL, on the other hand, no discharge occurs even when the reset pulse RP2_{Y1} is applied. As a result, immediately after the completion of the first half of the second reset stage R2, negative wall charges are formed near the row electrodes Y and positive wall charges are formed near the column electrodes D in all the discharge cells PC. Then, in the second half of the second reset stage R2 in the subfield SF2, the Y electrode driver 53 applies to the row electrodes Y₁ to Yₙ a reset pulse RP2_{Y2} which has such a pulse waveform that its potential gradually decreases with a lapse of time until it reaches a negative peak potential Vᵣ₂ as shown in FIG. 22. In the second half of the second reset stage R2, the X electrode driver 51 also applies a base pulse BP⁺ having a predetermined positive potential to each of the row electrodes X₁ to Xₙ. Here, the application of these negative reset pulse RP2_{Y2} and positive base pulse BP⁺ creates a second reset discharge between the row electrodes X and Y in all the discharge cells PC. Note that the peak potentials of the reset pulse RP2_{Y2} and the base pulse BP⁺ both are minimum voltages that can produce the second reset discharge between the row electrodes X and Y with reliability, in consideration of the wall charges that are formed near the respective row electrodes X and Y by the foregoing first reset discharge. Moreover, the negative peak potential Vᵣ₂ of the reset pulse RP2_{Y2} is set to a potential higher than the peak potential of the negative write scan pulse SP_{W}, or equivalently, a potential closer to zero volts. The reason is that if the peak potential Vᵣ₂ of the reset pulse RP2_{Y2} is set to be lower than the peak potential of the write scan pulse SP_{W}, a strong discharge can occur between the row electrodes Y and the column electrodes D. This might erase much of the wall charges formed near the column electrodes D, making an address discharge at the second selective write address stage W2_{W} unstable. Here, the second reset discharge created in the second half of the second reset stage R2 erases the wall charges formed near the respective row electrodes X and Y in each discharge cell PC, whereby all the discharge cells PC are initialized into the extinction mode. In addition, the application of the foregoing reset pulse RP2_{Y2} also creates a weak discharge between the row electrodes Y and the column electrodes D in all the discharge cells PC. This discharge erases part of the positive wall charges formed near the column electrodes D, thereby adjusting them to an amount capable of properly producing a selective write address discharge at the second selective write address stage W2_{W}.

Next, at the second selective write address stage W2_{W} of the subfield SF2, the Y electrode driver 53 applies the base pulse BP⁻ having a predetermined negative potential such as shown in FIG. 22 to the row electrodes Y₁ to Yₙ at the same time while selectively applying the write scan pulse SP_{W} having a negative peak potential to each of the row electrodes Y₁ to Yₙ in succession. In the meantime, the X electrode driver 51 applies the base pulse BP⁺ having a predetermined positive potential to each of the row electrodes X₁ to Xₙ. Moreover, at the second selective write address stage W2_{W}, the address driver 55 initially generates pixel data pulses DP having peak potentials according to the logic levels of the pixel drive data bits corresponding to the subfield SF2. For example, if a pixel drive data bit of logic level 1 for setting a discharge cell PC to lighting mode is supplied, the address driver 55 generates a pixel data pulse DP having a positive peak potential. For a pixel drive data bit of logic level 0 for setting a discharge cell PC to the extinction mode, on the other hand, it generates a pixel data pulse DP of low voltage (0 volts). The address driver 55 then applies these pixel data pulses DP to the column electrodes D₁ to Dₘ in units of a single display line (m pulses) in synchronization with the timing of application of each write scan pulse SP_{W}. Here, simultaneously with the write scan pulse SP_{W}, a selective write address discharge occurs between the column electrodes D and the row electrodes Y in discharge cells PC to which pixel data pulses DP of high voltage for setting to the lighting mode are applied. Furthermore, immediately after the selective write address discharge, a weak discharge also occurs between the row electrodes X and Y in these discharge cells PC. More specifically, after the application of the write scan pulse SP_{W}, a voltage corresponding to the base pulses BP⁻ and BP⁺ is applied to between the row electrodes X and Y. Since this voltage is set to be lower than the discharge start voltage of the discharge cells PC, no discharge will be created inside the discharge cells PC by the application of this voltage alone. If the selective write address discharge is created, however, a discharge occurs between the row electrodes X and Y even by means of the voltage application with the base pulses BP⁻ and BP⁺ alone, being induced by this selective write address discharge. By this discharge and the foregoing selective write address discharge, these discharge cells PC are set into a state where positive wall charges are formed near the row electrodes Y, negative wall charges are formed near the row electrodes X, and negative wall charges are formed near the column-electrodes D, i.e., into the lighting mode. In discharge cells PC to which pixel data pulses DP of low voltage (0 volts) for setting to the extinction mode are applied, on the other hand, such a selective write address discharge as described above will not occur between the column electrodes D and the row electrodes Y simultaneously with the foregoing write scan pulse SP_{W}. Thus, the row electrodes X and Y will not create any discharge, either. Consequently, these discharge cells PC maintain their immediately preceding state, i.e., the extinction mode into which they are initialized at the second reset stage R2.

Next, at the sustain stage I of the subfield SF2, the Y electrode driver 53 generates a single sustain pulse IP having a positive peak potential, and applies it to each of the row electrodes Y₁ to Yₙ simultaneously. In the meantime, the X electrode driver 51 sets the row electrodes X₁ to Xₙ into the state of the ground potential (0 volts). The address driver 55 sets the column electrodes D₁ to Dₘ into the state of the ground potential (0 volts). The application of the sustain pulse IP creates a sustain discharge between the row electrodes X and Y in the discharge cells PC that are set to the lighting mode. The light emitted from the phosphor layer 17 in response to this sustain discharge is emitted outside through the front transparent substrate 10, thereby performing a single round of display emission corresponding to the brightness weight of this subfield SF2. With the application of this sustain pulse IP, a discharge also occurs between the row electrodes Y and the column electrodes D in the discharge cells PC that are set to the lighting mode. This discharge and the foregoing sustain discharge produce negative wall charges near the row electrodes Y and positive wall charges near the row electrodes X and the column electrodes D in the discharge cells PC.

Next, at the sustain stage I in each of the subfields SF3 to SF14, the X electrode driver 51 and the Y electrode driver 53 apply the sustain pulse IP having a positive peak to the row electrodes Y₁ to Yₙ and X₁ to Xₙ repeatedly as many times as corresponding to the brightness weight of that subfield, taking turns to the row electrodes Y and X alternately as shown in FIG. 22. Each time this sustain pulse IP is applied, a sustain discharge occurs between the row electrodes X and Y in the discharge cells PC that are set to the lighting mode. The light emitted from the phosphor layer 17 in response to this sustain discharge is emitted outside through the front transparent substrate 10, thereby performing as many times of display light emission as corresponding to the brightness weight of that subfield SF. It should be noted that the total number of sustain pulses IP to be applied in each sustain stage I is an odd number. That is, in each sustain stage I, the first sustain pulse IP and the last sustain pulse IP both are applied to the row electrodes Y. As a result, immediately after the completion of each sustain stage I, negative wall charges are formed near the row electrodes Y and positive wall charges are formed near the row electrodes X and the column electrodes D in the discharge cells PC that have undergone the sustain discharges. This brings the wall charges formed in each discharge cell PC into the same condition as immediately after the completion of the first reset discharge.

Next, at the erase stage E in each of the subfields SF2 to SF14, the Y electrode driver 53 applies to the row electrodes Y₁ to Yₙ an erase pulse EP which has a negative peak potential having the same waveform as those of the reset pulses RP1_{Y2} and RP2_{Y2} that are applied in the second halves of the first reset stage R1 and second reset stage R2. In the meantime, the X electrode driver 51 applies the base pulse BP⁺, having a predetermined positive potential, to each of all the row electrodes X₁ to Xₙ as in the second half of the second reset stage R2. In response to these erase pulse EP and base pulse BP⁺, a weak erase discharge occurs in the display cells PC that have undergone the foregoing sustain discharge. This erase discharge erases part of the wall charges formed in the display cells PC, thereby shifting these display cells PC into the extinction mode. Furthermore, in response to the application of the erase pulse EP, a weak discharge also occurs between the column electrodes D and the row electrodes Y in the display cells PC. This discharge adjusts the positive wall charges formed near the column electrodes D to an amount capable of properly producing a selective write address discharge at the next second selective write address stage W2_{W}. Note that the second selective write address stage W2_{W} is performed in each of the subfields SF3 to SF14 instead of the selective erase address stage W_{D}.

Now, if the driving shown in FIGS. 21 and 22 is used to express the second tone level which is one level brighter than the first tone level for expressing black display (brightness level 0), then the selective write address discharge is created only in the subfield SF1 out of SF1 to SF14. Consequently, a weak light emission discharge occurs only in SF1 out of SF1 to SF14 as a discharge contributing to the display image. When expressing the third tone level which is one level brighter than this second tone level, the selective write address discharge is created only in the subfield SF2 out of SF1 to SF14. Consequently, a single sustain discharge occurs only in SF2 out of SF1 to SF14 as a discharge contributing to the display image. Then, at the fourth and subsequent grayscale levels, a selective write address discharge is created in both the subfields SF1 and SF2, and a selective write address discharge is further created in each of as many consecutive subfields as corresponding to that tone level. Consequently, for discharges contributing to the display image, a weak light emission discharge is initially created in the subfield SF1 and then sustain discharges are created in each of as many consecutive subfields as corresponding that tone level. This driving makes it possible to display 16 grayscale levels of intermediate brightness as in FIG. 16.

Here, according to the driving shown in FIGS. 21 and 22, the reset pulses RP1_{Y2} and RP2_{Y2} to be applied to the row electrodes Y at the first reset stage R1 and the second reset stage R2 and the erase pulse EP to be applied to the row electrodes Y at the erase stage E have the same waveforms, and both can thus be generated by a common circuit. Moreover, in each of the subfields SF1 to SF14, the states of the display cells PC (lighting mode, extinction mode) are set by means of the selective write address stages (W1_{W}, W2_{W}) alone, requiring only one system of circuitry for generating the scan pulses. Note that at these selective write address stages, ordinary column side anode discharges are created with the column electrodes as anodes.

Consequently, when the selective write address method such as shown in FIGS. 21 and 22 is employed to drive the PDP 50, the panel driver for generating the various types of drive pulses can be constructed at low price as compared to the cases where the selective erase address method such as shown in FIGS. 17 and 18 is employed.

Now, according to the driving shown in FIG. 18 or FIG. 22, a voltage is applied to between the electrodes with the column electrodes D as cathodes and the row electrodes Y as anodes at the first reset stage R1 of the first subfield SF1, so that a column side cathode discharge of passing a current from the row electrodes Y to the column electrodes D occurs as the first reset discharge. At the time of this first reset discharge, positive ions in the discharge gas therefore travel toward the column electrodes D, in which time they collide with MgO crystals, or secondary electron emitting material, contained in the phosphor layer 17 such as shown in FIG. 5 and make these MgO crystals emit secondary electrons. In particular, in the PDP 50, MgO crystals are exposed to the discharge spaces as shown in FIG. 5. This increases the collision probability with positive ions, so that secondary electrons are emitted to the display spaces with high efficiency. It follows that the priming effect of these secondary electrons lowers the discharge start voltage of the discharge cells PC, making it possible to create a relatively weak reset discharge. Since the weakened reset discharge reduces the emission brightness ascribable to that discharge, it becomes possible to display with improved dark contrast.

Moreover, according to the driving shown in FIG. 18 or FIG. 22, the first reset discharge is created between the row electrodes Y which are formed on the front transparent substrate 10, and the column electrodes D which are formed on the rear substrate 14 as shown in FIG. 3. As compared to the cases where a reset discharge is created between the row electrodes X and Y both of which are formed on the front transparent substrate 10, it is therefore possible to reduce the discharge light to be emitted outside from the front transparent substrate 10, with a further improvement in the dark contrast.

Here, the display panel or PDP 50 is configured so that CL emission MgO crystals, or secondary electron emitting material, are contained in the magnesium oxide layer 13 which is formed on the front transparent substrate 10, and in the phosphor layer 17 which is formed on the rear substrate 14 in each discharge cell PC.

According to this structure, it becomes possible to reduce the discharge delay time of the column side cathode discharge significantly as compared to conventional PDPs. As a result, even if the positive peak potentials of the reset pulses RP1_{Y1} and RP2_{Y1} are set to be lower than or equal to the positive peak potential of the sustain pulse IP as shown in FIG. 22, it is possible to create the first reset discharge, a column side cathode discharge, with reliability. Since the positive peak potentials of the reset pulses RP1_{Y1} and RP2_{Y1} are relatively low, the resulting column side cathode discharges also become weaker.

Consequently, according to the present invention, a column side cathode discharge of extremely low discharge intensity can be created as the reset discharge. This allows an improvement to the image contrast, or the dark contrast when displaying dark images in particular.

In the embodiment shown in FIG. 22, the positive peak potential of the reset pulse RP1_{X} (RP2_{X}) to be applied simultaneously with the reset pulse RP1_{Y1} (RP2_{Y1}) is set to be lower than or equal to the positive peak potential of the sustain pulse IP. The positive peak potential of the reset pulse RP1_{X} (RP2_{X}) may be set to be higher, however, if the column electrodes D employ the configuration such as shown in FIG. 2 each. More specifically, when the wide portions WP having an increased electrode width along the direction of the display lines are formed on the respective column electrodes D at areas where opposed to the transparent electrodes Ya as shown in FIG. 2, discharges are more difficult to occur between the column electrodes D and the row electrodes X than between the column electrodes D and the row electrodes Y. Thus, the positive peak potential of the reset pulse RP1_{X} (RP2_{X}) may be made higher than the positive peak potential of the sustain pulse IP if no discharge occurs between the column electrodes D and the row electrodes X in the first half of the reset stage R. It should be appreciated that the positive peak potential of either one of the reset pulses RP1_{X} and RP2_{X} alone may be made higher than the positive peak potential of the sustain pulse IP.

According to the embodiment shown in FIG. 22, the reset pulse RP1_{Y1} at the first reset stage R1 and the reset pulse RP2_{Y1} at the second reset stage R2 both have a potential lower than or equal to the positive peak potential of the sustain pulse IP. Nevertheless, at least either one of these may be set to a potential lower than or equal to the positive peak potential of the sustain pulse IP. In this case, however, the charged particles generated by the first reset discharge at the second reset stage R2 have an impact on the selective write address stage W2_{W} in each of all the subfields SF2 and later. Then, if the selective write address discharges in the subfields SF2 and later require further stabilization, the positive peak potential of the reset pulse RP2_{Y1} alone is preferably set to be higher than that of the sustain pulse IP.

At the reset stages (R1, R2) shown in FIG. 22, the first reset discharge, a column side cathode discharge, is created by applying the reset pulses (RP1_{Y1}, RP2_{Y1}) to the row electrodes Y₁ to Yₙ in the respective first halves. The application of either one or both of these reset pulses RP1_{Y1} and RP2_{Y1} may be omitted, however.

For example, such a first reset stage R1 as shown in FIG. 19 is employed instead of the first reset stage R1 shown in FIG. 22. As shown in FIG. 19, the row electrodes Y₁ to Yₙ are fixed to the ground potential in the first half of the first reset stage R1. In addition, such a second reset stage R2 as shown in FIG. 20 is employed instead of the second reset stage R2 shown in FIG. 22. As shown in FIG. 20, the row electrodes Y₁ to Yₙ are fixed to the ground potential in the first half of the second reset stage R2. In conjunction with this, the application of either one or both of the reset pulses RP1_{X} and RP2_{X}, which are supposed to be applied to all the row electrodes X at the same timing as that of the reset pulses (RP1_{Y1}, RP2_{Y2}), may be omitted. That is, in the first halves of the respective reset stages R1 and R2, all the row electrodes X are subjected to the ground potential instead of the reset pulses (RP1_{X}, RP2_{X}) while all the row electrodes Y are set to the ground potential as shown in FIGS. 19 and 20.

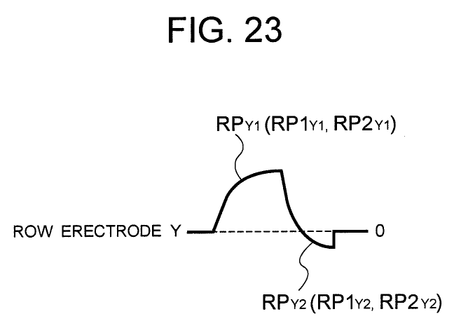

Moreover, the reset pulses RP_{Y1}, RP1_{Y1}, and RP2_{Y1} to be applied to create the foregoing first reset discharge are not limited to the rising waveforms of constant gradients such as shown in FIGS. 8, 13, 18, and 22. For example, they may gradually change in gradient with a lapse of time as shown in FIG. 23. Furthermore, the reset pulses RP_{Y2}, RP1_{Y2}, and RP2_{Y2} to be applied to create the foregoing second reset discharge are not limited to the falling waveforms of constant gradients such as shown in FIGS. 8, 13, 18, and 22. For example, they may gradually change in gradient with a lapse of time as shown in FIG. 23.

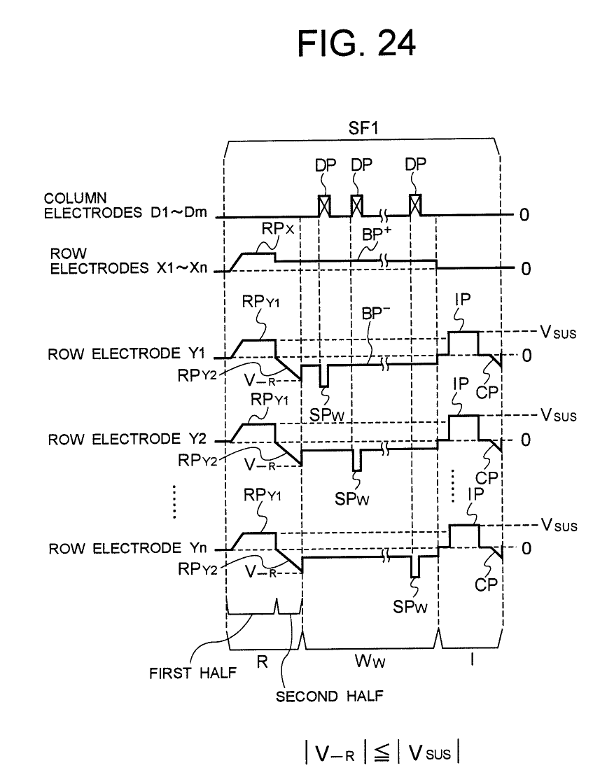

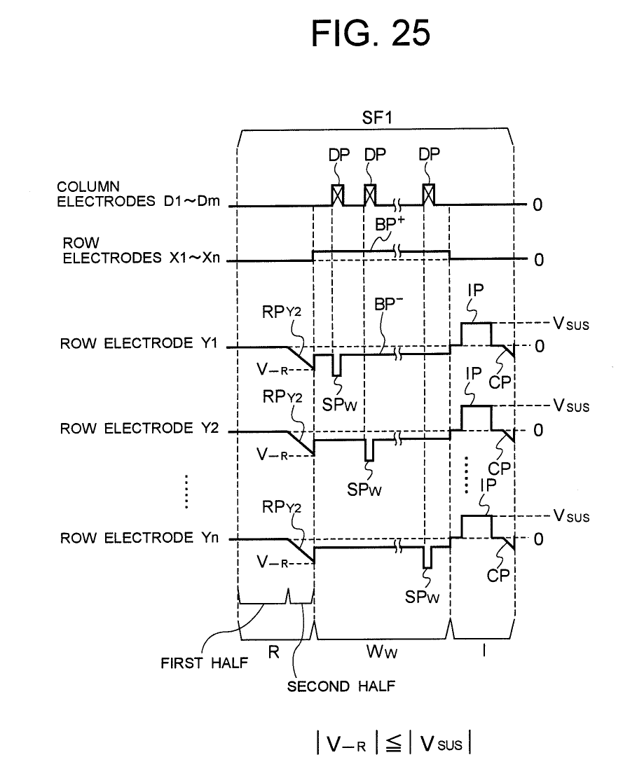

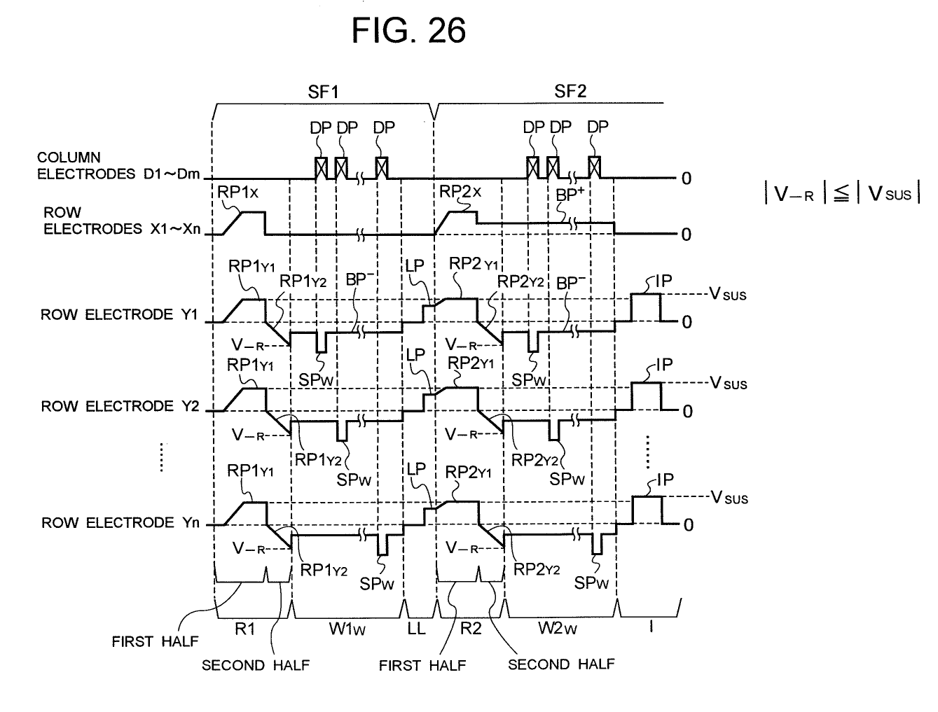

Now, for the reset pulse RP_{Y2} that is applied in the second half of the reset stage R in the subfield SF1 in FIGS. 8 and 13, its negative peak potential V_{-R} is desirably set to a value having an absolute value smaller than or equal to that of the positive peak potential V_{SUS} of the foregoing sustain pulse IP as shown in FIG. 24. Moreover, for the reset pulse RP_{Y2} that is applied at the reset stage R of the subfield SF1 in FIG. 11, its negative peak potential V_{-R} is also desirably set to a value having an absolute value smaller than or equal to that of the positive peak potential V_{SUS} of the foregoing sustain pulse IP as shown in FIG. 25. For the reset pulses RP1_{Y2} and RP2_{Y2} that are applied in the second halves of the respective first and second reset stages R1 and R2 in FIGS. 18 and 22, their negative peak potential V_{-R} is also desirably set to a value having an absolute value smaller than or equal to that of the positive peak potential V_{SUS} of the foregoing sustain pulse IP as shown in FIG. 26. For both the reset pulse RP1_{Y2} shown in FIG. 19 and the reset pulse RP2_{Y2} shown in FIG. 20, their negative peak potential V_{-R} is also desirably set to a value having an absolute value smaller than or equal to that of the positive peak potential V_{SUS} of the sustain pulse IP. Furthermore, when the reset pulses RP_{Y2}, RP_{1Y2}, and RP2_{Y2} employ such a waveform as shown in FIG. 23 each, their negative peak potential V_{-R} is desirably set to a value having an absolute value smaller than or equal to that of the positive peak potential V_{SUS} of the sustain pulse IP.

That is, the voltages to be applied to between the electrodes in each discharge cell PC in response to these reset pulses RP_{Y2}, RP1_{Y2}, and RP2_{Y2} are made lower than the voltage to be applied to between the electrodes in each discharge cell PC in response to the sustain pulse IP. This suppresses the intensity of the discharge produced in response to the reset pulse RP_{Y2}, RP1_{Y2}, or RP2_{Y2}, thereby preventing the wall charges from being erased excessively. Such consideration makes it possible, at the selective write address stages (W_{W}, W1_{W}, W2_{W}) immediately after the reset stages (R, R1, R2), to reduce failures of the selective write address discharge due to insufficient amounts of wall charges and improve the dark contrast as well.

Since the write scan pulse SP_{W} to be applied at the selective write address stages (W_{W}, W1_{W}, W2_{W}) has a pulse width smaller than that of the sustain pulse IP, the selective write address discharge is harder to create than the sustain discharge. The negative peak potential of the write scan pulse SP_{W} may thus be made lower than (−V_{SUS}).

In short, the negative peak potential of the reset pulse RP_{Y2}, RP1_{Y2}, or RP2_{Y2} and the negative peak potential of the write scan pulse SP_{W} have only to satisfy the relationship:

0>RP_{Y2}(RP1_{Y2}, RP2_{Y2})≧−V_{SUS}>SP_{W}.

Note that the negative peak potential of the write scan pulse SP_{W} is preferably higher than or equal to (−V_{SUS}) as long as the potential of (−V_{SUS}) or higher can properly produce the selective write address discharge.

That is, the negative peak potential of the reset pulse RP_{Y}2, RP1_{Y2}, or RP2_{Y2} and the negative peak potential of the write scan pulse SP_{W} satisfy the relationship:

0>RP_{Y2}(RP1_{Y2}, RP2_{Y2})>SPW≧−V_{SUS}.

Hereinafter, a third embodiment of the present invention will be described in detail with reference to the drawings.

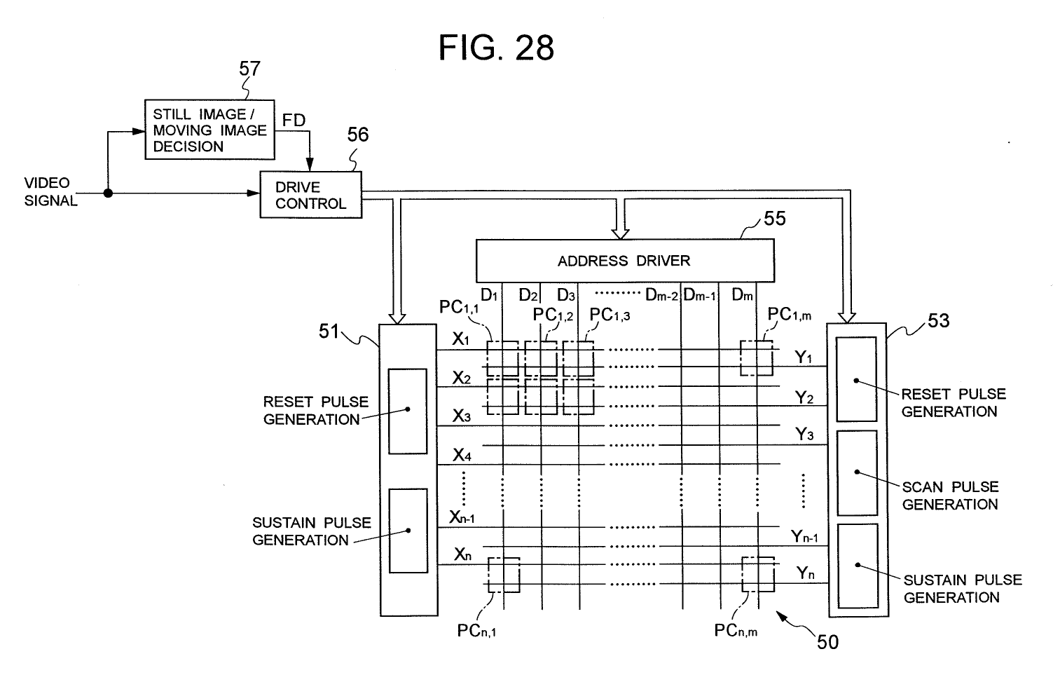

FIG. 28 is a diagram showing the general configuration of a plasma display apparatus which drives its plasma display panel according to a driving method of the present invention.

As shown in FIG. 28, this plasma display apparatus comprises a plasma display panel or PDP 50, an X electrode driver 51, a Y electrode driver 53, an address driver 55, a drive control circuit 56, and a still image/moving image decision circuit 57.

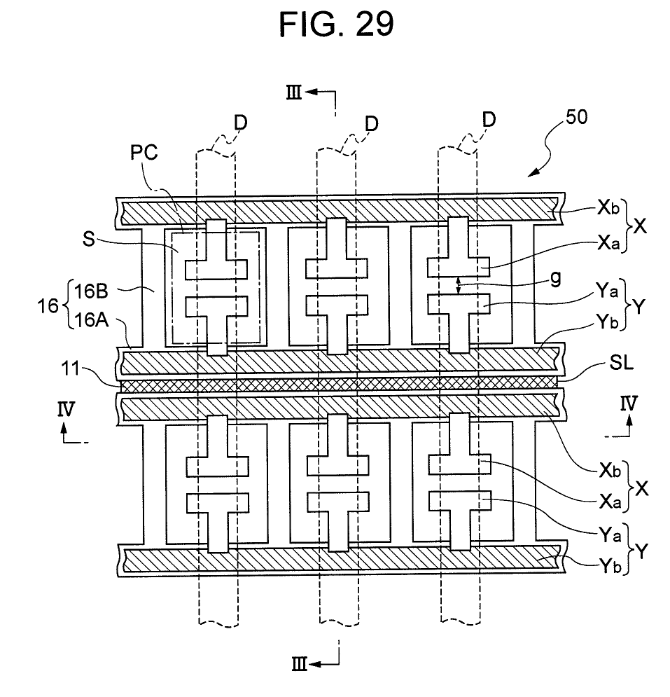

FIG. 29 is a front view schematically showing the internal structure of the PDP 50 as seen from the display-surface side. It should be appreciated that FIG. 29 selectively shows the intersections between three mutually adjoining column electrodes D and two mutually adjoining display lines. The cross section of the PDP 50, taken along the line III-III of FIG. 29 is shown in FIG. 3. The cross section of the PDP 50, taken along the line IV-IV of FIG. 29 is shown in FIG. 4. As shown in FIG. 29, the PDP according to the third embodiment has the same internal structure as shown in FIGS. 2 to 4, whereas the column electrodes D that are formed to extend in a direction orthogonal to the pairs of row electrodes (X,Y) at positions corresponding to the transparent electrodes Xa and Ya of the respective pairs of row electrodes (X,Y) have a different shape than shown in FIG. 2 each. More specifically, the wide portions WP of FIG. 2 are not formed.

Even in the present embodiment, the PDP 50 is configured so that CL emission MgO crystals, or secondary electron emitting material, are contained not only in the magnesium oxide layer 13 which is formed on the front transparent substrate 10, but also in the phosphor layer 17 which is formed on the rear substrate 14 in each discharge cell PC.

The following operation and effect resulting from the adoption of the foregoing configuration are the same as have been described with reference to FIGS. 9 and 10.

Note that FIG. 9 is a chart showing the temporal transition of the discharge intensity of a discharge that occurs when a predetermined voltage is applied to between a row electrode and a column electrode of a conventional PDP, with this column electrode as a cathode, where CL emission MgO crystals are contained in the magnesium oxide layer 13 alone out of the magnesium oxide layer 13 and the phosphor layer 17. FIG. 10, on the other hand, is a chart showing the temporal transition of the discharge intensity of a discharge that occurs when a predetermined voltage is applied to between a row electrode and a column electrode of the PDP 50 according to the present invention, with this column electrode as a cathode, where CL emission MgO crystals are contained both in the magnesium oxide layer 13 and the phosphor layer 17.

More specifically, according to the conventional PDP, a discharge of relatively high intensity continues for 1 [ms] or more from the discharge start time as shown in FIG. 9. In the PDP 50 according to the present invention, on the other hand, a weak discharge extinguishes within approximately 0.04 [ms] from the discharge start time as shown in FIG. 10. The structure that CL emission MgO crystals are contained both in the magnesium oxide layer 13 and the phosphor layer 17 can thus be employed to reduce the discharge delay time significantly and weaken the discharge as compared to the conventional PDP.

The X electrode driver 51 is composed of a reset pulse generation circuit and a sustain pulse generation circuit. The reset pulse generation circuit of the X electrode driver 51 generates a reset pulse (to be described later) having a peak potential (pulse voltage) that is specified by a reset pulse generation signal supplied from the drive control circuit 56, and applies this to the row electrodes X of the PDP 50. The sustain pulse generation circuit of the X electrode driver 51 generates a sustain pulse (to be described later) having a peak potential (pulse voltage) that is specified by a sustain pulse generation signal supplied from the drive control circuit 56, and applies this to the row electrodes X of the PDP 50. The Y electrode driver 53 is composed of a reset pulse generation circuit, a scan pulse generation circuit, and a sustain pulse generation circuit. The reset pulse generation circuit of the Y electrode driver 53 generates a reset pulse (to be described later) having a peak potential (pulse voltage) that is specified by a reset pulse generation signal supplied from the drive control circuit 56, and applies this to the row electrodes Y of the PDP 50. The scan pulse generation circuit of the Y electrode driver 53 generates a scan pulse (to be described later) having a peak potential (pulse voltage) that is specified by a scan pulse generation signal supplied from the drive control circuit 56, and applies this to the row electrodes Y₁ to Yₙ of the PDP 50 in succession. The sustain pulse generation circuit of the Y electrode driver 53 generates a sustain pulse (to be described later) having a peak potential (pulse voltage) that is specified by a sustain pulse generation signal supplied from the drive control circuit 56, and applies this to the row electrodes Y of the PDP 50. The address driver 55 generates pixel data pulses to be applied to the column electrodes D of the PDP 50 in accordance with a pixel data pulse generation signal supplied from the drive control circuit 56.

Based on mutually adjoining fields of the input video signal, the still image/moving image decision circuit 57 decides whether the image shown by this input video signal is a still image or a moving image, and supplies a still image/moving image decision signal FD for indicating the decision result to the drive control circuit 56.

Even in the present embodiment, the drive control circuit 56 obtains 14 bits of pixel drive data GD according to the data conversion table shown in FIG. 6, associates the first to fourteenth bits with subfields SF1 to SF14, respectively, and supplies bit digits corresponding to the subfields SF to the address driver 55 as pixel drive data bits in units of a single display line (m pieces).

The drive control circuit 56 also supplies various types of control signals for driving the PDP 50 of the foregoing structure according to an emission drive sequence such as shown in FIG. 7, to a panel driver which consists of the X electrode driver 51, the Y electrode driver 53, and the address driver 55.

Here, the drive control circuit 56 acquires the foregoing still image/moving image decision signal FD in each unit display period (single field or single frame display period), and supplies the panel driver with an image mode signal which indicates [still image mode] if the decision result indicated by this still image/moving image decision signal FD shows a still image, and [moving image mode] if a moving image.

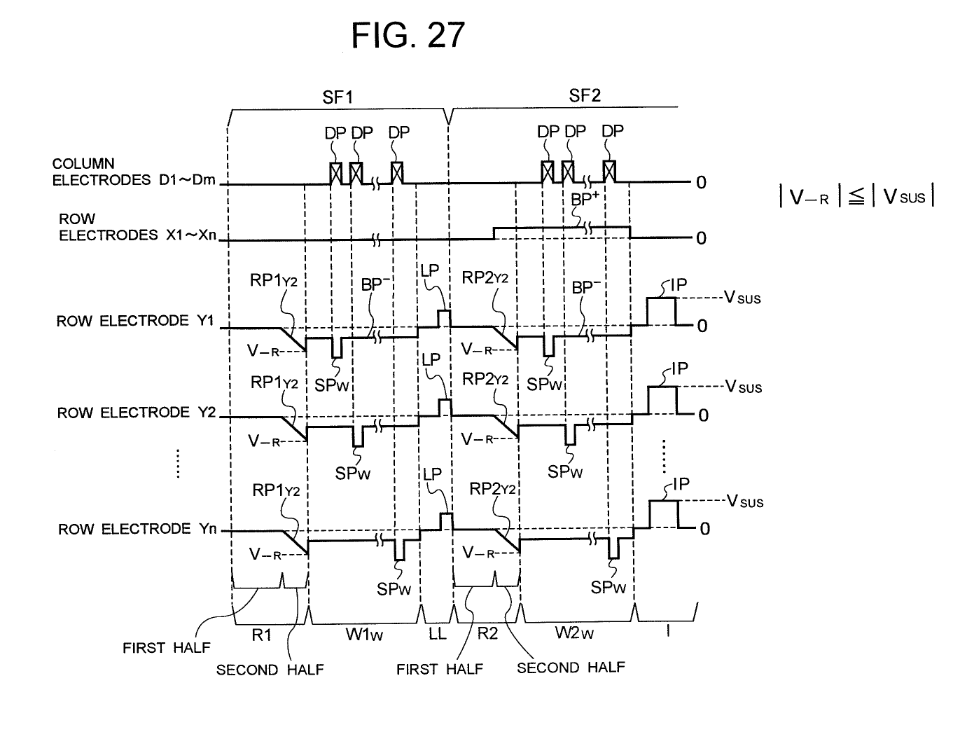

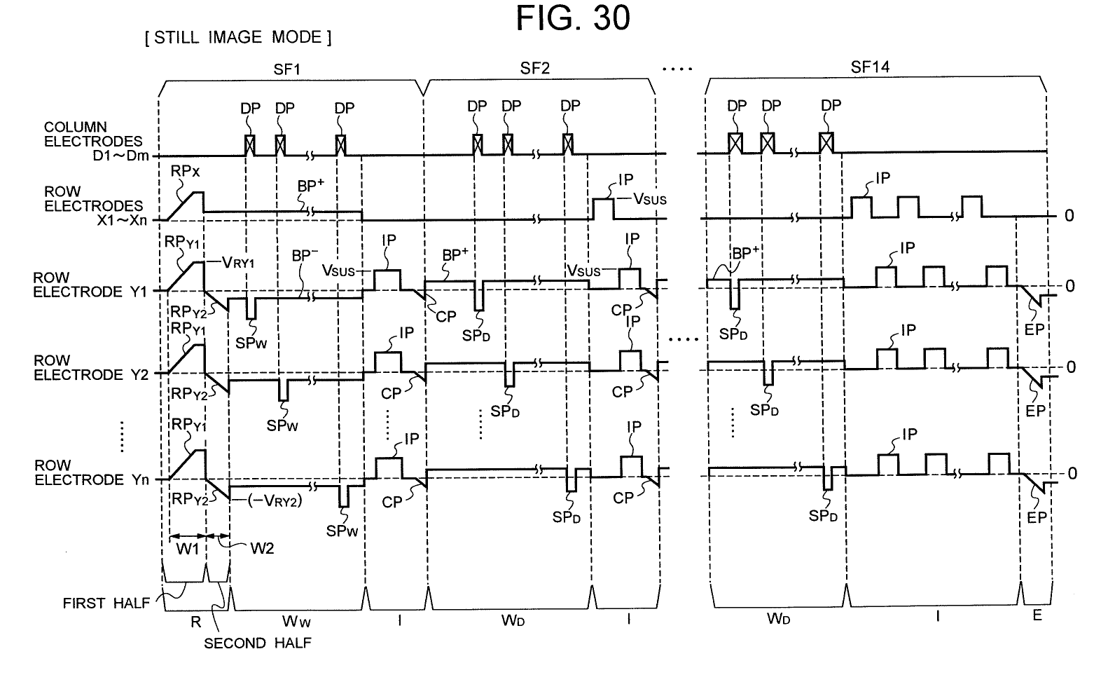

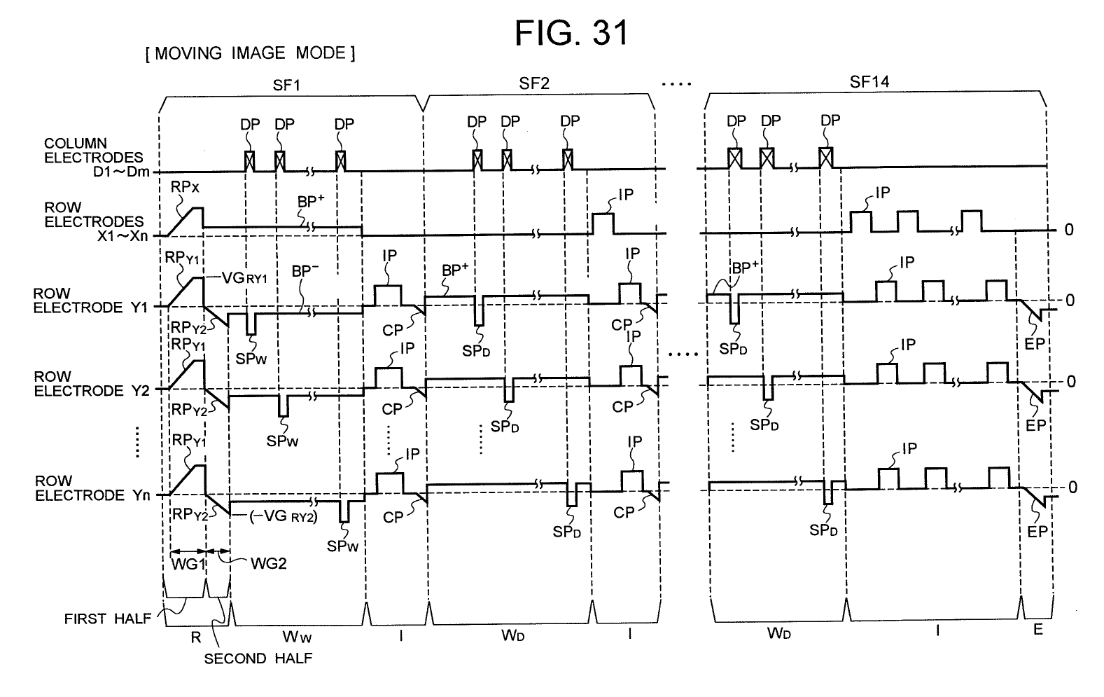

The panel driver (the X electrode driver 51, the Y electrode driver 53, and the address driver 55) supplies various types of drive pulses to the column electrodes D and the row electrodes X and Y of the PDP 50 as shown in FIG. 30 if the image mode signal supplied from the drive control circuit 56 indicates [still image mode], and as shown in FIG. 31 if [moving image mode]. FIGS. 26 and 27 selectively show the operations only in the first subfield SF1, the next subfield SF2, and the last subfield SF14 out of the subfields SF1 to SF14 shown in FIG. 9.

Here, the operations to be performed by the application of various drive pulses are common between [still image model shown in FIG. 30 and [moving image mode] shown in FIG. 31.

A description will thus be initially given of the operations for applying the various types of drive pulses and the operations to be performed by the application of the drive pulses, taking the case of [still image mode] shown in FIG. 30 as an example.

In the first half of the reset stage R in the subfield SF1, the Y electrode driver 53 applies to all the row electrodes Y₁ to Yₙ a reset pulse RP_{Y1} which has such a waveform that its front edge makes a gradual potential transition with a lapse of time as compared to a sustain pulse to be described later, and has a positive peak potential of V_{RY1} and a pulse width of W1. In the meantime,.the address driver 55 sets the column electrodes D₁ to Dₘ into the state of the ground potential (0 volt). The application of the foregoing reset pulse RP_{Y1} creates a first reset discharge between the row electrodes Y and the column electrodes D in all the discharge cells PC individually. That is, in the first half of the reset stage R, voltages are applied to between the electrodes with the row electrodes Y as anodes and the column electrodes D as cathodes, whereby a discharge for passing a current from the row electrodes Y to the column electrodes D (hereinafter, referred to as column side cathode discharge) occurs as the foregoing first reset discharge. In response to this first reset discharge, negative wall charges are formed near the row electrodes Y and positive wall charges are formed near the column electrodes D in all the discharge cells PC.

Moreover, in the first half of the reset stage R, the X electrode driver 51 applies a reset pulse RP_{X}, which has the same polarity as that of the reset pulse RP_{Y1} and has a peak potential capable of avoiding a surface discharge between the row electrodes X and Y due to the application of the reset pulse RP_{Y1}, to all the row electrodes X₁ to Xₙ individually.

Next, in the second half of the reset stage R in the subfield SF1, the Y electrode driver 53 generates a reset pulse RP_{Y2} which has such a pulse waveform that its potential gradually decreases with a lapse of time until it reaches a negative peak potential (−V_{RY2}) as shown in FIG. 30, with a pulse width of W2, and applies this to all the row electrodes Y₁ to Yₙ. In the second half of the reset stage R, the X electrode driver 51 also applies a base pulse BP⁺ having a positive potential to each of the row electrodes X₁ to Xₙ. Here, the application of these negative reset pulse RP_{Y2} and positive base pulse BP⁺ creates a second reset discharge between the row electrodes X and Y in all the discharge cells PC. Note that the negative peak potential (−V_{RY2}) of the reset pulse RP_{Y2} and the positive peak potential of the base pulse BP⁺ both are minimum potentials that can produce the second reset discharge between the row electrodes X and Y in response to the foregoing first reset discharge with reliability, in consideration of the wall charges that are formed near the respective row electrodes X and Y. The negative peak potential (−V_{RY2}) of the reset pulse RP_{Y2} is also set to a potential higher than the peak potential of a negative write scan pulse SP_{W} to be described later, or equivalently, a potential closer to zero volts. The reason is that if the peak potential of the reset pulse RP_{Y2} is set to be lower than the peak potential of the write scan pulse SP_{W}, a strong discharge can occur between the row electrodes Y and the column electrodes D. This might erase much of the wall charges formed near the column electrodes D, making an address discharge in the selective write address stage W_{W} unstable. The second reset discharge created in the second half of the reset stage R erases the wall charges formed near the respective row electrodes X and Y in each discharge cell PC, whereby all the discharge cells PC are initialized into extinction mode. In addition, the application of the foregoing reset pulse RP_{Y2} also creates a weak discharge between the row electrodes Y and the column electrodes D in all the discharge cells PC. This discharge erases part of the positive wall charges formed near the column electrodes D, thereby adjusting them to an amount capable of properly producing a selective write address discharge at the selective write address stage W_{W} to be described later.

Next, at the selective write address stage W_{W} of the subfield SF1, the Y electrode driver 53 applies a base pulse BP⁻ having a negative peak potential such as shown in FIG. 30 to the row electrodes Y₁ to Yₙ at the same time while selectively applying a write scan pulse SP_{W} having a negative peak potential to each of the row electrodes Y₁ to Yₙ in succession. In the meantime, the X electrode driver 51 continues applying the foregoing base pulse BP⁺ to each of the row electrodes X₁ to Xₙ. It should be appreciated that the peak potentials of the base pulse BP⁻ and the base pulse BP⁺ both are set so that the voltages between the row electrodes X and Y fall below the discharge start voltage of the discharge cells PC during a period when the write scan pulse SP_{W} is not applied.

Moreover, at this selective write address stage W_{W}, the address driver 55 initially generates pixel data pulses DP according to the logic levels of the pixel drive data bits corresponding to the subfield SF1. For example, if a pixel drive data bit of logic level 1 for setting a discharge cell PC to the lighting mode is supplied, the address driver 55 generates a pixel data pulse DP having a positive peak potential. For a pixel drive data bit of logic level 0 for setting a discharge cell PC to the extinction mode, on the other hand, the address driver 55 generates a pixel data pulse DP of low voltage (0 volts). The address driver 55 then applies these pixel data pulses DP to the column electrodes D₁ to Dₘ in units of a single display line (m pulses) in synchronization with the timing of application of each write scan pulse SP_{W}. Here, simultaneously with the write scan pulse SP_{W}, a selective write address discharge occurs between the column electrodes D and the row electrodes Y in discharge cells PC to which pixel data pulses DP of high voltage for setting to the lighting mode are applied. Furthermore, immediately after the selective write address discharge, a weak discharge also occurs between the row electrodes X and Y in these discharge cells PC. More specifically, after the application of the write scan pulse SP_{W}, a voltage corresponding to the base pulse BP⁻ and the base pulse BP⁺ is applied to between the row electrodes X and Y. Since this voltage is set to be lower than the discharge start voltage of the discharge cells PC, no discharge will be creased inside the discharge cells PC by the application of this voltage alone. If the selective write address discharge is created, however, a discharge can be created between the row electrodes X and Y even by means of the voltage application based on the base pulse BP⁻ and the base pulse BP⁺ alone, being induced by this selective write address discharge. By this discharge and the foregoing selective write address discharge, these discharge cells PC are set into a state where positive wall charges are formed near the row electrodes Y, negative wall charges are formed near the row electrodes X, and negative wall charges are formed near the column electrodes D, i.e., into the lighting mode. In discharge cells PC to which pixel data pulses DP of low voltage (0 volts) for setting to the extinction mode are applied, on the other hand, such a selective write address discharge as described above will not occur between the column electrodes D and the row electrodes Y simultaneously with the foregoing write scan pulse SP_{W}. Thus, the row electrodes X and Y will not create any discharge, either. Consequently, these discharge cells PC maintain their immediately preceding state, i.e., the state of the extinction mode into which they are initialized at the reset stage R.

Next, at the sustain stage I of the subfield SF1, the Y electrode driver 53 generates a single sustain pulse IP having a positive peak potential V_{SUS}, and applies it to each of the row electrodes Y₁ to Yₙ simultaneously. In the meantime, the X electrode driver 51 sets the row electrodes X₁ to Xₙ into the state of the ground potential (0 volts). The address driver 55 sets the column electrodes D₁ to Dₘ into the state of the ground potential (0 volts). With the application of the foregoing sustain pulse IP, a sustain discharge occurs between the row electrodes X and Y in the discharge cells PC that are set to the lighting mode as described above. The light emitted from the phosphor layer 17 in response to this sustain discharge is emitted outside through the front transparent substrate 10, thereby performing a single round of display light emission corresponding to the brightness weight of this subfield SF1. With the application of this sustain pulse IP, a discharge also occurs between the row electrodes Y and the column electrodes D in the discharge cells PC that are set to the lighting mode. This discharge and the foregoing sustain discharge produce negative wall charges near the row electrodes Y and positive wall charges near the row electrodes X and the column electrodes D in the discharge cells PC. Then, after the application of this sustain pulse IP, the Y electrode driver 53 applies to the row electrodes Y₁ to Yₙ a wall charge adjusting pulse CP having a negative peak potential whose front edge makes a gradual potential transition with a lapse of time as shown in FIG. 10. With the application of this wall charge adjusting pulse CP, a weak erase discharge occurs in the discharge cells PC that have undergone the foregoing sustain discharge, whereby the wall charges formed inside are erased in part. As a result, the wall charges in the discharge cells PC are adjusted to an amount capable of properly producing a selective erase address discharge in the subsequent selective erase address stage W_{D}.

Next, at the selective write address stage W_{D} in each of the subfields SF2 to SF14, the Y electrode driver 53 applies the base pulse BP⁺ having a positive peak potential to each of the row electrodes Y₁ to Yₙ while selectively applying an erase scan pulse SP_{D} having a negative peak potential such as shown in FIG. 30 to each of the row electrodes Y₁ to Yₙ in succession. It should be appreciated that the peak potential of the base pulse BP⁺ is set to a potential capable of avoiding any accidental discharge between the row electrodes X and Y during a period where this selective erase address stage W_{D} is in execution. The X electrode driver 51 also sets each of the row electrodes X₁ to Xₙ to the ground potential (0 volts) during the period when the selective erase address stage W_{D} is in execution. Moreover, at this selective erase address stage W_{D}, the address driver 55 initially converts pixel drive data bits corresponding to that subfield SF into pixel data pulses DP according to their logic levels. For example, if a pixel drive data bit of logic level 1 for shifting a discharge cell PC from the lighting mode to the extinction mode is supplied, the address driver 55 converts this into a pixel data pulse DP having a positive peak potential. If a pixel drive data bit of logic level 0 for maintaining a discharge cell PC in its present state is supplied, on the other hand, it converts this into a pixel data pulse DP of low voltage (0 volts). The address driver 55 then applies these pixel data pulses DP to the column electrodes D₁ to Dₘ in units of a single display line (m pulses) in synchronization with the timing of application of each erase scan pulse SP_{D}. Here, simultaneously with the erase scan pulse SP_{D}, a selective erase address discharge occurs between the column electrodes D and the row electrodes Y in discharge cells PC to which the pixel data pulses DP of high voltage are applied. By this selective erase address discharge, these discharge cells PC are set into the state where positive wall charges are formed near the row electrodes Y and X, and negative wall charges are formed near the column electrodes D, i.e., into the extinction mode. In discharge cells PC to which pixel data pulses DP of low voltage (0 volts) are applied, on the other hand, the foregoing selective erase address discharge will not occur between the column electrodes D and the row electrodes Y simultaneously with the foregoing erase scan pulse SP_{D}. These discharge cells PC therefore maintain their immediately preceding states (lighting mode or extinction mode).

Next, at the sustain stage I in each of the subfields SF2 to SF14, the X electrode driver 51 and the Y electrode driver 53 apply a sustain pulse IP having a positive peak potential V_{SUS} to the row electrodes X₁ to Xₙ and Y₁ to Yₙ repeatedly as many times (an even-number of times) as corresponding to the brightness weight of that subfield, taking turns to the row electrodes X and Y alternately as shown in FIG. 30. Each time this sustain pulse IP is applied, a sustain discharge occurs between the row electrodes X and Y in the discharge cells PC that are set to the lighting mode. The light emitted from the phosphor layer 17 in response to this sustain discharge is emitted outside through the front transparent substrate 10, thereby performing as many times of display light emission as corresponding to the brightness weight of that subfield SF. Here, in the discharge cells PC that have undergone a sustain discharge corresponding to the last sustain pulse IP applied at the sustain stage I of each of the subfields SF2 to SF14, negative wall charges are formed near the row electrodes Y and positive wall charges are formed near the row electrodes X and the column electrodes D. Then, after the application of the last sustain pulse IP, the Y electrode driver 53 applies to the row electrodes Y₁ to Yₙ a wall charge adjusting pulse CP having a negative peak potential whose front edge makes a gradual potential transition with a lapse of time as shown in FIG. 30. With the application of this wall charge adjusting pulse CP, a weak erase discharge occurs in the discharge cells PC that have undergone the foregoing sustain discharge, whereby the wall charges formed inside are erased in part. As a result, the wall charges in the discharge cells PC are adjusted to an amount capable of properly producing a selective erase address discharge in the subsequent selective erase address stage W_{D}.

Then, at the end of the last subfield SF14, the Y electrode driver 53 applies an erase pulse EP having a negative peak potential to all the row electrodes Y₁ to Yₙ. With the application of this erase pulse EP, an erase discharge occurs only in the discharge cells PC that are in the lighting mode. By this erase discharge, the discharge cells PC in the lighting mode are brought into the extinction mode.

The foregoing driving is performed based on 15 possible values of pixel drive data GD such as shown in FIG. 6. According to this driving, as shown in FIG. 6, a write address discharge (indicated by a double circle) initially occurs in each discharge cell PC in the first subfield SF1, thereby setting this discharge cell PC into the lighting mode, except when expressing brightness level 0 (first tone level). Subsequently, a selective erase address discharge (indicated by a black circle) occurs selectively at the selective erase address stage W_{D} of any one of the subfields SF2 to SF14, and the discharge cell PC is set into the extinction mode. In other words, each discharge cell PC is set to the lighting mode in as many consecutive subfields as corresponding to its intermediate brightness to express, and repeats light emission (indicated by a white circle) resulting from a sustain discharge as many times as the numbers assigned to these respective subfields. Here, what is visualized is the brightness corresponding to the total number of sustain discharges created within a single field (or single frame) display period. Consequently, according to the 15 types of emission patterns corresponding to the first to fifteenth levels of driving such as shown in FIG. 6, 15 grayscale levels of intermediate brightness are expressed corresponding to the total numbers of sustain discharges created in the respective subfields that are indicated by the white circles.

This driving precludes areas of inverted emission patterns (lighting state, extinction state) from concurrently appearing on a single screen within a single field display period, thereby avoiding false contours which tend to occur in these states.

Furthermore, according to this driving, the reset discharge intended to initialize all the discharge cells PC into the extinction mode is created in the first subfield SF1 before a selective write address discharge intended to shift the discharge cells PC in this extinction mode into the lighting mode is created. Then, in this driving which employs the selective erase address method, a selective erase address discharge intended to shift the discharge cells PC in the lighting mode into the extinction mode is created in any one of the subfields SF2 to SF14 subsequent to SF1. Thus, when displaying black (brightness level 0) by this driving, the discharges to be created within a single field display period are only the reset discharge in the first subfield SF1. In other words, the number of discharges to be created throughout a unit display period decreases as compared to the cases of performing driving such that a reset discharge for initializing all the display cells PC into the lighting mode is created in the first subfield SF1 and then a selective erase address discharge for shifting them into the extinction mode is created. Consequently, this driving allows an improvement to the contrast when displaying dark images, i.e., so-called dark contrast.

In addition, the PDP 50 employs the structure that contain CL emission MgO crystals are contained both in the magnesium oxide layer 13 and the phosphor layer 17 as shown in FIGS. 22 and 3 to 5. This reduces the discharge delay time significantly and weaken the discharges. Since weaker reset discharges can be created with reliability, it is possible to suppress light emission ascribable to the reset discharges which do not contribute to display images, thereby improving the image contrast or the dark contrast when displaying dark images in particular.

Here, in the plasma display apparatus shown in FIG. 28, the PDP 50 is driven by performing driving according to [still image mode] such as described above if the image shown by the input video signal is a still image. If the image shown by the input video signal is a moving image, on the other hand, driving according to [moving image mode] such as shown in FIG. 31 is performed.

Note that in [moving image mode], the various types of drive pulses (RP_{X}, RP_{Y1}, RP_{Y2}, DP, BP⁺, BP⁻, SP_{W}, IP, CP, SP_{D}, and EP) to be applied at the reset stage R, the selective write address stage W_{W}, the sustain stages I, the selective erase address stages W_{D}, and the erase stage E, and the operations to be made in response to the application of those drive pulses are the same as in [still image mode] shown in FIG. 30.

In [moving image mode], however, the reset pulses RP_{Y1} and RP_{Y2} have respective different waveforms than in [still image mode].

More specifically, as shown in FIG. 31, [moving image mode] employs:

(1) For the positive peak potential of the reset pulse RP_{Y1}, a potential VG_{RY1} higher than the potential V_{RY1};

(2) For the negative peak potential of the reset pulse RP_{Y1}, a potential (−VG_{RY2}) lower than the potential (−V_{RY2});

(3) For the pulse width of the reset pulse RP_{Y1}, a pulse width WG1 greater than the pulse width W1; and

(4) For the pulse width of the reset pulse RP_{Y2}, a pulse width WG2 greater than the pulse width W2;

Any one of the foregoing (1) to (4) may be employed, or at least two of the foregoing (1) to (4) in combination.

That is,.in [moving image mode], the positive peak potential of the reset pulse RP_{Y1} is set to the potential VG_{RY1}, which is higher than the potential V_{RY1} in [still image mode], in the first half of the reset stage R. This makes the voltage applied to between the row electrodes X and Y higher than in [still image mode]. In the first half of the reset stage R in [moving image mode], the pulse width of the reset pulse RP_{Y1} is also set to the pulse width WG1 which is greater than the pulse width W1 in [still image mode]. Such a control on the peak potential or pulse width makes it easier for a column side cathode discharge to occur between the row electrodes Y and the column electrodes D. The higher the voltage (field intensity) to be applied to between the row electrodes X and Y is, the easier this column side cathode discharge is to occur as induced by the electric field. Since an excessive increase in this voltage can create an accidental discharge between the row electrodes X and Y, a voltage that will not produce this accidental discharge is applied.

Moreover, in the second half of the reset stage R in [moving image mode], the negative peak potential of the reset pulse RP_{Y2} is set to the potential (−VG_{RY2}) which is lower than the potential (−V_{RY2}) in [still image mode]. This makes the voltages applied to between the row electrodes X and Y and between the row electrodes Y and the column electrodes D higher than in [still image mode]. In the second half of the reset stage R in [moving image mode], the pulse width of the reset pulse RP_{Y2} is also set to the pulse width WG2 that is greater than the pulse width W2 in [still image mode]. Such a control on the peak potential or pulse width makes it easier for a discharge to occur between the row electrodes X and Y and between the row electrodes Y and the column electrodes D.

As above, in [moving image mode], the voltages and/or the pulse widths to be applied to between the electrodes through the application of the respective drive pulses are made higher or greater than in [still image mode], so that discharges can occur more easily in each discharge cell than when performing [still image mode].

That is, when displaying a still image, discharge cells that undergo a sustain discharge within a single field display period have also created a sustain discharge in the previous field. Consequently, charged particles created by the sustain discharges in the previous field always remain in these discharge cells, which results in a state where address discharges can occur easily. Then, when displaying a still image, the voltages to be applied to between the row electrodes X and Y and between the row electrodes Y and the column electrodes D, intended to create a reset discharge, are lowered and the application time is reduced to weaken the reset discharge. That is, since the charged particles are generated in every field when displaying a still image as described above, it is possible to create a weak reset discharge with reliability even if the voltages to be applied to between the row electrodes X and Y and between the row electrodes Y and the column electrodes D are lowered and the application time is reduced. As a result, this weakened reset discharge improves the dark contrast. In particular, since the PDP 50 which contains CL emission MgO crystals in its phosphor layer has smaller discharge delays and higher discharge probabilities as compared to conventional PDPs, the dark contrast is improved further when displaying a still image.

When displaying a moving image, on the other hand, sustain discharges occurring in the present field do not necessarily mean that sustain discharges have occurred in the previous field. Since the formation of charged particles in the previous field cannot be expected, address discharges might fail to be created with reliability in the present field. Then, when displaying a moving image, the voltages to be applied to between the row electrodes X and Y and between the row electrodes Y and the column electrodes D, intended to create a reset discharge, are raised and the application time is increased so that a reset discharge of higher intensity occurs to produce a greater amount of charged particles in the discharge cells. Even if no sustain discharge has occurred in the previous field, it is therefore possible to create an address discharge with reliability in the next field.

Note that when the image mode signal supplied from the drive control circuit 56 shifts from [moving image mode] to [still image mode], the panel driver lowers the positive peak potential of the reset pulse RP_{Y1} into the state of the potential V_{RY1} over a plurality of fields gradually, not switching it from the state of the potential VG_{RY1} shown in FIG. 31 to the state of the potential V_{RY1} shown in FIG. 30 immediately. This can prevent the brightness corresponding to black display from dropping abruptly, thereby providing display without a feeling of strangeness. When the image mode signal supplied from the drive control circuit 56 shifts from [still image mode] to [moving image mode], on the other hand, the panel driver switches the positive peak potential of the reset pulse RP_{Y1} from the state of the potential V_{RY1} shown in FIG. 30 to the state of the potential VG_{RY1} shown in FIG. 31 immediately. That is, the state capable of creating address discharges with reliability is entered immediately in order to avoid erroneous display due to address discharge failures.

Here, the plasma display apparatus shown in FIG. 28 is provided with mode-specific power supplies corresponding to the peak potentials of the drive pulses in [moving image mode] and [still image mode] for the sake of changing the peak potentials of the drive pulses therebetween. For example, a first power supply for generating the potential V_{RY1} intended for [still image mode] and a second power supply for generating the potential VG_{RY1} intended for [moving image mode] are provided as the power supplies for generating the positive peak potential of the reset pulse RP_{Y1}. Here, the Y electrode driver 53 generates the peak potential of the reset pulse RP_{Y1} by selectively using the potential VG_{RY1} generated by the second power supply when in [moving image mode], and the potential V_{RY1} generated by the first power supply when in [still image mode].

Nevertheless, this reset pulse RP_{Y1} may be generated by using the second power supply alone out of the foregoing first and second power supplies, in which case the rising period of the reset pulse RP_{Y1} is controlled so as to generate the reset pulse RP_{Y1} not only with the positive peak potential VG_{RY1} for [moving image mode] but also with the positive peak potential V_{RY1} for [still image mode].

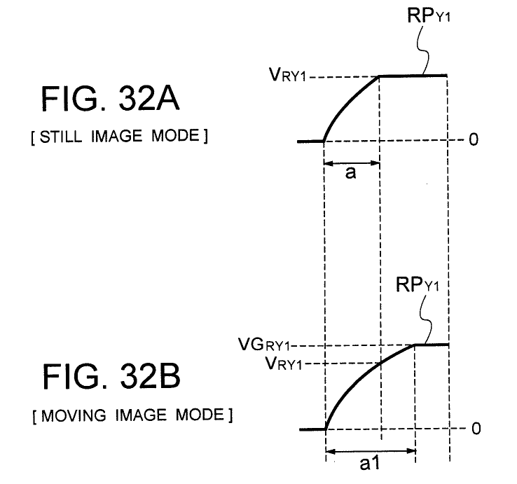

For example, in [still image mode], the Y electrode driver 53 applies the potential VG_{RY1} generated by the second power supply to the row electrodes Y for such a period a as shown in FIG. 32A. This charges up the parasitic load capacitances between the row electrodes X and Y of the PDP 50, and the row electrodes Y gradually increase in potential from the state of 0 volts with a lapse of time as shown in FIG. 32A. Here, the row electrodes Y reach the potential V_{RY1} at the point when the period a has elapsed from the start of this potential increase. The Y electrode driver 53 sets the row electrodes Y into a state of high impedance when this period a has elapsed. Consequently, the row electrodes Y remain in their states of potential at the point when the foregoing period a has elapsed, which results in the positive peak potential V_{RY1} of the reset pulse RP_{Y1} in [still image mode] such as shown in FIG. 32A.

In [moving image mode], the Y electrode driver 53 applies the potential VG_{RY1} generated by the second power supply to the row electrodes Y for a period a1 which is longer than the foregoing period a, such as shown in FIG. 32B. This charges up the parasitic load capacitances between the row electrodes X and Y of the PDP 50, and the row electrodes Y gradually increase in potential from the state of 0 volts with a lapse of time as shown in FIG. 32B. Here, the row electrodes Y reach the potential VG_{RY1} at the point when the period a1 has elapsed from the start of this potential increase. The Y electrode driver 53 sets the row electrodes Y into the state of high impedance when this period a1 has elapsed. Consequently, the row electrodes Y remain in their states of potential at the point when the foregoing period a1 has elapsed, which results in the positive peak potential VG_{RY1} of the reset pulse RP_{Y1} in [moving image mode] such as shown in FIG. 32B.

The foregoing reset pulse RP_{Y1} is not limited to such waveforms as shown in FIGS. 26 and 27. For example, the gradient of the voltage transition may vary gradually with a lapse of time as shown in FIG. 23. Moreover, while the reset discharges at the reset stages R shown in FIGS. 26 and 27 are created in all the discharge cells simultaneously, reset discharges may be created in a temporally distributed fashion in units of discharge cell blocks each consisting of a plurality of discharge cells.

In the present embodiment, as shown in FIG. 5, the MgO crystals are contained in the phosphor layer 17 which is formed on the rear substrate 14 of the PDP 50. Nevertheless, as shown in FIG. 14, the phosphor layer 17 may be formed by laminating a phosphor particle layer 17a which is made of phosphor particles, and a secondary electron emitting layer 18 which is made of a secondary electron emitting material. Here, the secondary electron emitting layer 18 may be formed by spreading crystals of secondary electron emitting material (for example, MgO crystals that contain CL emission MgO crystals) or by depositing a thin film of secondary electron emitting material over the surface of the phosphor particle layer 17a.

### Embodiment 4

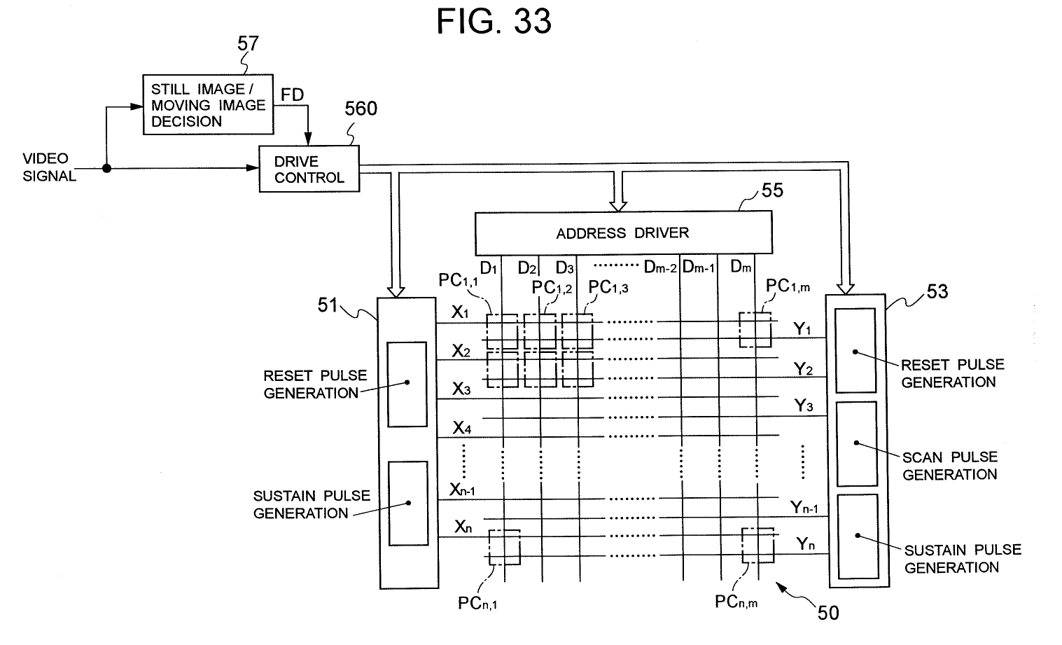

FIG. 33 is a diagram showing another configuration of the plasma display apparatus according to the present invention.

It should be appreciated that the PDP 50 of the plasma display apparatus shown in FIG. 33 is the same as the PDP 50 of the plasma display apparatus shown in FIG. 28, having such a structure as shown in FIGS. 25, 3 to 5, and 14. The X electrode driver 51, the Y electrode driver 53, the address driver 55, and the still image/moving image decision circuit 57 of the plasma display apparatus shown in FIG. 33 also make the same operations as shown in FIG. 28 each. Nevertheless, the method for driving the PDP 50 to be performed by a drive control circuit 560, the X electrode driver 51, the Y electrode driver 53, and the address driver 55 is different from that of the plasma display apparatus shown in FIG. 28.

The drive control circuit 560 shown in FIG. 33 initially converts the input video signal into eight bits of pixel data for expressing all possible brightness levels in 256 grayscale levels pixel by pixel, and applies multi-grayscale processing consisting of error diffusion processing and dithering to this pixel data. This multi-grayscale processing is the same as that performed by the drive control circuit 56 such as described above. In other words, the drive control circuit 560 obtains, through this multi-grayscale processing, 4-bit multi-grayscale pixel data PDs which expresses the entire brightness range in 15 levels of sections. The drive control circuit 560 then converts this multi-grayscale pixel data PDs into 14 bits of pixel drive data GD according to a data conversion table such as shown in FIG. 16.

The drive control circuit 560 associates the first to fourteenth bits of this pixel drive data GD with subfields SF1 to SF14, respectively, and supplies bit digits corresponding to the subfields SF to the address driver 55 as pixel drive data bits in units of a single display line (m pieces).

The drive control circuit 560 also supplies various types of control signals for driving the PDP 50 of the foregoing structure in accordance with an emission drive sequence such as shown in FIG. 17, to each of the X electrode driver 51, the Y electrode driver 53, and the address driver 55. More specifically, in the first subfield SF1 within a single field (single frame) display period, the drive control circuit 560 supplies the panel driver with various types of control signals for performing driving in accordance with a first reset stage R1, a first selective write address stage W1_{W}, and a weak light emission stage LL in succession. In the subfield SF2 subsequent to this SF1, it supplies the panel driver with various types of control signals for performing driving in accordance with a second reset stage R2, a second selective write address stage W2_{W}, and a sustain stage I in succession. Moreover, in each of the subfields SF3 to SF14, it supplies the panel driver with various types of control signals for performing driving in accordance with a selective erase address stage W_{D} and a sustain stage I in succession. It should be appreciated that the drive control circuit 560 supplies the panel driver with various types of control signals for performing driving in accordance with an erase stage E after the execution of the sustain stage I in succession, only in the last subfield SF14 in the single field display period.

Furthermore, the drive control circuit 560 acquires a still image/moving image decision signal FD supplied from the still image/moving image decision circuit 57 in each unit display period, and supplies the panel driver with an image mode signal that indicates [still image mode] if the decision result indicated by this still image/moving image decision signal FD shows a still image, and [moving image mode] if a moving image.

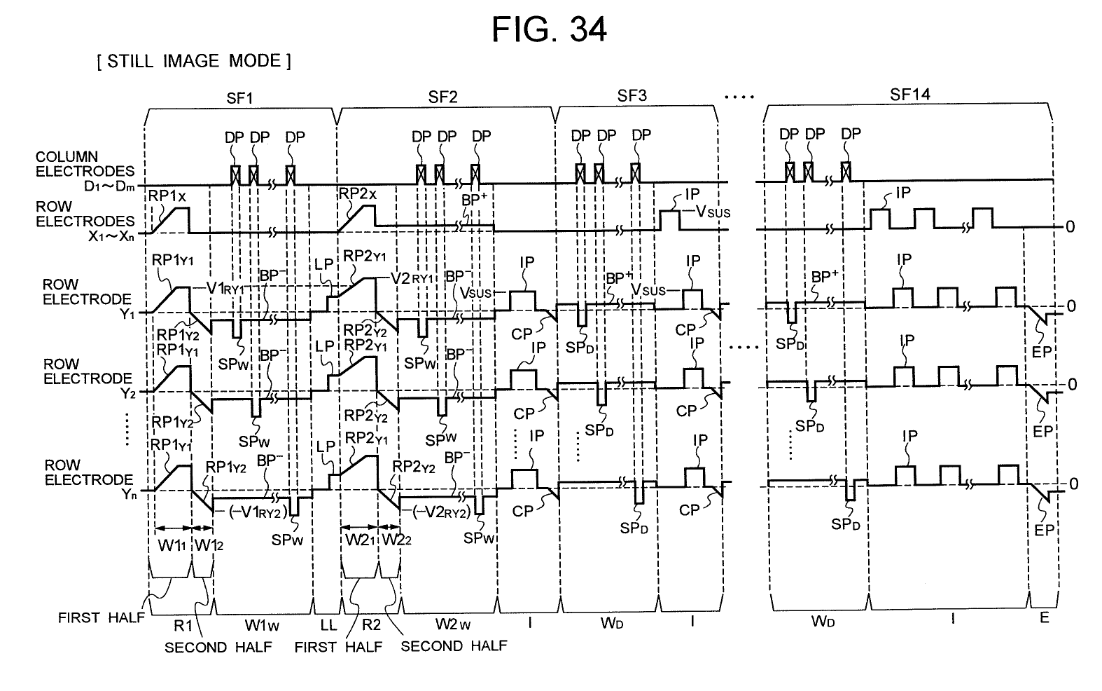

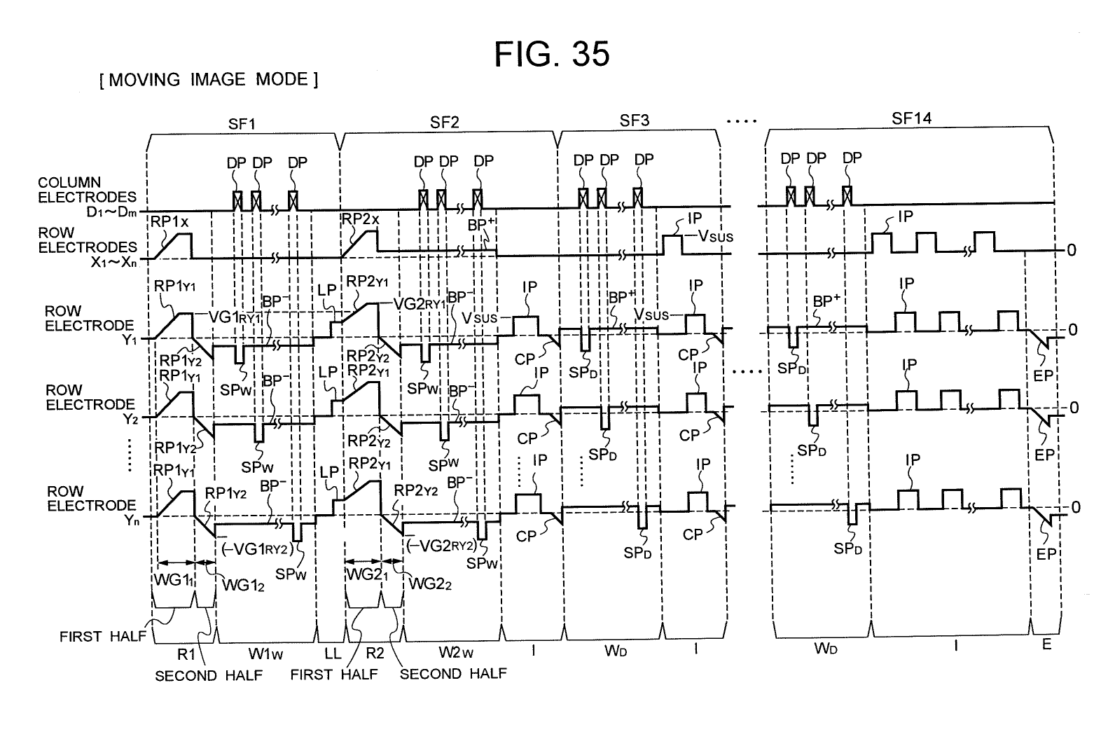

The panel driver (the X electrode driver 51, the Y electrode driver 53, and the address driver 55) supplies various types of drive pulses to the column electrodes D and the row electrodes X and Y of the PDP 50 as shown in FIG. 34 if the image mode signal supplied from the drive control circuit 560 indicates [still image mode], and as shown in FIG. 35 if [moving image mode]. FIGS. 30 and 31 selectively show the operations only in the first subfield SF1, the next subfield SF2, and the last subfield SF14 out of the subfields SF1 to SF14 shown in FIG. 17.

Here, the operations to be performed by the application of the various drive pulses are common between [still image mode] shown in FIG. 34 and [moving image mode] shown in FIG. 35.

A description will thus be given of the operations for applying the various types of drive pulses and the operations performed by the application of the drive pulses, taking the case of [still image mode] shown in FIG. 34 as an example.

In the first half of the first reset stage R1 in the subfield SF1, the Y electrode driver 53 initially applies to all the row electrodes Y₁ to Yₙ a reset pulse RP1_{Y1} which has such a waveform that its front edge makes a gradual potential transition with a lapse of time as compared to the sustain pulse, with a pulse width of W1₁. As shown in FIG. 34, the positive peak potential V1_{RY1} of the reset pulse RP1_{Y1} is lower than or equal to the positive peak potential V_{SUS} of the sustain pulse IP to be described later. In the meantime, the address driver 55 sets the column electrodes D₁ to Dₘ into the state of the ground potential (0 volt). The application of the foregoing reset pulse RP1_{Y1} creates a first reset discharge between the row electrodes Y and the column electrodes D in all the discharge cells PC individually. That is, in the first half of the first reset stage R1, voltages are applied to between the electrodes with the row electrodes Y as anodes and the column electrodes D as cathodes, so that a column side cathode discharge of passing a current from the row electrodes Y to the column electrodes D occurs as the first reset discharge. In response to this first reset discharge, negative wall charges are formed near the row electrodes Y and positive wall charges are formed near the column electrodes D in all the discharge cells PC.

In the first half of the first reset stage R1, the X electrode driver 51 also applies a reset pulse RP1_{X}, which has the same polarity as that of the reset pulse RP1_{Y1} and has a positive peak potential capable of avoiding a surface discharge between the row electrodes X and Y due to the application of this reset pulse RP1_{Y1}, to all the row electrodes X₁ to Xₙ individually.

Next, in the second half of the first reset stage R1, the Y electrode driver 53 generates a reset pulse RP1_{Y2} which has such a pulse waveform that its potential gradually decreases with a lapse of time until it reaches a negative peak potential (−V1_{RY2}) as shown in FIG. 34, with a pulse width of W1₂, and applies this to all the row electrodes Y₁ to Yₙ. Here, the application of this reset pulse RP1_{Y2} creates a second reset discharge between the row electrodes X and Y in all the discharge cells PC. Note that the negative peak potential (−V1_{RY2}) of the reset pulse RP1_{Y2} is a minimum potential that can produce the foregoing second reset discharge between the row electrodes X and Y with reliability, in consideration of the wall charges that are formed near the respective row electrodes X and Y in response to the foregoing first reset discharge. The peak potential (−V1_{RY2}) of the reset pulse RP_{Y2} is also set to a potential higher than the negative peak potential of a write scan pulse SP_{W} to be described later, or equivalently, a potential closer to zero volts. The reason is that if the negative peak potential (−V1_{RY2}) of the reset pulse RP1_{Y2} is set to be lower than the negative peak potential of the write scan pulse SP_{W}, a strong discharge can occur between the row electrodes Y and the column electrodes D. This might erase much of the wall charges formed near the column electrodes D, making an address discharge in a first selective write address stage W1_{W} to be described later unstable. The second reset discharge created in the second half of the first reset stage R1 erases the wall charges formed near the row electrodes X and Y in each discharge cell PC, whereby all the discharge cells PC are initialized into the extinction mode. In addition, the application of the foregoing reset pulse RP1_{Y2} also creates a weak discharge between the row electrodes Y and the column electrodes D in all the discharge cells PC. This discharge erases part of the positive wall charges formed near the column electrodes D, thereby adjusting them to an amount capable of properly producing a selective write address discharge at the first selective write address stage W1_{W}.

Next, at the first selective write address stage W1_{W} in the subfield SF1, the Y electrode driver 53 applies a base pulse BP⁻ having such a negative peak potential as shown in FIG. 34 to the row electrodes Y₁ to Yₙ at the same time while selectively applying a write scan pulse SP_{W} having a negative peak potential to each of the row electrodes Y₁ to Yₙ in succession. In the meantime, the X electrode driver 51 applies a voltage of 0 volts to each of the row electrodes X₁ to Xₙ. Moreover, at the first selective write address stage W1_{W}, the address driver 55 generates pixel data pulses DP according to the logic levels of the pixel drive data bits corresponding to the subfield SF1. For example, if a pixel drive data bit of logic level 1 for setting a discharge cell PC to the lighting mode is supplied, the address driver 55 generates a pixel data pulse DP having a positive peak potential. For a pixel drive data bit of logic level 0 for setting a discharge cell PC to the extinction mode, on the other hand, it generates a pixel data pulse DP of low voltage (0 volts). The address driver 55 then applies these pixel data pulses DP to the column electrodes D₁ to Dₘ in units of a single display line (m pulses) in synchronization with the timing of application of each write scan pulse SP_{W}. Here, simultaneously with the write scan pulse SP_{W}, a selective write address discharge occurs between the column electrodes D and the row electrodes Y in discharge cells PC to which pixel data pulses DP of high voltage for setting to the lighting mode are applied. By this selective write address discharge, these discharge cells PC are set into the state where positive wall charges are formed near the row electrodes Y and negative wall charges are formed near the column electrodes D, i.e., into the lighting mode. In discharge cells PC to which pixel data pulses DP of low voltage (0 volts) for setting to the extinction mode are applied, on the other hand, the foregoing selective write address discharge will not occur between the column electrodes D and the row electrodes Y simultaneously with the foregoing erase scan pulse SP_{D}. Consequently, these discharge cells PC maintain their immediately preceding state, i.e., the extinction mode into which they are initialized at the first reset stage R1.

Next, at the weak light emission stage LL in the subfield SF1, the Y electrode driver 53 applies a weak light emission pulse LP, which has a predetermined positive peak potential such as shown in FIG. 34, to the row electrodes Y₁ to Yₙ simultaneously. With the application of this weak light emission pulse LP, a discharge (hereinafter, referred to as weak light emission discharge) occurs between the column electrodes D and the row electrodes Y in the discharge cells PC that are set to the lighting mode. That is, at the weak light emission stage LL, the row electrodes Y are subjected to a potential that can create a discharge between the row electrodes Y and the column electrodes D but not between the row electrodes X and Y in the discharge cells PC, so that a weak light emission discharge occurs only between the column electrodes D and the row electrodes Y in the discharge cells PC that are set to the lighting mode. Here, the weak light emission pulse LP has a positive peak potential lower than the peak potential of the sustain pulse IP which is applied in the subfields SF2 and later to be described below. As shown in FIG. 34, the rate of change of potential of the weak light emission pulse LP with a lapse of time in its rising interval is higher than those of the reset pulses (RP1_{Y1}, RP2_{Y1}) in their rising intervals. In other words, the potential transition at the front edge of the weak light emission pulse LP is made steeper than the potential transitions at the front edges of the reset pulses, thereby creating a discharge stronger than the first reset discharge which occurs at the first reset stages R1. This discharge is a column side cathode discharge such as described previously, and is created by the weak light emission pulse LP which has a peak potential lower than that of the sustain pulse IP. The emission brightness resulting from the discharge is thus lower than that of the sustain discharge occurring between the row electrodes X and Y. That is, at the weak light emission stage LL, a discharge that is accompanied with light emission of higher brightness level than that of the first reset discharge and lower than that of the sustain discharge, i.e., a discharge that is accompanied with as weak light emission as is available for display purposes is created as the weak light emission discharge. At the first selective write address stage W1_{W} which is performed immediately before the weak light emission stage LL, a selective write address discharge is created between the column electrodes D and the row electrodes Y in the discharge cells PC. Consequently, in the subfield SF1, brightness corresponding to a tone level one higher than the brightness level 0 is expressed by the light emission resulting from this selective write address discharge and the light emission resulting from the weak light emission discharge.

After the foregoing weak light emission discharge, negative wall charges are formed near the row electrodes Y and positive wall charges are formed near the column electrodes D.

Next, in the first half of the second reset stage R2 in the subfield SF2, the Y electrode driver 53 applies to all the row electrodes Y₁ to Yₙ a positive reset pulse RP2_{Y1} which has such a waveform that its front edge makes a gradual potential transition with a lapse of time as compared to the sustain pulse IP to be described later, with a positive peak potential of V2RY₁ and a pulse width of W2₁. As shown in FIG. 34, the positive peak potential V2RY₁ of the reset pulse RP2_{Y1} is lower than or equal to the positive peak potential V_{SUS} of the sustain pulse IP. In the meantime, the address driver 55 sets the column electrodes D₁ to Dₘ into the state of the ground potential (0 volts). The X electrode driver 51 applies to each of all the row electrodes X₁ to Xₙ a positive reset pulse RP2_{X} which has a positive peak potential capable of avoiding a surface discharge between the row electrodes X and Y due to the application of the foregoing reset pulse RP2_{Y1}. It should be noted that the positive peak potential of the reset pulse RP2_{X} is lower than or equal to the positive peak potential V_{SUS} of the sustain pulse IP. Here, instead of applying the foregoing reset pulse RP2_{X}, the X electrode driver 51 may set all the row electrodes X₁ to Xₙ to the ground potential (0 volts) unless the row electrodes X and Y create a surface discharge therebetween. In response to the application of the foregoing reset pulse RP2_{Y1}, a first reset discharge which is weaker than the column side cathode discharge at the foregoing weak light emission stage LL occurs between the row electrodes Y and the column electrodes D in discharge cells PC that have not undergone the column side cathode discharge at the weak light emission stage LL. That is, in the first half of the second reset stage R2, voltages are applied to between the electrodes with the row electrodes Y as anodes and the column electrodes D as cathodes, so that a column side cathode discharge of passing a current from the row electrodes Y to the column electrodes D occurs as the first reset discharge. In discharge cells PC that have already undergone the weak light emission discharge at the foregoing weak light emission stage LL, on the other hand, no discharge occurs even when the reset pulse RP2_{Y1} is applied. As a result, immediately after the completion of the first half of the second reset stage R2, negative wall charges are formed near the row electrodes Y and positive wall charges are formed near the column electrodes D in all the discharge cells PC. Then, in the second half of the second reset stage R2 in the subfield SF2, the Y electrode driver 53 applies to the row electrodes Y₁ to Yₙ a reset pulse RP2_{Y2} which has such a pulse waveform that its potential gradually decreases with a lapse of time until it reaches a negative peak potential (−V2_{RY2}) as shown in FIG. 34, with a pulse width of W2₂. In the second half of the second reset stage R2, the X electrode driver 51 also applies a base pulse BP⁺ having a positive peak potential to each of the row electrodes X₁ to Xₙ. Here, the application of these negative reset pulse RP2_{Y2} and positive base pulse BP⁺ creates a second reset discharge between the row electrodes X and Y in all the discharge cells PC. Note that the negative peak potential (−V2_{RY2}) of the reset pulse RP2_{Y2} and the positive peak potential of the base pulse BP⁺ both are minimum potentials that can produce the second reset discharge between the row electrodes X and Y in response to the foregoing first reset discharge with reliability, in consideration of the wall charges that are formed near the row electrodes X and Y. The negative peak potential (−V2_{RY2}) of the reset pulse RP2_{Y2} is also set to a potential higher than the peak potential of the negative write scan pulse SP_{W}, or equivalently, a potential closer to zero volts. The reason is that if the negative peak potential of the reset pulse RP2_{Y2} is set to be lower than the negative peak potential of the write scan pulse SP_{W}, a strong discharge can occur between the row electrodes Y and the column electrodes D. This might erase much of the wall charges formed near the column electrodes D, making an address discharge at the subsequent second selective write address stage W2_{W} unstable.

At the second selective write address stage W2_{W}, the Y electrode driver 53 applies the base pulse BP⁻ having such a negative peak potential as shown in FIG. 34 to the row electrodes Y₁ to Yₙ at the same time while selectively applying a write scan pulse SP_{W} having a negative peak potential to each of the row electrodes Y₁ to Yₙ in succession. In the meantime, the X electrode driver 51 applies the base pulse BP⁺ having a positive peak potential to each of the row electrodes X₁ to Xₙ. Moreover, at the second selective write address stage W2_{W}, the address driver 55 initially generates pixel data pulses DP having peak potentials according to the logic levels of the pixel drive data bits corresponding to the subfield SF2. For example, if a pixel drive data bit of logic level 1 for setting a discharge cell PC to lighting mode is supplied, the address driver 55 generates a pixel data pulse DP having a positive peak potential. For a pixel drive data bit of logic level 0 for setting a discharge cell PC to the extinction mode, on the other hand, it generates a pixel data pulse DP of low voltage (0 volts). The address driver 55 then applies these pixel data pulses DP to the column electrodes D₁ to Dₘ in units of a single display line (m pulses) in synchronization with the timing of application of each write scan pulse SP_{W}. Here, simultaneously with the write scan pulse SP_{W}, a selective write address discharge occurs between the column electrodes D and the row electrodes Y in discharge cells PC to which pixel data pulses DP of high voltage for setting to the lighting mode are applied. Furthermore, immediately after the selective write address discharge, a weak discharge also occurs between the row electrodes X and Y in these discharge cells PC. More specifically, after the application of the write scan pulse SP_{W}, a voltage corresponding to the base pulses BP⁻ and BP⁺ is applied to between the row electrodes X and Y. This voltage is set to be lower than the discharge start voltage of the discharge cells PC. Thus, no discharge will occur in the discharge cells PC by the application of this voltage alone. If the selective write address discharge is created, however, a discharge occurs between the row electrodes X and Y even by means of the voltage application with the base pulses BP⁻ and BP⁺ alone, being induced by this selective write address discharge. By this discharge and the foregoing selective write address discharge, these discharge cells PC are set into a state where positive wall charges are formed near the row electrodes Y, negative wall charges are formed near the row electrodes X, and negative wall charges are formed near the column electrodes D, i.e., into the lighting mode. In discharge cells PC to which pixel data pulses DP of low voltage (0 volts) for setting to the extinction mode are applied, on the other hand, such a selective write address discharge as described above will not occur between the column electrodes D and the row electrodes Y simultaneously with the foregoing write scan pulse SP_{W}. Thus, the row electrodes X and Y will not create any discharge, either. Consequently, these discharge cells PC maintain their immediately preceding state, i.e., the extinction mode into which they are initialized at the second reset stage R2.

Next, at the sustain stage I in the subfield SF2, the Y electrode driver 53 generates a single sustain pulse IP having a positive peak potential V_{SUS}, and applies it to each of the row electrodes Y₁ to Yₙ simultaneously. In the meantime, the X electrode driver 51 sets the row electrodes X₁ to Xₙ into the state of the ground potential (0 volts). The address driver 55 sets the column electrodes D₁ to Dₘ into the state of the ground potential (0 volts). The application of the sustain pulse IP creates a sustain discharge between the row electrodes X and Y in the discharge cells PC that are set to the lighting mode. The light emitted from the phosphor layer 17 in response to this sustain discharge is emitted outside through the front transparent substrate 10, thereby performing a single round of display emission corresponding to the brightness weight of this subfield SF2. With the application of this sustain pulse IP, a discharge also occurs between the row electrodes Y and the column electrodes D in the discharge cells PC that are set to the lighting mode. This discharge and the foregoing sustain discharge produce negative wall charges near the row electrodes Y and positive wall charges near the row electrodes X and the column electrodes D in the discharge cells PC. Then, after the application of this sustain pulse IP, the Y electrode driver 53 applies to the row electrodes Y₁ to Yₙ a wall charge adjusting pulse CP having a negative peak potential whose front edge makes a gradual potential transition with a lapse of time as shown in FIG. 18. With the application of this wall charge adjusting pulse CP, a weak erase discharge occurs in the discharge cells PC that have undergone the foregoing sustain discharge, whereby the wall charges formed inside are erased in part. As a result, the wall charges in the discharge cells PC are adjusted to an amount capable of properly producing a selective erase address discharge in the subsequent selective erase address stage W_{D}.

Next, at the selective erase address stage W_{D} in each of the subfields SF3 to SF14, the Y electrode driver 53 applies the base pulse BP⁺ having a positive potential V_{BP+} to each of the row electrodes Y₁ to Yₙ while selectively applying an erase scan pulse SP_{D} having a negative peak potential such as shown in FIG. 34 to each of the row electrodes Y₁ to Yₙ in succession. It should be noted that the peak potential V_{BP+} of the base pulse BP⁺ is set to a potential capable of avoiding an accidental discharge between the row electrodes X and Y over the period when this selective erase address stage W_{D} is in execution. The X electrode driver 51 also sets each of the row electrodes X₁ to Xₙ to the ground potential (0 volts) during the period when the selective erase address stage W_{D} is in execution. At this selective erase address stage W_{D}, the address driver 55 initially converts pixel drive data bits corresponding to that subfield SF into pixel data pulses DP having peak potentials according to their logic levels. For example, if a pixel drive data bit of logic level 1 for shifting a discharge cell PC from the lighting mode to the extinction mode is supplied, the address driver 55 converts this into a pixel data pulse DP having a positive peak potential. If a pixel drive data bit of logic level 0 for maintaining a discharge cell PC in its present state is supplied, on the other hand, it converts this into a pixel data pulse DP of low voltage (0 volts). The address driver 55 then applies these pixel data pulses DP to the column electrodes D₁ to Dₘ in units of a single display line (m pulses) in synchronization with the timing of application of each erase scan pulse SP_{D}. Here, simultaneously with the erase scan pulse SP_{D}, a selective erase address discharge occurs between the column electrodes D and the row electrodes Y in discharge cells PC to which the pixel data pulses DP of high voltage are applied. By this selective erase address discharge, these discharge cells PC are set into the state where positive wall charges are formed near the row electrodes Y and X, and negative wall charges are formed near the column electrodes D, i.e., into the extinction mode. In discharge cells PC to which pixel data pulses DP of low voltage (0 volts) are applied, on the other hand, the foregoing selective erase address discharge will not occur between the column electrodes D and the row electrodes Y simultaneously with the foregoing erase scan pulse SP_{D}. These discharge cells PC therefore maintain their immediately preceding states (lighting mode or extinction mode).

Next, at the sustain stage I of each of the subfields SF3 to SF14, the X electrode driver 51 and the Y electrode driver 53 apply the sustain pulse IP having a positive peak potential V_{SUS} to the row electrodes Y₁ to Yₙ and X₁ to Xₙ repeatedly as many times as corresponding to the brightness weight of that subfield, taking turns to the row electrodes Y and X alternately as shown in FIG. 34. Each time this sustain pulse IP is applied, a sustain discharge occurs between the row electrodes X and Y in the discharge cells PC that are set to the lighting mode. The light emitted from the phosphor layer 17 in response to this sustain discharge is emitted outside through the front transparent substrate 10, thereby performing as many times of display light emission as corresponding to the brightness weight of that subfield SF. It should be noted that the total number of sustain pulses IP to be applied within each sustain stage I is an even number. That is, in each sustain stage I, the first sustain pulse IP is applied to the row electrodes X and the last sustain pulse IP is applied to the row electrodes Y. As a result, immediately after the completion of each sustain stage I, negative wall charges are formed near the row electrodes Y and positive wall charges are formed near the row electrodes X and the column electrodes D in the discharge cells PC that have undergone the sustain discharges. This brings the wall charges formed in each discharge cell PC into the same condition as immediately after the completion of the first reset discharge.

Then, after the completion of the sustain stage I in the last subfield SF14, the Y electrode driver 53 applies an erase pulse EP having a negative peak potential to all the row electrodes Y₁ to Yₙ. With the application of this erase pulse EP, an erase discharge occurs only in the discharge cells PC that are in the lighting mode. By this erase discharge, the discharge cells PC in the lighting mode are brought into the extinction mode.

The foregoing driving is performed based on 16 possible values of pixel drive data GD such as shown in FIG. 16.

Here, in the plasma display apparatus shown in FIG. 33, the PDP 50 is driven by performing the driving according to [still image mode] described above if the image shown by the input video signal is a still image. If the image shown by the input video signal is a moving image, on the other hand, the driving is performed according to [moving image mode] such as shown in FIG. 35.

Note that in [moving image mode], the various drive pulses (RP1_{X}, RP1_{Y1}, RP1_{Y2}, DP, BP⁻, SP_{W}, LP, BP⁺, RP2_{X}, RP2_{Y1}, RP2_{Y2}, IP, CP, SP_{D}, and EP) to be applied at the reset stages (R1, R2), the selective write address stages (W1_{W}, W2_{W}), the weak light emission stage LL, the sustain stages I, the selective erase address stages W_{D}, and the erase stage E, and the operations to be made in response to the application of those drive pulses are the same as in [still image mode] shown in FIG. 34.

In [moving image mode], however, the reset pulses RP1_{Y1}, RP1_{Y2}, RP2_{Y1}, and RP2_{Y2} have respective different waveforms than in [still image mode].

More specifically, as shown in FIG. 35, [moving image mode] employs:

(1) For the positive peak potential of the reset pulse RP1_{Y1}, a potential VG1_{RY1} higher than the potential V1_{RY1};

(2) For the positive peak potential of the reset pulse RP2_{Y1}, a potential VG2_{RY1} higher than the potential V2_{RY1};

(3) For the negative peak potential of the reset pulse RP1_{Y2}, a potential (−VG1_{RY2}) lower than the potential (−V1_{RY2});

(4) For the negative peak potential of the reset pulse RP2_{Y2}, a potential (−VG2_{RY2}) lower than the potential (−V2_{RY2});

(5) For the pulse width of the reset pulse RP1_{Y1}, a pulse width WG1₁ greater than the pulse width W1₁;

(6) For the pulse width of the reset pulse RP1_{Y2}, a pulse width WG1₂ greater than the pulse width W1₂;

(7) For the pulse width of the reset pulse RP2_{Y1}, a pulse width WG2₁ greater than the pulse width W2₁; and

(8) For the pulse width of the reset pulse RP2_{Y2}, a pulse width WG2₂ greater than the pulse width W2₂.

Any one of the foregoing (1) to (8) may be employed, or at least two of the foregoing (1) to (8) in combination.

That is, in [moving image mode], in the first halves of the reset stages (R1, R2), the positive peak potentials of the reset pulses (RP1_{Y1}, RP2_{Y1}) are set to the potentials (VG1_{RY1}, VG2_{RY1}) which are higher than the potentials (V1_{RY1}, V2_{RY1}) in [still image mode]. This makes the voltages applied to between the row electrodes X and Y higher than in [still image mode]. Besides, in the first halves of the reset stages (R1, R2) in [moving image mode], the pulse widths of the reset pulses (RP1_{Y1}, RP2_{Y1}) are set to the pulse widths (WG1₁, WG2₁) which are greater than the pulse widths (W1₁, W2₁) in [still image mode]. Such a control on the peak potentials or pulse widths makes it easier for a column side cathode discharge to occur between the row electrodes Y and the column electrodes D. The higher the voltage (field intensity) applied between the row electrodes X and Y is, the easier this column side cathode discharge is to occur as induced by the electric field. Since an excessive increase in this voltage can cause an accidental discharge between the row electrodes X and Y, a voltage that will not produce this accidental discharge is applied.

Moreover, in the second halves of the reset stages (R1, R2) in [moving image mode], the negative peak potentials of the reset pulses (RP1_{Y2}, RP2_{Y2}) are set to the potentials (−VG1_{RY2}, −VG2_{RY2}) which are lower than the potentials (−V1_{RY2}, −V2_{RY2}) in [still image mode]. This makes the voltages applied to between the row electrodes X and Y and between the row electrodes Y and the column electrodes D higher than in [still image mode]. Besides, in the second halves of the reset stages (R1, R2) in [moving image mode], the pulse widths of the reset pulses (RP1_{Y2}, RP2_{Y2}) are set to the pulse widths (WG1₂, WG2₂) which are greater than the pulse widths (W1₂, W2₂) in [still image mode]. Such a control on the peak potentials or pulse widths makes it easier for a discharge to occur between the row electrodes X and Y and between the row electrodes Y and the column electrodes D.

As above, in [moving image mode], the voltages and/or the pulse widths to be applied to between the electrodes through the application of the respective drive pulses are made higher or greater than in [still image mode], so that a discharge can occur more easily in each discharge cell than when performing [still image mode].

That is, when displaying a still image, discharge cells that undergo a sustain discharge within a single field display period have also created a sustain discharge in the previous field. Consequently, charged particles created by the sustain discharges in the previous field always remain in these discharge cells, which results in a state where address discharges can occur easily. Then, when displaying a still image, the voltages to be applied to between the row electrodes X and Y and between the row electrodes Y and the column electrodes D, intended to create a reset discharge, are lowered and the application time is reduced to weaken the reset discharge. That is, since the charged particles are generated in every field when displaying a still image as described above, it is possible to create a weak reset discharge with reliability even if the voltages to be applied to between the row electrodes X and Y and between the row electrodes Y and the column electrodes D are lowered and the application time is reduced. As a result, this weakened reset discharge improves the dark contrast. In particular, since the PDP 50 which contains CL emission MgO crystals in its phosphor layer has smaller discharge delays and higher discharge probabilities as compared to conventional PDPs, the dark contrast is improved further when displaying a still image.

When displaying a moving image, on the other hand, sustain discharges occurring in the present field do not necessarily mean that sustain discharges have occurred in the previous field. Since the formation of charged particles in the previous field cannot be expected, address discharges might fail to be created with reliability in the present field. Then, when displaying a moving image, the voltages to be applied to between the row electrodes X and Y and between the row electrodes Y and the column electrodes D, intended to create a reset discharge, are raised and the application time is increased so that a reset discharge of higher intensity occurs to produce a greater amount of charged particles in the discharge cells. Even if no sustain discharge has occurred in the previous field, it is therefore possible to create an address discharge with reliability in the next field.

Note that when the image mode signal supplied from the drive control circuit 560 shifts from [moving image mode] to [still image mode], the panel driver lowers the positive peak potentials of the respective reset pulses (RP1_{Y1}, RP1_{Y2}, RP2_{Y1}, RP2_{Y2}) over a plurality of fields gradually, not switching them from such a state as shown in FIG. 35 to such a state as shown in FIG. 34 immediately. This can prevent the brightness corresponding to black display from dropping abruptly, thereby providing display without a feeling of strangeness. When the image mode signal supplied from the drive control circuit 560 shifts from [still image mode] to [moving image model, on the other hand, the panel driver switches the peak potentials of the respective reset pulses from the state shown in FIG. 10 to the state shown in FIG. 35 immediately. That is, the state capable of creating address discharges with reliability is entered immediately in order to avoid erroneous display due to address discharge failures.

Here, in the plasma display apparatus shown in FIG. 33, mode-specific power supplies corresponding to the peak potentials of the drive pulses in [moving image model and [still image mode] are provided in order to generate the respective different peak potentials. For example, a first power supply for generating the potential V1_{RY1} intended for. [still image mode] and a second power supply for generating the potential VG1_{RY1} intended for [moving image mode] are provided as the power supplies for generating the positive peak potential of the reset pulse RP1_{Y1}. Here, the Y electrode driver 53 generates the peak potential of the reset pulse RP1_{Y1} by selectively using the potential VG1_{RY1} generated by the second power supply when in [moving image mode], and the potential V1_{RY1} generated by the first power supply when in [still image mode].

The reset pulse RP1_{Y1} (or RP2_{Y1}) may be generated, however, by using the second power supply alone out of the foregoing first and second power supplies, in which case the rising period of the reset pulse RP1_{Y1} is controlled to generate the positive peak potential VG1_{RY1} (VG2_{RY1}) for [moving image mode], and the positive peak potential V1_{RY1} (V2_{RY1}) for [still image mode] as well.

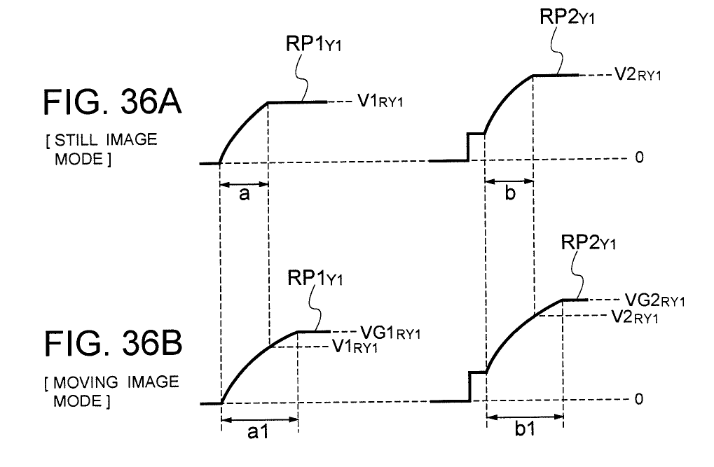

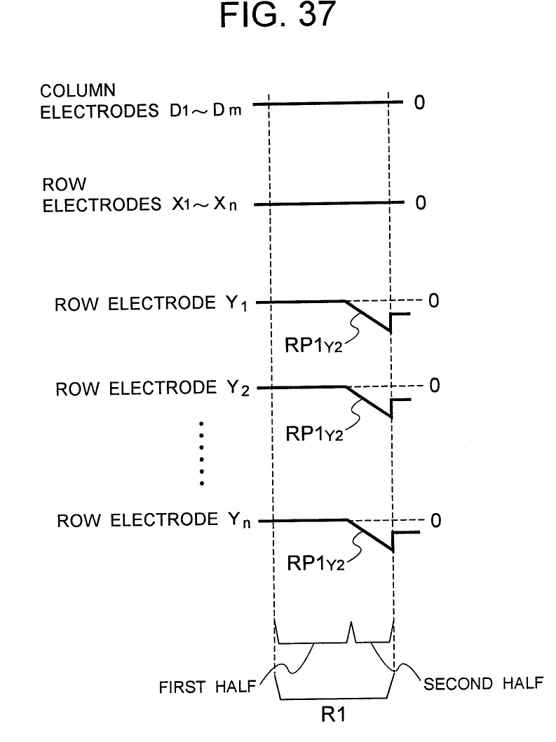

For example, in [still image mode], the Y electrode driver 53 applies the potential VG1_{RY1} (VG2_{RY1}) generated by the second power supply to the row electrodes Y for such a period a (period b) as shown in FIG. 36A. This charges up the parasitic load capacitances between the row electrodes X and Y of the PDP 50, and the row electrodes Y gradually increase in potential from the state of 0 volts with a lapse of time as shown in FIG. 36A. Here, the row electrodes Y reach the potential V1_{RY1} (V2_{RY1}) at the point when the period a (period b) has elapsed from the start of this potential increase. The Y electrode driver 53 sets the row electrodes Y to a state of high impedance when this period a (period b) has elapsed. Consequently, the row electrodes Y maintain their states of potential at the point when the foregoing period a (period b) has elapsed. This results in the positive peak potential V1_{RY1} (V2_{RY1}) of the reset pulse RP1_{Y1} (RP2_{Y1}) in [still image mode] such as shown in FIG. 36A.

In (moving image mode], on the other hand, the Y electrode driver 53 applies the potential VG1_{RY1} (VG2_{RY1}) generated by the second power supply to the row electrodes Y for a period a1 (period b1) which is longer than the foregoing period a (period b), such as shown in FIG. 36B. This charges up the parasitic load capacitances between the row electrodes X and Y of the PDP 50, and the row electrodes Y gradually increase in potential from the state of 0 volts with a lapse of time as shown in FIG. 36B. Here, the row electrodes Y reach the potential VG1_{RY1} (VG2_{RY1}) at the point when the period a1 (period b1) has elapsed from the start of this potential increase. The Y electrode driver 53 sets the row electrodes Y to the state of high impedance when this period a1 (period b1) has elapsed. Consequently, the row electrodes Y maintain their states of potential at the point when the foregoing period al (period b1) has elapsed. This results in the positive peak potential VG1_{RY1} (VG2_{RY1}) of the reset pulse RP1_{Y1} (RP2_{Y1}) in [moving image mode] such as shown in FIG. 36B.

Here, the foregoing reset pulse RP1_{Y1} (RP1_{Y2}) is not limited to such waveforms as shown in FIGS. 30 and 31, but the gradient of the voltage transition may vary gradually with a lapse of time such as shown in FIG. 23.

Moreover, while the reset discharges at the reset stages (R1, R2) shown in FIGS. 30 and 31 are created in all the discharge cells simultaneously, reset discharges may be created in a temporally distributed fashion in units of discharge cell blocks each consisting of a plurality of discharge cells.

At the first reset stages R1 shown in FIGS. 30 and 31, the first reset discharge is created as a column side cathode discharge by applying the reset pulses RP1_{Y1} and RP1_{X} to all the row electrodes X and Y in the first halves thereof. The application of these reset pulses RP1_{Y1} and RP1_{X} may be omitted, however.

For example, a first reset stage R1 such as shown in FIG. 37 is employed instead of the first reset stages R1 shown in FIGS. 30 and 31. As shown in FIG. 37, the row electrodes Y₁ to Yₙ are fixed to the ground potential in the first half of the first reset stage R1. More specifically, in this case, the first half of the first reset stage R1 includes no pulse application at all. The reset pulse RP1_{Y2}, having a negative peak potential of (−V1_{RY2}) when in [still image mode] and (−VG1_{RY2}) when in [moving image mode], is applied to all the row electrodes Y only in the second half.

This application is based on Japanese patent applications Nos. 2007-124099, 2007-128050, and 2008-007234 which are hereby incorporated by reference.

What is claimed is:

1. A method for driving a plasma display panel in accordance with pixel data based on a video signal pixel by pixel, the plasma display panel comprising display cells being formed at respective intersections between a plurality of pairs of row electrodes and a plurality of column electrodes, the display cells having a phosphor layer containing a phosphor material and a secondary electron emitting material, the method comprising:
in a first subfield out of a plurality of subfields into which a unit display period of said video signal is divided, performing a reset stage for maintaining each of said column electrodes to a predetermined potential and applying a reset pulse having a peak potential higher than or equal to the predetermined potential to one row electrodes in the pairs of row electrodes; and
in each of all the subfields, performing an address stage, and a sustain stage for applying a sustain pulse to said pairs of row electrodes, and
wherein said reset pulse has a peak potential lower than or equal to a peak potential of said sustain pulse.

2. The method for driving a plasma display panel according to claim 1, wherein at said reset stage, a potential lower than or equal to the peak potential of said sustain pulse is applied to the other row electrodes in said pairs of row electrodes.

3. The method for driving a plasma display panel according to claim 1, wherein at said reset stage, a voltage to between said one row electrodes and said column electrodes with said one row electrodes as anodes and said column electrodes as cathodes is applied.

4. The method for driving a plasma display panel according to claim 2, wherein a ground potential is applied to the other row electrodes in said pairs of row electrodes.

5. The method for driving a plasma display panel according to claim 3, wherein at said reset stage, a potential for preventing a discharge between the other row electrodes and said one row electrodes in said pairs of row electrodes is applied to said other row electrodes.

6. The method for driving a plasma display panel according to claim 1, wherein in said first subfield, said address stage is followed by a sustain stage for applying a sustain pulse to said one row electrodes alone only once.

7. The method for driving a plasma display panel according to claim 1, wherein said reset stage is performed only in said first subfield out of said subfields within a unit display period.

8. The method for driving a plasma display panel according to claim 1, wherein:
at said reset stage in said first subfield, each of said display cells is initialized into the state of extinction mode;
at said address stage in said first subfield, each of said display cells is set in the state of lighting mode selectively in accordance with said pixel data; and
at said address stage in each of said subfields subsequent to said first subfield, each of said display cells is set in the state of said extinction mode selectively in accordance with said pixel data.

9. The method for driving a plasma display panel according to claim 1, wherein:
at said reset stage in said first subfield, each of said display cells is initialized into the state of extinction mode;
at said address stage in said first subfield, each of said display cells is set in the state of lighting mode selectively in accordance with said pixel data; and
at said address stage in each of said subfields subsequent to said first subfield, each of said display cells is set in the state of said lighting mode selectively in accordance with said pixel data.

10. The method for driving a plasma display panel according to claim 1, wherein at said address stage in said first subfield, a negative base potential is applied to said one row electrodes and a positive base potential is applied to the other row electrodes in said pairs of row electrodes.

11. The method for driving a plasma display panel according to claim 1, wherein said secondary electron emitting material is made of magnesium oxide.

12. The method for driving a plasma display panel according to claim 11, wherein said magnesium oxide contains a magnesium oxide crystal which produces a cathode luminescence emission having a peak within a wavelength band of 200 to 300 nm when excited by an electron beam.

13. The method for driving a plasma display panel according to claim 12, wherein said magnesium oxide crystal is a magnesium oxide single crystal formed by vapor-phase oxidation.

14. The method for driving a plasma display panel according to claim 12, wherein said magnesium oxide crystal has a particle size of 2000 Å or above.

15. The method for driving a plasma display panel according to claim 1, wherein particles made of said secondary electron emitting material are in contact with a discharge gas in a discharge space.

16. A method for driving a plasma display panel in accordance with pixel data based on a video signal pixel by pixel, the plasma display panel comprising display cells being formed at respective intersections between a plurality of pairs of row electrodes and a plurality of column electrodes, the display cells having a phosphor layer containing a phosphor material and a secondary electron emitting material, the method comprising:
both in a first subfield and a second subfield immediately after said first subfield out of a plurality of subfields into which a unit display period of said video signal is divided, successively performing a reset stage for maintaining each of said column electrodes to a predetermined potential and applying a reset pulse having a peak potential higher than or equal to the predetermined potential to one row electrodes in the pairs of row electrodes and an address stage; and
in each of the second and subsequent subfields, performing a sustain stage for applying a sustain pulse to said pairs of row electrodes, and
wherein at least either one of said reset pulse to be applied at said reset stage of said first subfield and said reset pulse to be applied at said reset stage of said second subfield has a peak potential lower than or equal to a peak potential of said sustain pulse.

17. The method for driving a plasma display panel according to claim 16, wherein said reset pulse to be applied at said reset stage in said first subfield and said reset pulse to be applied at said reset stage in said second subfield both have a peak potential lower than or equal to the peak potential of said sustain pulse.

18. The method for driving a plasma display panel according to claim 17, wherein at said reset stage, a potential lower than or equal to the peak potential of said sustain pulse is applied to the other row electrodes in said pairs of row electrodes.

19. The method for driving a plasma display panel according to claim 17, wherein at said reset stage, a voltage to between said one row electrodes and said column electrodes with said one row electrodes as anodes and said column electrodes as cathodes is applied.

20. The method for driving a plasma display panel according to claim 18, wherein a ground potential is applied to the other row electrodes in said pairs of row electrodes.

21. The method for driving a plasma display panel according to claim 19, wherein at said reset stage, a potential for preventing a discharge between the other row electrodes and said one row electrodes in said pairs of row electrodes is applied to said other row electrodes.

22. The method for driving a plasma display panel according to claim 16, wherein:
at said reset stage, said display cells are initialized into the state of extinction mode; and
at said address stage, each of said display cells is set in the state of lighting mode selectively in accordance with said pixel data.

23. The method for driving a plasma display panel according to claim 16, wherein immediately after said address stage of said first subfield, a weak light emission stage is performed by applying a voltage to between said one row electrodes in said pairs of row electrodes and said column electrodes with said one row electrodes as anodes and said column electrodes as cathodes, thereby creating a weak light emission discharge between said column electrodes and said one row electrodes in said display cells that are in the state of lighting mode.

24. The method for driving a plasma display panel according to claim 23, wherein said weak light emission discharge is a discharge accompanied with light emission corresponding to a tone level one brighter than brightness level 0.

25. The method for driving a plasma display panel according to claim 23, wherein a potential to be applied to said one row electrodes in order to create said weak light emission discharge in the weak light emission stage is lower than the peak potential of said sustain pulse.

26. The method for driving a plasma display panel according to claim 16, wherein in said second subfield, said address stage is immediately followed by a sustain stage for applying a sustain pulse to said one row electrodes alone only once.

27. The method for driving a plasma display panel according to claim 16, wherein at said address stage in each of said subfields subsequent to said second subfield, each of said display cells is set in the state of extinction mode selectively in accordance with said pixel data.

28. The method for driving a plasma display panel according to claim 16, wherein at said address stage in each of said subfields subsequent to said second subfield, each of said display cells is set in the state of said lighting mode selectively in accordance with said pixel data.

29. The method for driving a plasma display panel according to claim 16, wherein said secondary electron emitting material is made of magnesium oxide.

30. The method for driving a plasma display panel according to claim 29, wherein said magnesium oxide contains a magnesium oxide crystal which produces a cathode luminescence emission having a peak within a wavelength band of 200 to 300 nm when excited by an electron beam.

31. The method for driving a plasma display panel according to claim 30, wherein said magnesium oxide crystal is formed by vapor-phase oxidation.

32. The method for driving a plasma display panel according to claim 30, wherein said magnesium oxide crystal has a particle size of 2000 Å or above.

33. The method for driving a plasma display panel according to claim 16, wherein particles made of said secondary electron emitting material are in contact with a discharge gas in a discharge space.

34. A method for driving a plasma display panel in accordance with pixel data based on a video signal pixel by pixel, the plasma display panel comprising display cells being formed at respective intersections between a plurality of pairs of row electrodes and a plurality of column electrodes, the method comprising:
in a first subfield out of a plurality of subfields into which a unit display period of said video signal is divided, successively performing a first reset stage for maintaining each of said column electrodes to a predetermined potential and applying a reset pulse having a peak potential higher than or equal to the predetermined potential to one row electrodes in the pairs of row electrodes, thereby said display cells are each initialized into a state of extinction mode, an address stage for setting each of said display cells in a state of lighting mode selectively in accordance with said pixel data, and a weak light emission stage of creating a weak light emission discharge in said display cells that are in the state of said lighting mode; and
in each of said subfields subsequent to said first subfield, performing a sustain stage for applying a sustain pulse to said pairs of row electrodes, and
wherein: said reset pulse has a peak potential lower than or equal to a peak potential of said sustain pulse; and
at said weak light emission stage, a voltage is applied to between the one row electrodes in said pairs of row electrodes and said column electrodes with said one row electrodes as anodes and said column electrodes as cathodes, thereby creating said weak light emission discharge between said column electrodes and said one row electrodes in said display cells that are in the state of said lighting mode.

35. The method for driving a plasma display panel according to claim 34, wherein
the second subfield immediately after said first subfield includes successively performing:
a second reset stage for maintaining each of said column electrodes to a predetermined potential and applying a reset pulse having a peak potential higher than or equal to the predetermined potential and lower than or equal to the peak potential of said sustain pulse to one row electrodes in said pairs of row electrodes, thereby said display cells are each initialized into the state of said extinction mode; and a second address stage for setting each of said display cells in the state of said lighting mode selectively in accordance with said pixel data.

36. The method for driving a plasma display panel according to claim 1, wherein said initialization is performed by applying a first reset pulse having a positive peak potential to said one row electrodes in a first half, and applying a second reset pulse having a negative peak potential to said one row electrodes in a second half at the first and second halves of said reset stage.

37. The method for driving a plasma display panel according to claim 16, wherein said initialization is performed by applying a first reset pulse having a positive peak potential to said one row electrodes in a first half, and applying a second reset pulse having a negative peak potential to said one row electrodes in a second half at the first and second halves of said reset stage in each of said first and second subfields.

38. The method for driving a plasma display panel according to claim 36, wherein the peak potential of said second reset pulse has an absolute value smaller than or equal to that of the peak potential of said sustain pulse.

39. The method for driving a plasma display panel according to claim 37, wherein the peak potential of said second reset pulse has an absolute value smaller than or equal to that of the peak potential of said sustain pulse.

40. A method for driving a plasma display panel in accordance with pixel data based on a video signal pixel by pixel, discharge cells being formed at respective intersections between a plurality of pairs of row electrodes and a plurality of column electrodes, the discharge cells each having a phosphor layer, the method comprising:
a drive control stage for applying a reset pulse to said pairs of row electrodes at least one of a plurality of subfields within every unit display period of said video signal; and a moving images/still image decision stage for deciding whether said video signal shows a moving image or a still image, and
wherein said drive control stage includes changing a pulse waveform of said reset pulse between when said video signal is decided to be a moving image and when it is decided to be a still image.

41. The method for driving a plasma display panel according to claim 40, wherein at said drive control stage, the peak potential or pulse width of said reset pulse is changed between when said video signal is decided to be a moving image and when a still image.

42. The method for driving a plasma display panel according to claim 41, wherein:
said peak potential is a positive potential; and
at said drive control stage, the peak potential of said reset pulse is raised when said video signal is decided to be a moving image as compared to when a still image.

43. The method for driving a plasma display panel according to claim 42, wherein at said drive control stage, the peak potential of said reset pulse is set to a first peak potential when said video signal is decided to be a still image, and the peak potential of said reset pulse is set to a second peak potential higher than said first peak potential when said video signal is decided to be a moving image.

44. The method for driving a plasma display panel according to claim 43, wherein at said drive control stage, the peak potential of said reset pulse is lowered stepwise in each unit display period until said peak potential reaches said first peak potential if the decision result of said moving image/still image decision stage shifts from a moving image to a still image.

45. The method for driving a plasma display panel according to claim 43, wherein at said drive control stage, the peak potential of said reset pulse is switched from said first potential to said second potential in said unit display period when the decision result of said moving image/still image decision stage shifts from a still image to a moving image.

46. The method for driving a plasma display panel according to claim 40, wherein at said drive control stage, the pulse width of said reset pulse is increased when the decision result of said moving image/still image decision stage is a moving image as compared to when a still image.

47. The method for driving a plasma display panel according to claim 40, wherein:
said peak potential is a negative potential; and
at said drive control stage, the peak potential of said reset pulse is lowered when said video signal is decided to be a moving image as compared to when a still image.

48. The method for driving a plasma display panel according to claim 40, wherein said phosphor layer contains a phosphor material and a secondary electron emitting material.

49. The method for driving a plasma display panel according to claim 48, wherein said secondary electron emitting material is made of magnesium oxide.

50. The method for driving a plasma display panel according to claim 49, wherein said magnesium oxide contains a magnesium oxide crystal which produces a cathode luminescence emission having a peak within a wavelength band of 200 to 300 nm when excited by an electron beam.

51. The method for driving a plasma display panel according to claim 50, wherein said magnesium oxide crystal is a magnesium oxide single crystal formed by vapor-phase oxidation.

52. The method for driving a plasma display panel according to claim 48, wherein said secondary electron emitting material is in contact with a discharge gas in a discharge space.

53. The method for driving a plasma display panel according to claim 40, wherein:
the drive control stage includes a reset stage for initializing said discharge cells into the state of said extinction mode in the first subfield within said unit display period, and a write address stage for setting each of said discharge cells from the state of extinction mode to the state of lighting mode selectively in accordance with said pixel data; and
at said reset stage, a voltage to between said one row electrodes and said column electrodes with said one row electrodes as anodes and said column electrodes as cathodes is applied.

54. The method for driving a plasma display panel according to claim 53, wherein at said reset stage, a potential for preventing a discharge between the other row electrodes and said one row electrodes in said pairs of row electrodes is applied to the other row electrodes.

55. The method for driving a plasma display panel according to claim 53, wherein in said first subfield, a sustain pulse is applied to said one row electrodes alone only once.

56. The method for driving a plasma display panel according to claim 53, wherein at said reset stage, said discharge cells create a reset discharge only in said first subfield out of said subfields within said unit display period.

57. The method for driving a plasma display panel according to claim 53, wherein in each of said subfields subsequent to the first subfield, the drive control stage further includes an erase address stage for setting each of said discharge cells from the state of said lighting mode to the state of said extinction mode selectively in accordance with said pixel data.

58. The method for driving a plasma display panel according to claim 53, wherein at said reset stage, a voltage is generated between said column electrodes and said one row electrodes by increasing the potential applied to said one row electrodes gradually with a lapse of time.

59. The method for driving a plasma display panel according to claim 53, wherein at the write address stage, a negative first base pulse is applied to said one row electrodes and a positive second base pulse is applied to the other row electrodes in said pairs of row electrodes.

60. The method for driving a plasma display panel according to claim 40, wherein:
said drive control stage includes a reset stage for initializing said discharge cells to either one of the states of said lighting mode and said extinction mode at least in the first subfield in said unit display time and the second subfield immediately after said first subfield, and an address stage for setting each of said discharge cells in the other of the states of said lighting mode and said extinction mode selectively in accordance with said pixel data both in the first subfield and the second subfield; and
at said reset stage in said second subfield, a voltage to between said one row electrodes and said column electrodes with said one row electrodes as anodes and said column electrodes as cathodes is applied.

61. The method for driving a plasma display panel according to claim 60, wherein at said reset stage in said first subfield, a voltage to between said one row electrodes and said column electrodes with said one row electrodes as anodes and said column electrodes as cathodes is applied.

62. The method for driving a plasma display panel according to claim 60, wherein:
at said reset stage, said discharge cells are initialized into the state of said extinction mode; and
at said address stage, each of said discharge cells is set from the state of said extinction mode to the state of said lighting mode selectively in accordance with said pixel data.

63. The method for driving a plasma display panel according to claim 60, wherein at said reset stage, a potential for preventing a discharge between said other row electrodes and said one row electrodes in said pairs of row electrodes is applied to said other row electrodes.

64. The method for driving a plasma display panel according to claim 60, wherein at said reset stage, positive potentials are applied to both said one row electrodes and said other row electrodes.

65. The method for driving a plasma display panel according to claim 60, wherein said drive control stage in said first subfield further includes a weak light emission stage for applying a voltage to between said one row electrodes in said pairs of row electrodes and said column electrodes with said one row electrodes as anodes and said column electrodes as cathodes, thereby creating a weak light emission discharge between said column electrodes and said one row electrodes in said discharge cells that are set to the state of said lighting mode.

66. The method for driving a plasma display panel according to claim 65, wherein said weak light emission discharge is a discharge accompanied with light emission corresponding to a tone level one brighter than brightness level 0.

67. The method for driving a plasma display panel according to claim 65, wherein at said reset stage in said second subfield, the potential for creating said weak light emission discharge in said first subfield is increased, applied to said one row electrodes, gradually with a lapse of time.

68. The method for driving a plasma display panel according to claim 65, wherein a rate of change of the potential, with a lapse of time in its rising period, to be applied to said one row electrodes in order to create said weak light emission discharge is higher than a rate of change of the potential, with a lapse of time in its rising period, to be applied to said one row electrodes at said reset stage.

69. The method for driving a plasma display panel according to claim 65, wherein:
said drive control stage further includes a sustain stage for applying a sustain pulse to each of said one row electrodes and each of the other row electrodes alternately in each of said subfields subsequent to said second subfield; and
the potential to be applied to said one row electrodes in order to create said weak light emission discharge is lower than a peak potential of said sustain pulse.

70. The method for driving a plasma display panel according to claim 60, wherein in said second subfield, a sustain pulse is applied to said one row electrodes alone only once.

71. The method for driving a plasma display panel according to claim 60, wherein in each of said subfields subsequent to the second subfield, the drive control stage further includes an erase address stage for setting each of said discharge cells from the state of said lighting mode to the state of said extinction mode selectively in accordance with said pixel data.

72. The method for driving a plasma display panel according to claim 60, wherein at said reset stage, the voltage between said column electrodes and the one row electrodes is increased gradually by increasing the potential applied to the one row electrodes gradually with a lapse of time.
